(19) United States
(12) Patent Application Publication
(10) Pub. No.: US 2005/0052741 A1
(43) Pub. Date: Mar. 10, 2005

(54) Polarization beam splitter film and method of phase shift adjustment thereof

(75) Inventors: Tomokazu Taguchi, Osaka (JP); Takuji Hatano, Osaka (JP); Kazuyuki Nishi, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 10/936,292

(22) Filed: Sep. 8, 2004

(30) Foreign Application Priority Data
Sep. 9, 2003 (JP) 2003-316571

(51) Int. Cl. G02B 5/30; G02B 27/28

(52) U.S. Cl. 359/495; 359/483

(57) ABSTRACT

In a polarization beam splitter film formed on a transparent substrate, in a desired range of incidence angles and in a desired range of wavelengths, the reflection-induced phase shift of s-polarized light varies linearly with respect to the variation of the incidence angle thereof.

This application is based on Japanese Patent Application No. 2003-316571 filed on Sep. 9, 2003, the contents of which are hereby incorporated by reference.

### BACKGROUND OF THE INVENTION 1. Field of the Invention

The present invention relates to a polarization beam splitter film, and to a method of phase shift adjustment thereof. More particularly, the present invention relates to a polarization beam splitter film having optical characteristics suitable, for example, for the optical system of an optical pickup for a blue laser, and to a method of phase shift adjustment thereof. 2. Description of Related Art

Many optical systems designed for optical pickups use a polarization beam splitter film that is capable of achieving polarization separation. However, conventionally known polarization beam splitter films exhibit high dependence on incidence angle, and this makes it difficult to achieve, by using them, satisfactory polarization separation with incident light having a large divergence angle, such as blue laser light. Thus, there have been demands for polarization beam splitter films having polarization separation characteristics that exhibit low dependence on incidence angle. In response, polarization beam splitter films that offer predetermined characteristics for so wide a range of angles as to be able to cope with incident light having a divergence angle of ±5° or more have been proposed in Patent Publications 1 and 2 listed below.
Patent Publication 1: Japanese Patent Application Laid-Open No. H8-146218
Patent Publication 2: Japanese Patent Application Laid-Open No. H9-184916

However, with the polarization beam splitter films disclosed in Patent Publications 1 and 2, it is only possible to reduce the incidence-angle dependence of s-polarized light to about 20% in terms of transmissivity, and thus it is impossible to obtain satisfactory polarization separation characteristics. Accordingly, using these polarization beam splitter films in the optical system of an optical pickup for a blue laser or the like results in problems such as an undue lowering of the amount of light.

Moreover, with conventionally known polarization beam splitter films, when s-polarized light is reflected therefrom, the phase thereof is shifted, causing irregular variations in the phase shift of s-polarized light depending on the incidence angle thereof. This lowers the wavefront accuracy of s-polarized light. Blue lasers have, on one hand, problems such as low oscillation stability, and, on the other hand, require high precision in the optical systems of the optical pickups that incorporate them. Thus, in the presence of irregular variations in the phase shift of s-polarized light depending on the incidence angle thereof, the signal receiver, under the influence of the lowering of the wavefront accuracy, causes various problems. Patent Publication 2 discloses a polarization beam splitter film in which a phase adjustment film having a large film thickness is used with a view to diminishing the incidence-angle dependence of the phase difference between s- and p-polarized light that is produced when it is transmitted or reflected. Even with this polarization beam splitter film, it is not possible to prevent irregular variations in the phase shift of s-polarized light depending on the incidence angle thereof.

### SUMMARY OF THE INVENTION

In view of the conventionally experienced inconveniences mentioned above, it is an object of the present invention to provide a polarization beam splitter film that, while maintaining good polarization separation characteristics exhibiting low dependence on incidence angle, can reflect s-polarized light with high wavefront accuracy, and to provide a method of adjusting the phase shift of such a polarization beam splitter film.

To achieve the above object, in one aspect of the present invention, a polarization beam splitter film formed on a transparent substrate is characterized in that, in a desired range of incidence angles and in a desired range of wavelengths, the reflection-induced phase shift of s-polarized light varies linearly with respect to the variation of the incidence angle thereof.

In another aspect of the present invention, a method of adjusting the phase shift of s-polarized light reflected from a polarization beam splitter film having a multiple-layer construction is characterized in that, in a desired range of incidence angles and in a desired range of wavelengths, if the electric field intensity distribution of the s-polarized light as observed between the light-entrance side and the light-exit side exhibits an increase exceeding a predetermined value, the electric field intensity of the s-polarized light is reduced down to the predetermined value or less by adjusting the film thickness of the layer in which the electric field intensity distribution of the s-polarized light exhibits the increase.

In another aspect of the present invention, a method of adjusting the phase shift of s-polarized light reflected from a polarization beam splitter film having a multiple-layer construction is characterized in that, in a desired range of incidence angles and in a desired range of wavelengths, the electric field intensity distribution of the s-polarized light is controlled in such a way that the peaks thereof decrease largely monotonically.

In another aspect of the present invention, a method of adjusting the phase shift of s-polarized light reflected from a polarization beam splitter film having a multiple-layer construction is characterized in that, in a desired range of incidence angles and in a desired range of wavelengths, if the electric field intensity distribution of the s-polarized light as observed between the light-entrance side and the light-exit side exhibits an increase exceeding a predetermined value, the electric field intensity of the s-polarized light is reduced down to the predetermined value or less by adjusting the film thickness of the layer in which the electric field intensity distribution of the s-polarized light exhibits the increase so that the electric field intensity distribution is controlled in such a way that the peaks thereof decrease largely monotonically.

In another aspect of the present invention, a polarization beam splitter is provided with a first substrate that is transparent and a polarization beam splitter film formed on the first substrate, and is characterized that, when light in a desired range of wavelengths is incident on the polarization beam splitter film in a desired range of incidence angles, the deviation of the reflection-induced phase shift of s-polarized light from the phase shift curve expressed as a linear function determined by the phase shifts observed at the minimum and maximum incidence angles is within ±50° all over the desired range of incidence angles.

In a polarization beam splitter film according to the present invention, the reflection-induced phase shift of s-polarized light varies linearly with respect to the variation of the incidence angle. This makes it possible to reflect s-polarized light with high wavefront accuracy while maintaining satisfactory polarization separation characteristics exhibiting low incidence-angle dependence. By using a polarization beam splitter film according to the present invention or a transparent optical component provided therewith in an optical system that receives incident light having a large divergence angle but that nevertheless requires satisfactory p-/s-polarization separation characteristics (for example, the optical system of an optical pickup using a blue laser), it is possible to dramatically enhance the wavefront accuracy of the light reflected from the polarization beam splitter film, and thereby to obtain excellent optical performance and other benefits.

### BRIEF DESCRIPTION OF THE DRAWINGS

FIG. 1 is a graph showing the polarization separation characteristics in the range of incidence angles from 40° to 50° as observed in Example 1;

FIG. 2 is a graph showing the reflection-induced phase shift of s-polarized light in the range of incidence angles from 40° to 50° as observed in Example 1;

FIG. 3 is a graph showing the electric field intensity distribution of s-polarized light at an incidence angle of 40° as observed in Example 1;

FIG. 4 is a graph showing the electric field intensity distribution of s-polarized light at an incidence angle of 41° as observed in Example 1;

FIG. 5 is a graph showing the electric field intensity distribution of s-polarized light at an incidence angle of 42° as observed in Example 1;

FIG. 6 is a graph showing the electric field intensity distribution of s-polarized light at an incidence angle of 43° as observed in Example 1;

FIG. 7 is a graph showing the electric field intensity distribution of s-polarized light at an incidence angle of 44° as observed in Example 1;

FIG. 8 is a graph showing the electric field intensity distribution of s-polarized light at an incidence angle of 45° as observed in Example 1;

FIG. 9 is a graph showing the electric field intensity distribution of s-polarized light at an incidence angle of 46° as observed in Example 1;

FIG. 10 is a graph showing the electric field intensity distribution of s-polarized light at an incidence angle of 47° as observed in Example 1;

FIG. 11 is a graph showing the electric field intensity distribution of s-polarized light at an incidence angle of 48° as observed in Example 1;

FIG. 12 is a graph showing the electric field intensity distribution of s-polarized light at an incidence angle of 49° as observed in Example 1;

FIG. 13 is a graph showing the electric field intensity distribution of s-polarized light at an incidence angle of 50° as observed in Example 1;

FIG. 14 is a graph showing the reflection-induced phase shift of s-polarized light in the range of incidence angles from 50° to 60° as observed in Example 1;

FIG. 15 is a graph showing the electric field intensity distribution of s-polarized light at an incidence angle of 52° as observed in Example 1;

FIG. 16 is a graph showing the electric field intensity distribution of s-polarized light at an incidence angle of 56.2° as observed in Example 1;

FIG. 17 is a graph showing the polarization separation characteristics in the range of incidence angles from 40° to 50° as observed in Example 2;

FIG. 18 is a graph showing the reflection-induced phase shift of s-polarized light in the range of incidence angles from 40° to 50° as observed in Example 2;

FIG. 19 is a graph showing the electric field intensity distribution of s-polarized light at an incidence angle of 40° as observed in Example 2;

FIG. 20 is a graph showing the electric field intensity distribution of s-polarized light at an incidence angle of 41° as observed in Example 2;

FIG. 21 is a graph showing the electric field intensity distribution of s-polarized light at an incidence angle of 42° as observed in Example 2;

FIG. 22 is a graph showing the electric field intensity distribution of s-polarized light at an incidence angle of 43° as observed in Example 2;

FIG. 23 is a graph showing the electric field intensity distribution of s-polarized light at an incidence angle of 44° as observed in Example 2;

FIG. 24 is a graph showing the electric field intensity distribution of s-polarized light at an incidence angle of 45° as observed in Example 2;

FIG. 25 is a graph showing the electric field intensity distribution of s-polarized light at an incidence angle of 46° as observed in Example 2;

FIG. 26 is a graph showing the electric field intensity distribution of s-polarized light at an incidence angle of 47° as observed in Example 2;

FIG. 27 is a graph showing the electric field intensity distribution of s-polarized light at an incidence angle of 48° as observed in Example 2;

FIG. 28 is a graph showing the electric field intensity distribution of s-polarized light at an incidence angle of 49° as observed in Example 2;

FIG. 29 is a graph showing the electric field intensity distribution of s-polarized light at an incidence angle of 50° as observed in Example 2;

FIG. 30 is a graph showing the polarization separation characteristics in the range of incidence angles from 40° to 50° as observed in Comparative Example 1;

FIG. 31 is a graph showing the reflection-induced phase shift of s-polarized light in the range of incidence angles from 40° to 50° as observed in Comparative Example 1;

FIG. 32 is a graph showing the electric field intensity distribution of s-polarized light at an incidence angle of 40° as observed in Comparative Example 1;

FIG. 33 is a graph showing the electric field intensity distribution of s-polarized light at an incidence angle of 41° as observed in Comparative Example 1;

FIG. 34 is a graph showing the electric field intensity distribution of s-polarized light at an incidence angle of 42° as observed in Comparative Example 1;

FIG. 35 is a graph showing the electric field intensity distribution of s-polarized light at an incidence angle of 43° as observed in Comparative Example 1;

FIG. 36 is a graph showing the electric field intensity distribution of s-polarized light at an incidence angle of 44° as observed in Comparative Example 1;

FIG. 37 is a graph showing the electric field intensity distribution of s-polarized light at an incidence angle of 45° as observed in Comparative Example 1;

FIG. 38 is a graph showing the electric field intensity distribution of s-polarized light at an incidence angle of 46° as observed in Comparative Example 1;

FIG. 39 is a graph showing the electric field intensity distribution of s-polarized light at an incidence angle of 47° as observed in Comparative Example 1;

FIG. 40 is a graph showing the electric field intensity distribution of s-polarized light at an incidence angle of 48° as observed in Comparative Example 1;

FIG. 41 is a graph showing the electric field intensity distribution of s-polarized light at an incidence angle of 49° as observed in Comparative Example 1;

FIG. 42 is a graph showing the electric field intensity distribution of s-polarized light at an incidence angle of 50° as observed in Comparative Example 1;

FIG. 43 is a graph showing the polarization separation characteristics in the range of incidence angles from 40° to 50° as observed in Comparative Example 2;

FIG. 44 is a graph showing the reflection-induced phase shift of s-polarized light in the range of incidence angles from 40° to 50° as observed in Comparative Example 2;

FIG. 45 is a graph showing the electric field intensity distribution of s-polarized light at an incidence angle of 40° as observed in Comparative Example 2;

FIG. 46 is a graph showing the electric field intensity distribution of s-polarized light at an incidence angle of 41° as observed in Comparative Example 2;

FIG. 47 is a graph showing the electric field intensity distribution of s-polarized light at an incidence angle of 42° as observed in Comparative Example 2;

FIG. 48 is a graph showing the electric field intensity distribution of s-polarized light at an incidence angle of 43° as observed in Comparative Example 2;

FIG. 49 is a graph showing the electric field intensity distribution of s-polarized light at an incidence angle of 44° as observed in Comparative Example 2;

FIG. 50 is a graph showing the electric field intensity distribution of s-polarized light at an incidence angle of 45° as observed in Comparative Example 2;

FIG. 51 is a graph showing the electric field intensity distribution of s-polarized light at an incidence angle of 46° as observed in Comparative Example 2;

FIG. 52 is a graph showing the electric field intensity distribution of s-polarized light at an incidence angle of 47° as observed in Comparative Example 2;

FIG. 53 is a graph showing the electric field intensity distribution of s-polarized light at an incidence angle of 48° as observed in Comparative Example 2;

FIG. 54 is a graph showing the electric field intensity distribution of s-polarized light at an incidence angle of 49° as observed in Comparative Example 2;

FIG. 55 is a graph showing the electric field intensity distribution of s-polarized light at an incidence angle of 50° as observed in Comparative Example 2;

FIG. 56 is a graph showing the phase shifts of s-polarized light as observed when the first layer is given different film thicknesses in Comparative Example 2;

FIG. 57 is a graph showing the phase shift of s-polarized light as observed when the first layer is given a film thickness QWOT of 0.613 in Comparative Example 2;

FIG. 58 is a graph showing the phase shift of s-polarized light as observed when the first layer is given a film thickness QWOT of 1.613 in Comparative Example 2;

FIG. 59 is a graph showing the phase shift of s-polarized light as observed when the first layer is given a film thickness QWOT of 2.613 in Comparative Example 2;

FIG. 60 is a graph showing the phase shift of s-polarized light as observed when the first layer is given a film thickness QWOT of 3.613 in Comparative Example 2;

FIG. 61 is a graph showing the phase shifts of s-polarized light as observed when the second layer is given different film thicknesses in Comparative Example 2;

FIG. 62 is a graph showing the phase shifts of s-polarized light as observed when the third layer is given different film thicknesses in Comparative Example 2;

FIG. 63 is a graph showing the phase shifts of s-polarized light as observed when the fifth layer is given different film thicknesses in Comparative Example 2;

FIG. 64 is a graph showing the phase shifts of s-polarized light as observed when the seventh layer is given different film thicknesses in Comparative Example 2;

FIG. 65 is a graph showing the phase shifts of s-polarized light as observed when the ninth layer is given different film thicknesses in Comparative Example 2;

FIG. 66 is a graph showing the phase shifts of s-polarized light as observed when the tenth layer is given different film thicknesses in Comparative Example 2;

FIG. 67 is a graph showing the phase shift of s-polarized light as observed when the tenth layer is given a film thickness QWOT of 0.086 in Comparative Example 2;

FIG. 68 is a graph showing the phase shift of s-polarized light as observed when the tenth layer is given a film thickness QWOT of 1.086 in Comparative Example 2;

FIG. 69 is a graph showing the phase shift of s-polarized light as observed when the tenth layer is given a film thickness QWOT of 2.086 in Comparative Example 2;

FIG. 70 is a graph showing the phase shift of s-polarized light as observed when the tenth layer is given a film thickness QWOT of 3.086 in Comparative Example 2;

FIG. 71 is a graph showing the phase shifts of s-polarized light as observed when the eleventh layer is given different film thicknesses in Comparative Example 2;

FIG. 72 is a graph showing the phase shift of s-polarized light as observed when the eleventh layer is given a film thickness QWOT of 0.949 in Comparative Example 2;

FIG. 73 is a graph showing the phase shift of s-polarized light as observed when the eleventh layer is given a film thickness QWOT of 1.949 in Comparative Example 2;

FIG. 74 is a graph showing the phase shift of s-polarized light as observed when the eleventh layer is given a film thickness QWOT of 2.949 in Comparative Example 2;

FIG. 75 is a graph showing the phase shift of s-polarized light as observed when the eleventh layer is given a film thickness QWOT of 3.949 in Comparative Example 2;

FIG. 76 is a graph showing the phase shifts of s-polarized light as observed when the twelfth layer is given different film thicknesses in Comparative Example 2;

FIG. 77 is a graph showing the phase shifts of s-polarized light as observed when the thirteenth layer is given different film thicknesses in Comparative Example 2;

FIG. 78 is a graph showing the phase shifts of s-polarized light as observed when the fifteenth layer is given different film thicknesses in Comparative Example 2;

FIG. 79 is a graph showing the phase shifts of s-polarized light as observed when the seventeenth layer is given different film thicknesses in Comparative Example 2;

FIG. 80 is a graph showing the phase shifts of s-polarized light as observed when the nineteenth layer is given different film thicknesses in Comparative Example 2;

FIG. 81 is a graph showing the phase shifts of s-polarized light as observed when the twenty-first layer is given different film thicknesses in Comparative Example 2;

FIG. 82 is a graph showing the phase shift of s-polarized light as observed when the twenty-first layer is given a film thickness QWOT of 0.820 in Comparative Example 2;

FIG. 83 is a graph showing the phase shift of s-polarized light as observed when the twenty-first layer is given a film thickness QWOT of 1.820 in Comparative Example 2;

FIG. 84 is a graph showing the phase shift of s-polarized light as observed when the twenty-first layer is given a film thickness QWOT of 2.820 in Comparative Example 2;

FIG. 85 is a graph showing the phase shift of s-polarized light as observed when the twenty-first layer is given a film thickness QWOT of 3.820 in Comparative Example 2;

FIG. 86 is a graph showing the phase shifts of s-polarized light as observed when the twenty-third layer is given different film thicknesses in Comparative Example 2;

FIG. 87 is a graph showing the phase shifts of s-polarized light as observed when the twenty-fourth layer is given different film thicknesses in Comparative Example 2;

FIG. 88 is a graph showing the polarization separation characteristics in the range of incidence angles from 40° to 50° as observed in Example 3;

FIG. 89 is a graph showing the reflection-induced phase shift of s-polarized light in the range of incidence angles from 40° to 50° as observed in Example 3;

FIG. 90 is a graph showing the electric field intensity distribution of s-polarized light at an incidence angle of 40° as observed in Example 3;

FIG. 91 is a graph showing the electric field intensity distribution of s-polarized light at an incidence angle of 41° as observed in Example 3;

FIG. 92 is a graph showing the electric field intensity distribution of s-polarized light at an incidence angle of 42° as observed in Example 3;

FIG. 93 is a graph showing the electric field intensity distribution of s-polarized light at an incidence angle of 43° as observed in Example 3;

FIG. 94 is a graph showing the electric field intensity distribution of s-polarized light at an incidence angle of 44° as observed in Example 3;

FIG. 95 is a graph showing the electric field intensity distribution of s-polarized light at an incidence angle of 45° as observed in Example 3;

FIG. 96 is a graph showing the electric field intensity distribution of s-polarized light at an incidence angle of 46° as observed in Example 3;

FIG. 97 is a graph showing the electric field intensity distribution of s-polarized light at an incidence angle of 47° as observed in Example 3;

FIG. 98 is a graph showing the electric field intensity distribution of s-polarized light at an incidence angle of 48° as observed in Example 3;

FIG. 99 is a graph showing the electric field intensity distribution of s-polarized light at an incidence angle of 49° as observed in Example 3;

FIG. 100 is a graph showing the electric field intensity distribution of s-polarized light at an incidence angle of 50° as observed in Example 3; and

FIG. 101 is a flow chart showing a method of fabricating a polarization beam splitter film according to the invention.

### DETAILED DESCRIPTION OF PREFERRED EMBODIMENTS

Hereinafter, polarization beam splitter films embodying the present invention and a method of fabricating them will be described with reference to the drawings. Table 1 shows, as an example of a polarization beam splitter film embodying the invention, the multiple-layer construction of Example 1 (QWOT=4∘n∘d/λ0, where d represents the physical film thickness; n represents the refractive index; and λ0 represents the design wavelength). In Example 1, on a glass substrate M (with a refractive index of 1.64) disposed on the light-entrance side, there are laid a total of 33 layers (the total number of layers is represented by N) that are given successive numbers (the number of a given layer is represented by i) in the order in which they are laid. These layers consist of films of a high-refractive-index material, namely TiO₂ (titanium oxide), and films of a low-refractive-index material, namely SiO₂ (silicon oxide), that are laid alternately on one another. The last layer, i.e., the one farthest from the light-entrance-side glass substrate M, is bonded to a glass substrate E (with a refractive index of 1.64) disposed on the light-exit side, with an adhesive layer S (with a refractive index of 1.51) interposed in between.

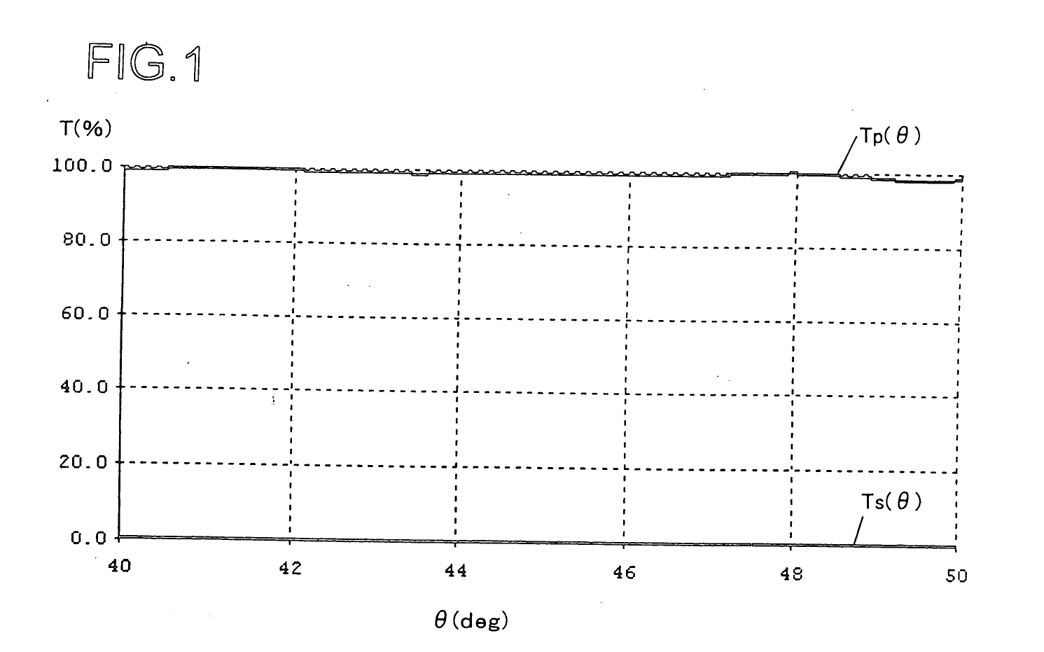

FIG. 1 shows the polarization separation characteristics of Example 1 as plotted in terms of transmissivity T (%). FIG. 1 shows the transmissivity Tp (θ) of p-polarized light and the transmissivity Ts (θ) of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 1, Example 1 has polarization separation characteristics exhibiting low incidence-angle dependence, and is thus suitable as a polarization beam splitter for a blue laser.

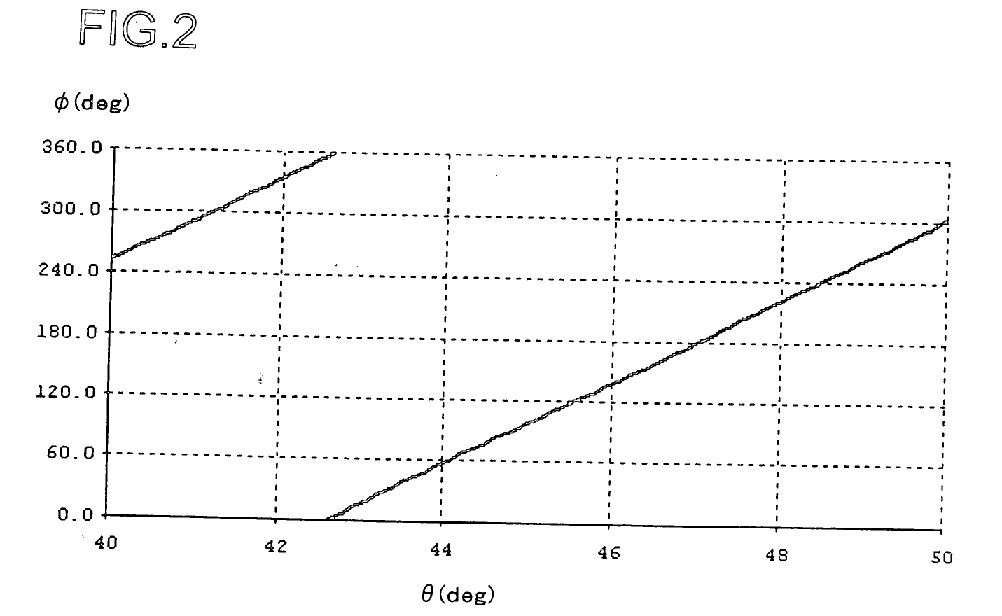

FIG. 2 shows the reflection-induced phase shift φ (°) of s-polarized light (with a wavelength λ of 405 nm) as observed in the range of incidence angles θ from 40° to 50° in Example 1. As will be understood from FIG. 2, the reflection-induced phase shift φ of s-polarized light varies linearly with respect to the variation of the incidence angle.

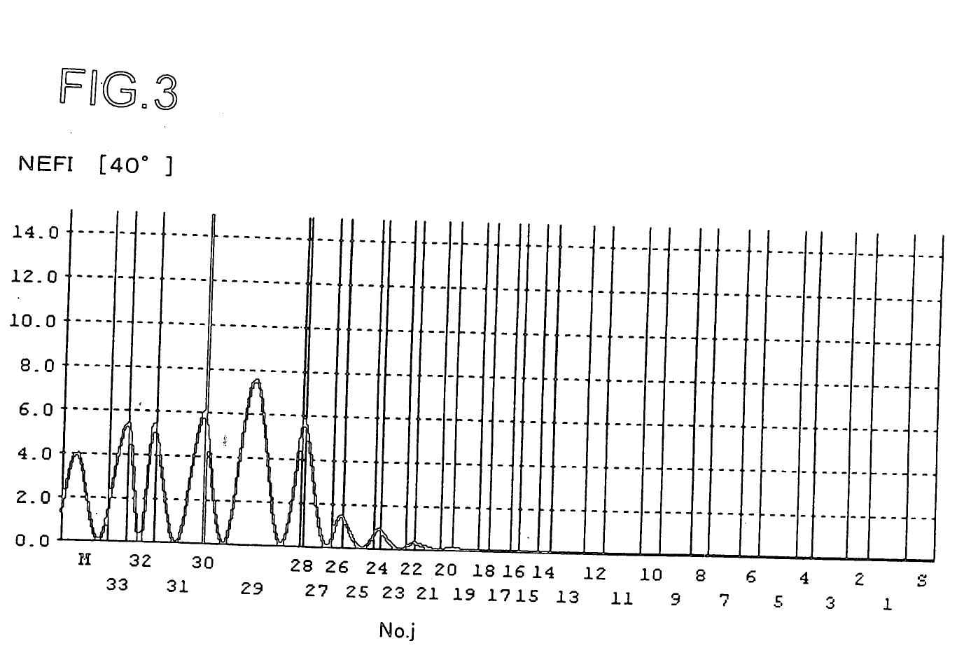

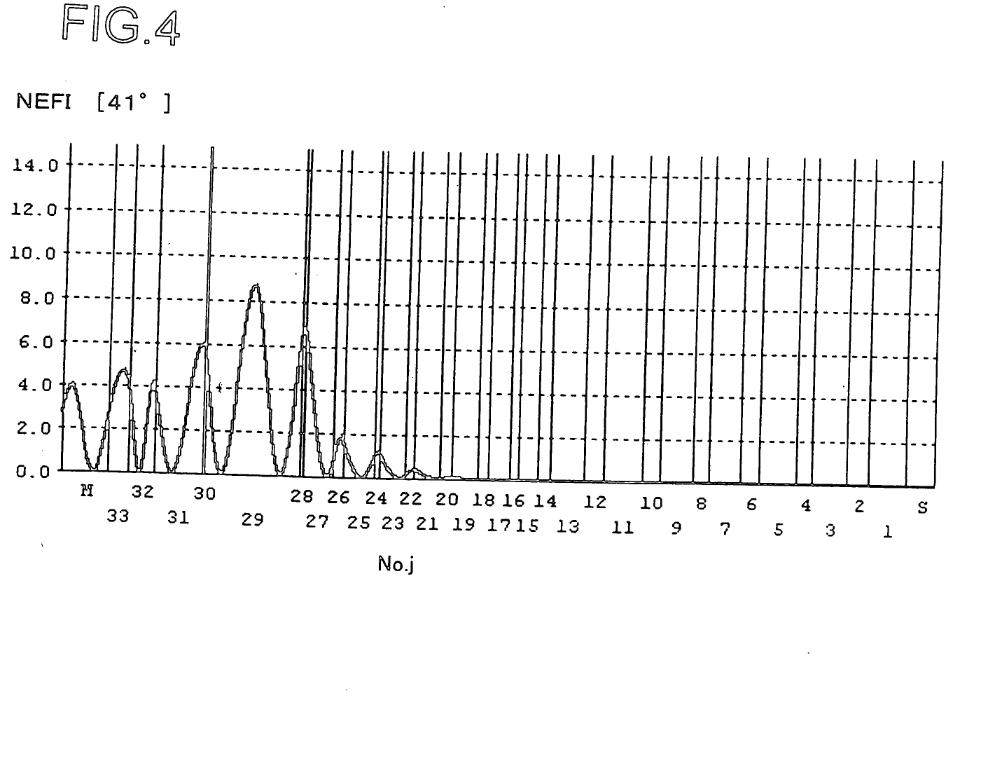

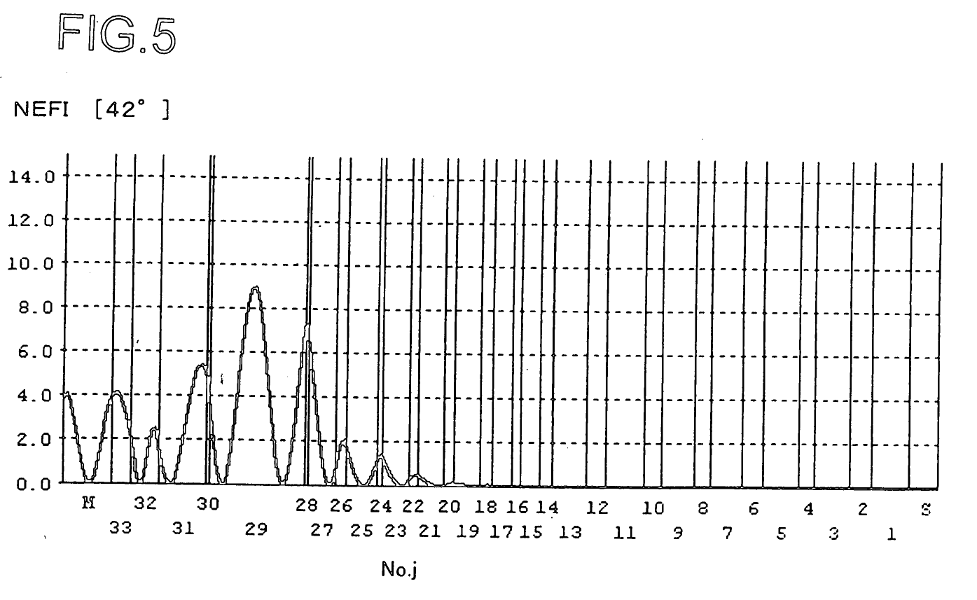

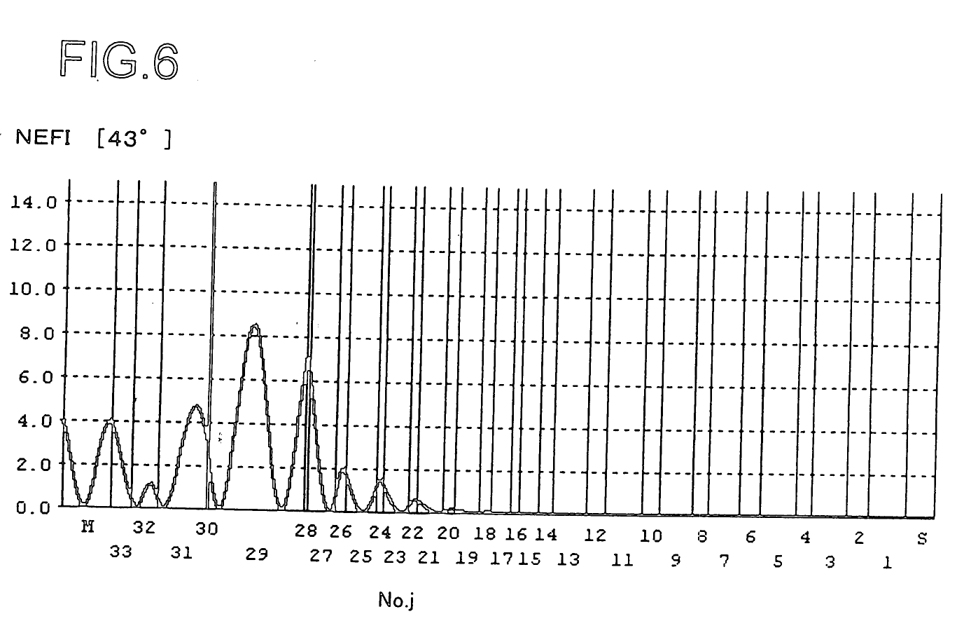

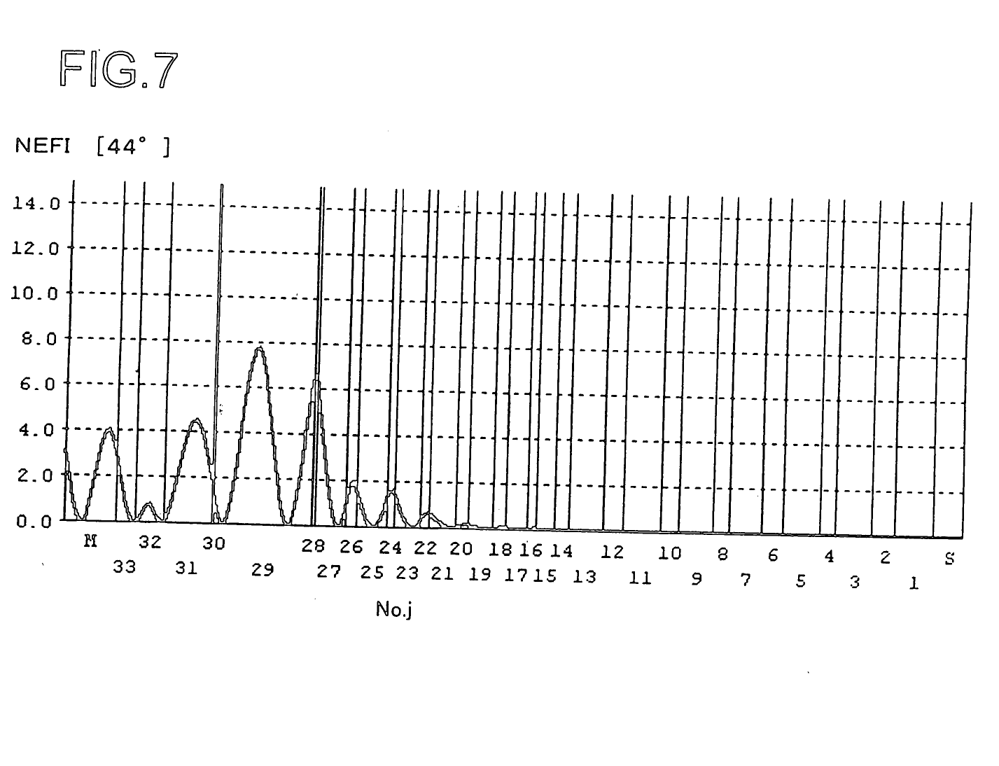

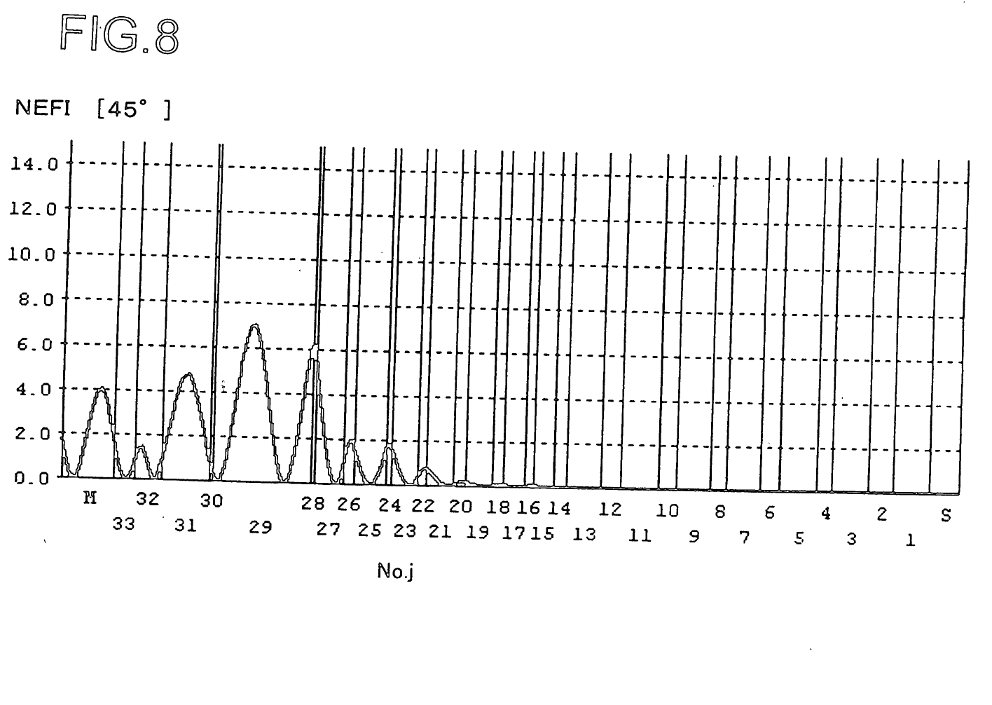

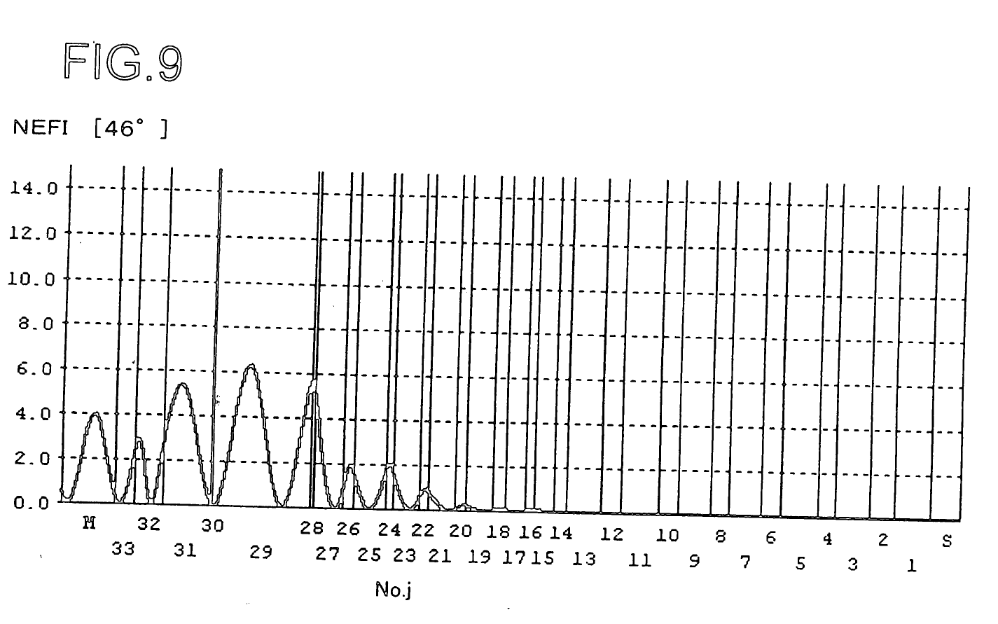

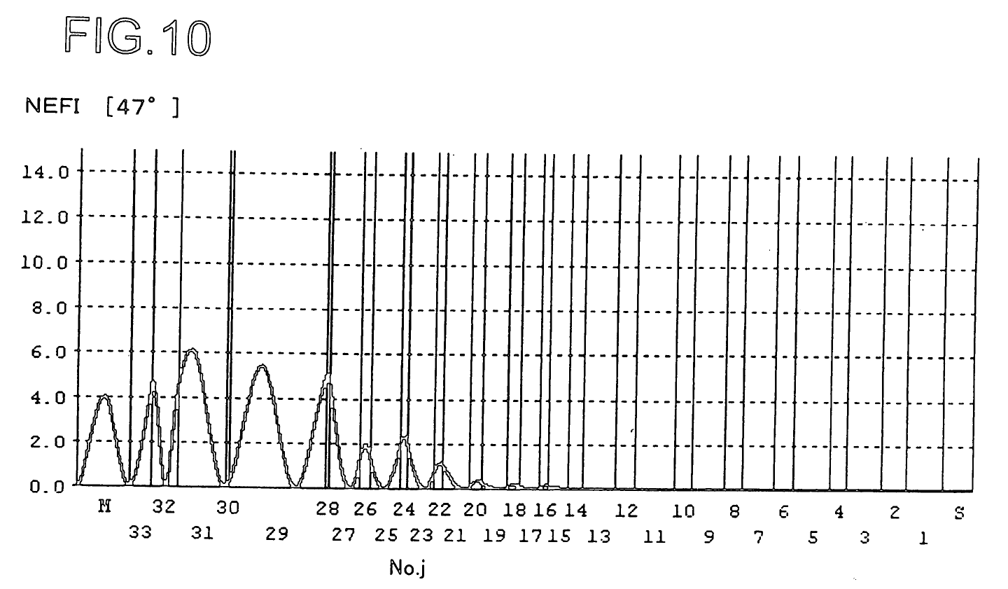

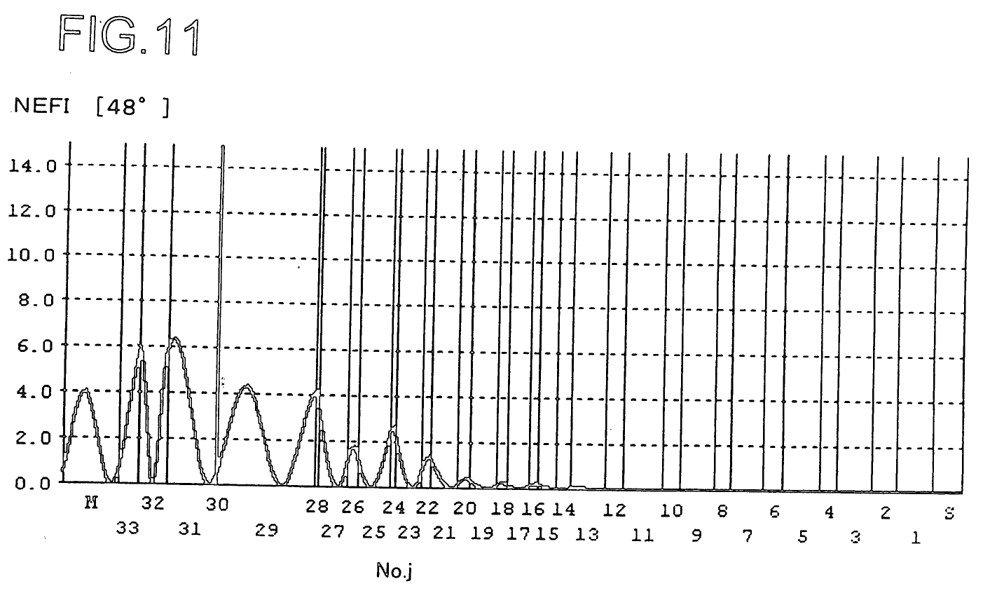

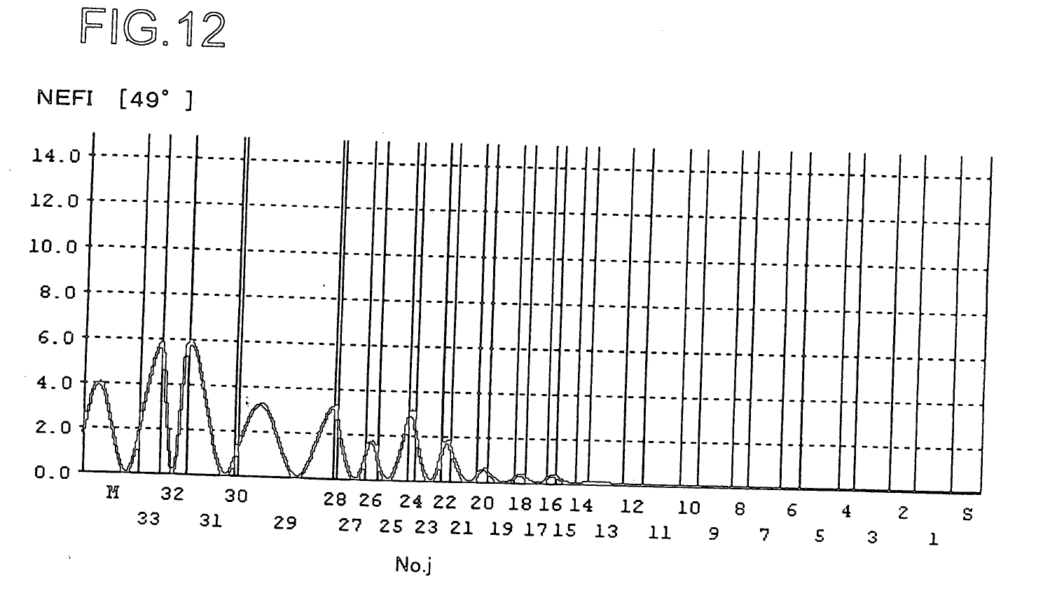

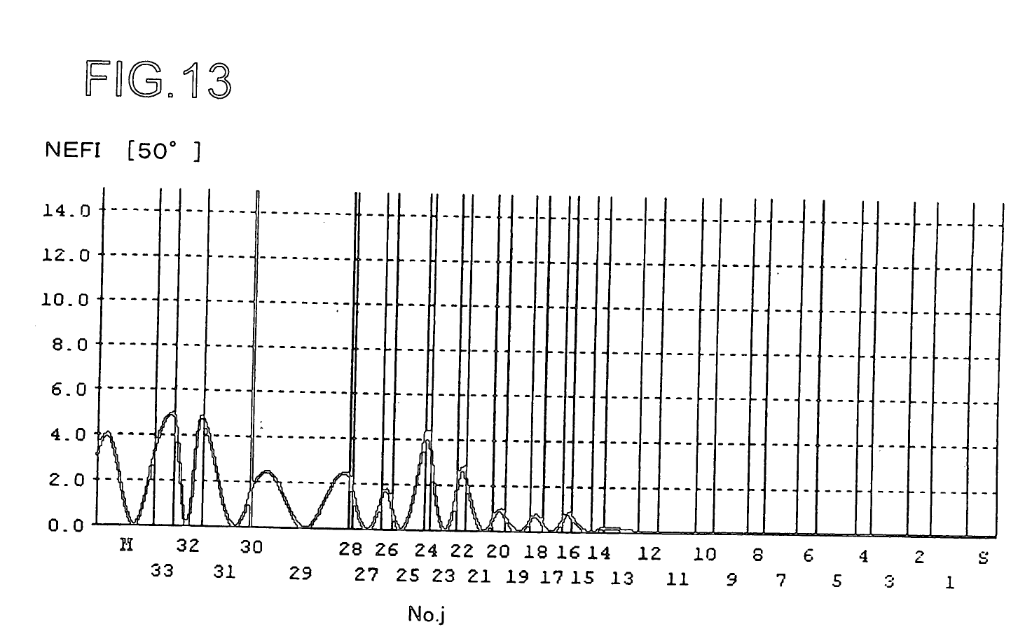

FIGS. 3 to 13 show the electric field intensity distribution of s-polarized light (with a wavelength λ of 405 nm) as observed at each integer angle in the range of incidence angles θ from 40° to 50° in Example 1. In the graphs of FIGS. 3 to 13, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 3 to 13, the vertical axis represents the normalized electric field intensity (NEFI) of the layers. As will be understood from FIGS. 3 to 13, over the entire range of incidence angles θ from 40° to 50°, none of the layers exhibits any sharp increase in electric field intensity. Specifically, the electric field intensity of s-polarized light varies in such a way as not to exceed three times the electric field intensity thereof in the glass substrate M; moreover, the peaks of the electric field intensity distribution decrease largely monotonically.

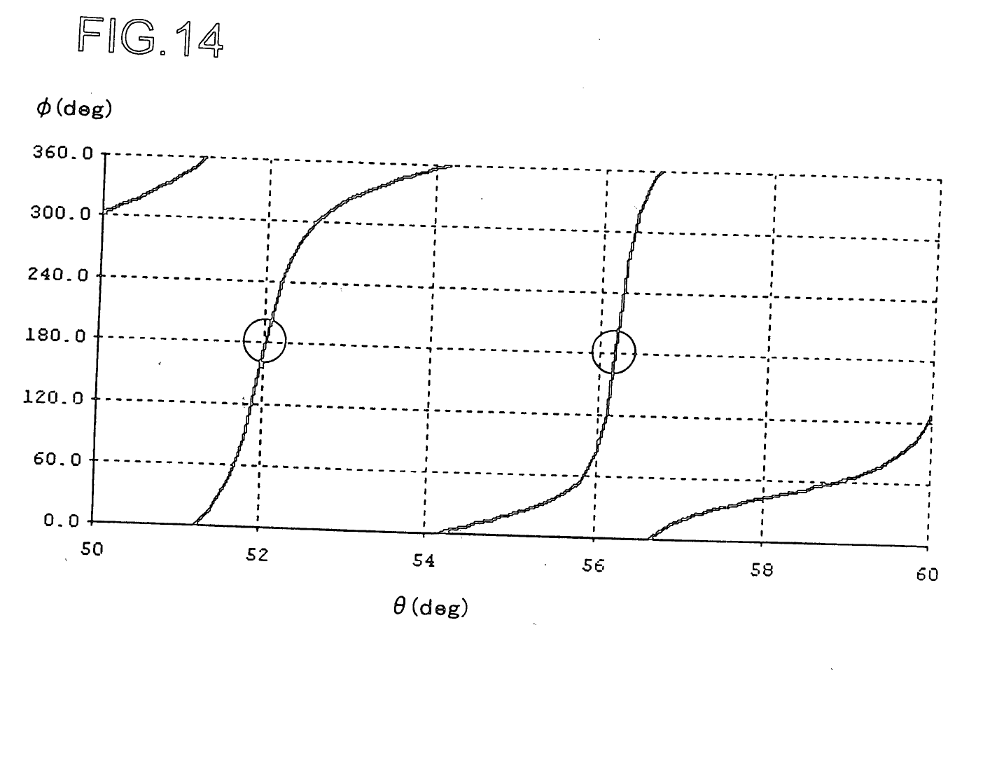

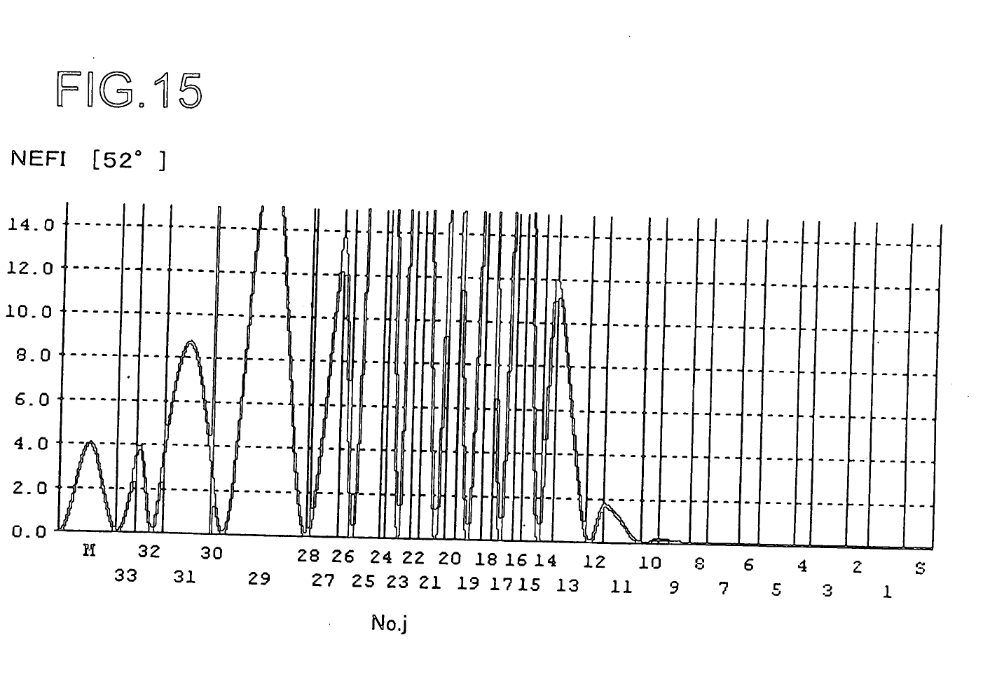

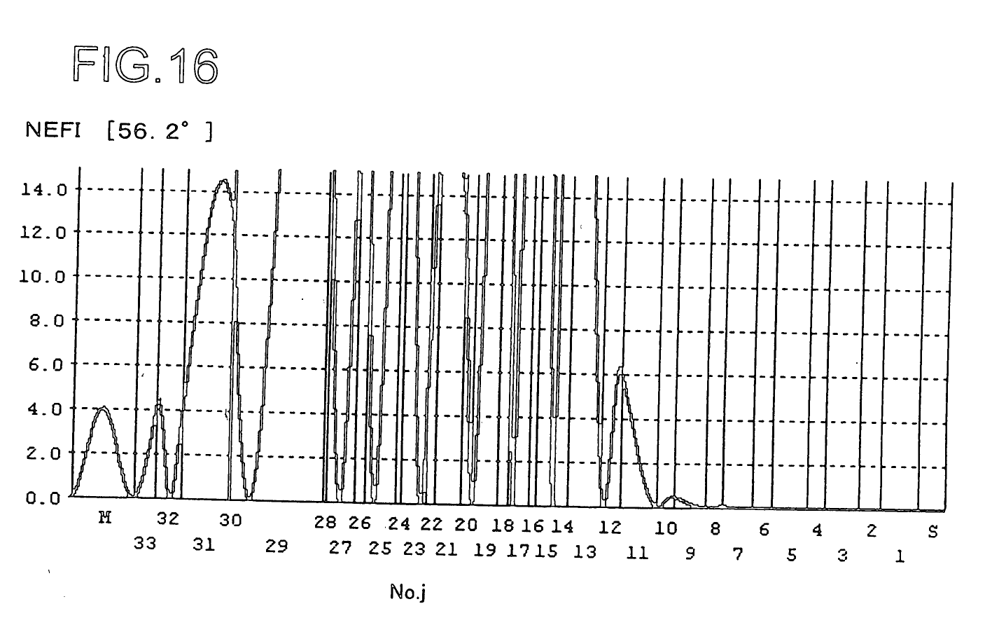

FIG. 14 shows the reflection-induced phase shift φ (°) of s-polarized light (with a wavelength λ of 405 nm) as observed in the range of incidence angles θ from 50° to 60° in Example 1. As will be understood from FIG. 14, around incidence angles θ of 52° and 56.2°, changes are observed in the curve of the phase shift. That is, at these incidence angles, the change of the phase shift with respect to the variation of the incidence angle has inflection points (indicated by circles in FIG. 14). FIGS. 15 and 16 show the electric field intensity distribution of s-polarized light (with a wavelength λ of 405 nm) at incidence angles θ of 52° and 56.2°, respectively. These graphs show that, at incidence angles θ of 52° and 56.2°, where the curve representing the reflection-induced phase shift φ of s-polarized light (i.e., the phase shift curve) has inflection points, part of the layers exhibit a sharp increase in electric field intensity (that is, the electric field intensity exceeds three to four times that in the glass substrate M).

As another example of a polarization beam splitter film in which, as in Example 1, the reflection-induced phase shift of s-polarized light as observed at a wavelength λ of 405 nm, in the range of incidence angles θ from 40° to 50° varies linearly with respect to the variation of the incidence angle, Table 2 shows the multiple-layer construction of Example 2 (QWOT=4∘n∘d/λ0, where d represents the physical film thickness; n represents the refractive index; and λ0 represents the design wavelength). In Example 2, on a glass substrate M (with a refractive index of 1.64) disposed on the light-entrance side, there are laid a total of 35 layers (the total number of layers is represented by N) that are given successive numbers (the number of a given layer is represented by i) in the order in which they are laid. These layers consist of films of a high-refractive-index material, namely TiO₂ (titanium oxide), and films of a low-refractive-index material, namely SiO₂ (silicon oxide), that are laid alternately on one another. The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between.

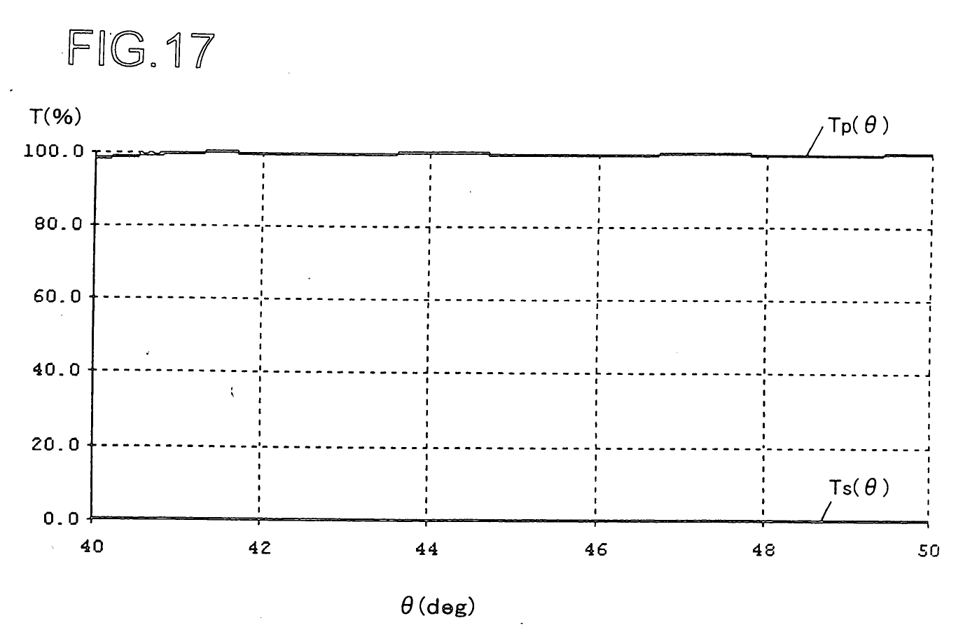

FIG. 17 shows the polarization separation characteristics of Example 2 as plotted in terms of transmissivity T (%). FIG. 17 shows the transmissivity Tp (θ) of p-polarized light and the transmissivity Ts (θ) of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 17, Example 2 has polarization separation characteristics exhibiting low incidence-angle dependence, and is thus suitable as a polarization beam splitter for a blue laser.

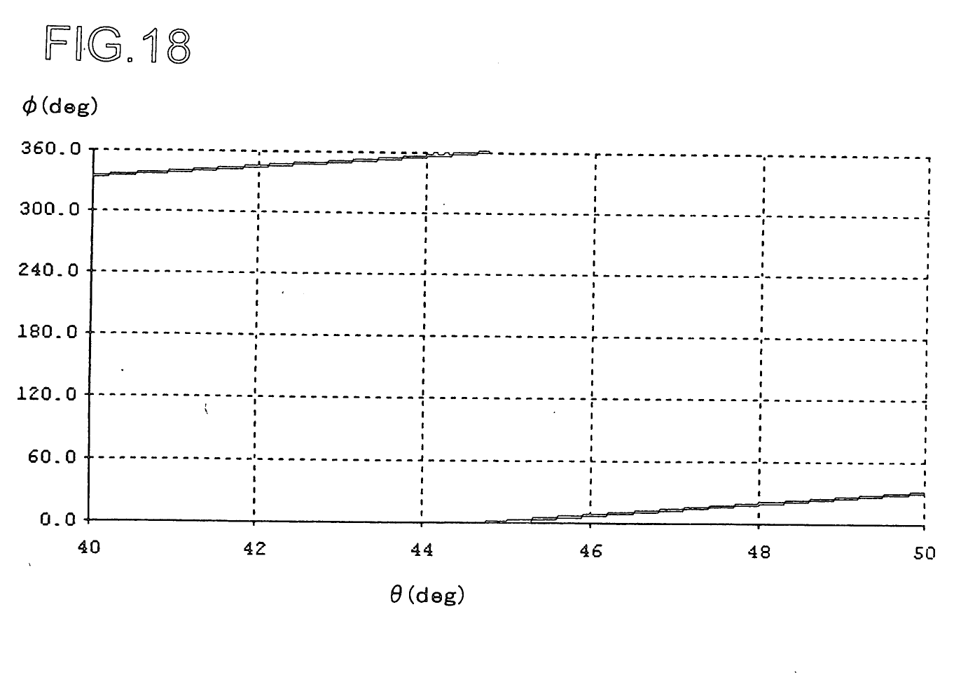

FIG. 18 shows the reflection-induced phase shift φ (°) of s-polarized light (with a wavelength λ of 405 nm) as observed in the range of incidence angles θ from 40° to 50° in Example 2. As will be understood from FIG. 18, the reflection-induced phase shift φ of s-polarized light varies linearly with respect to the variation of the incidence angle.

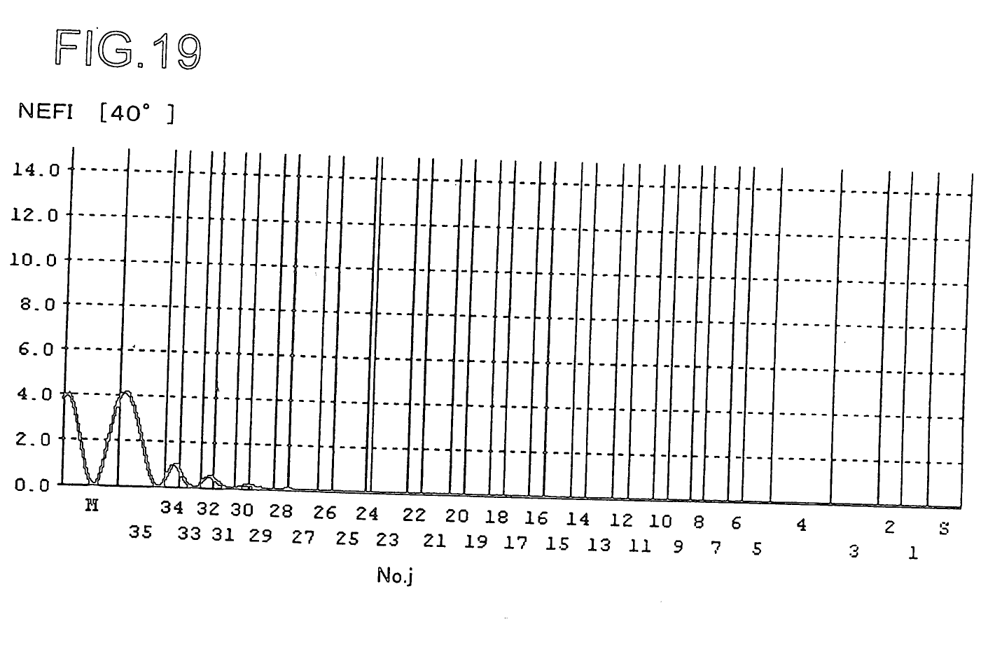

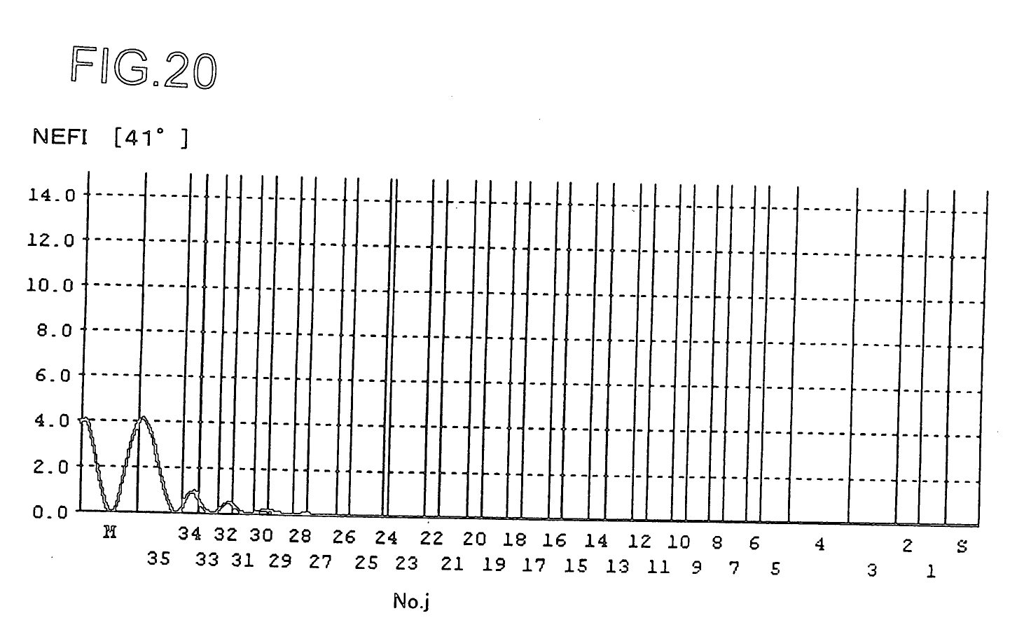

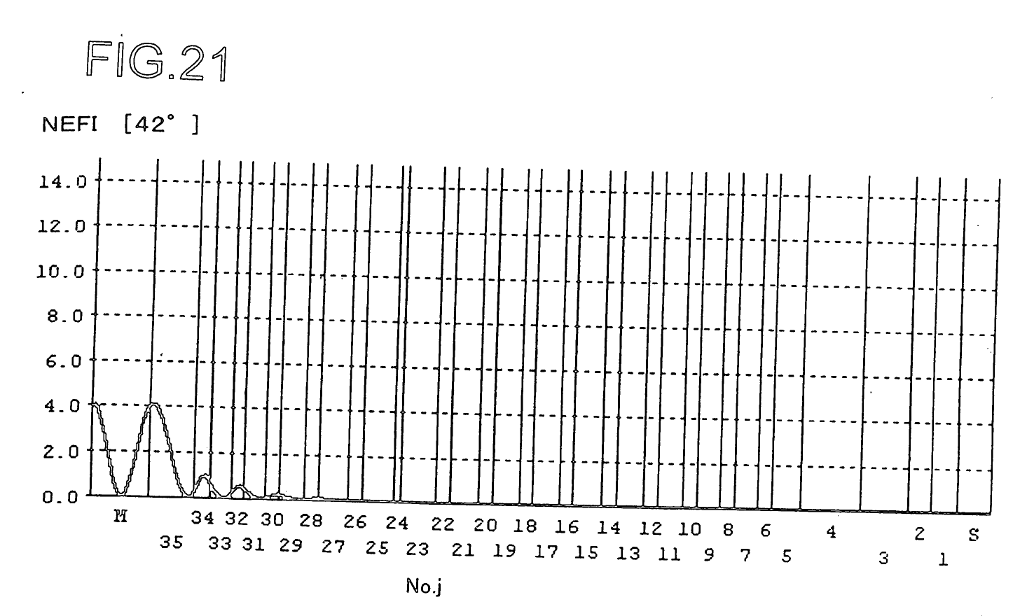

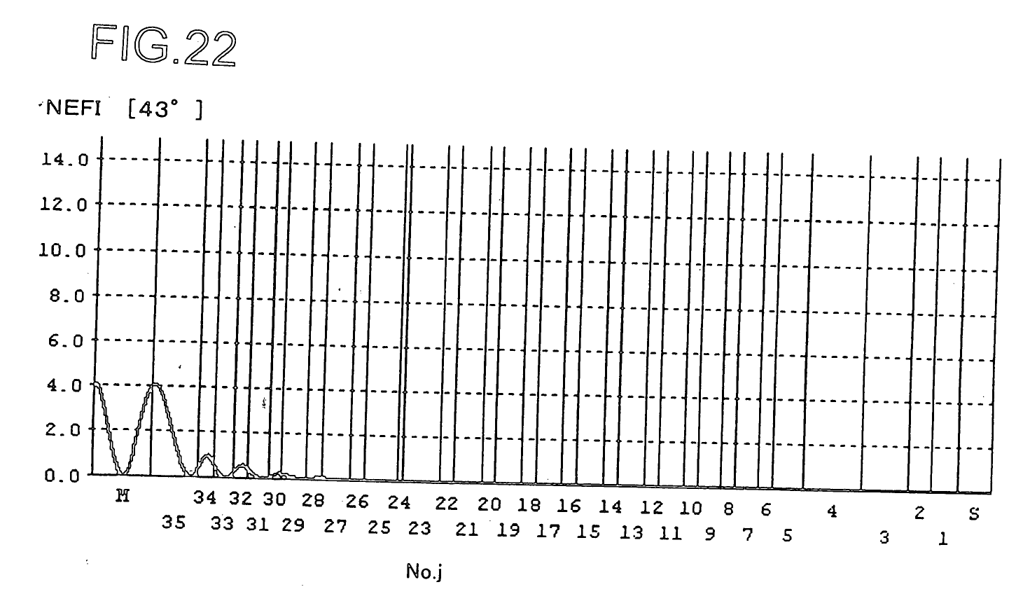

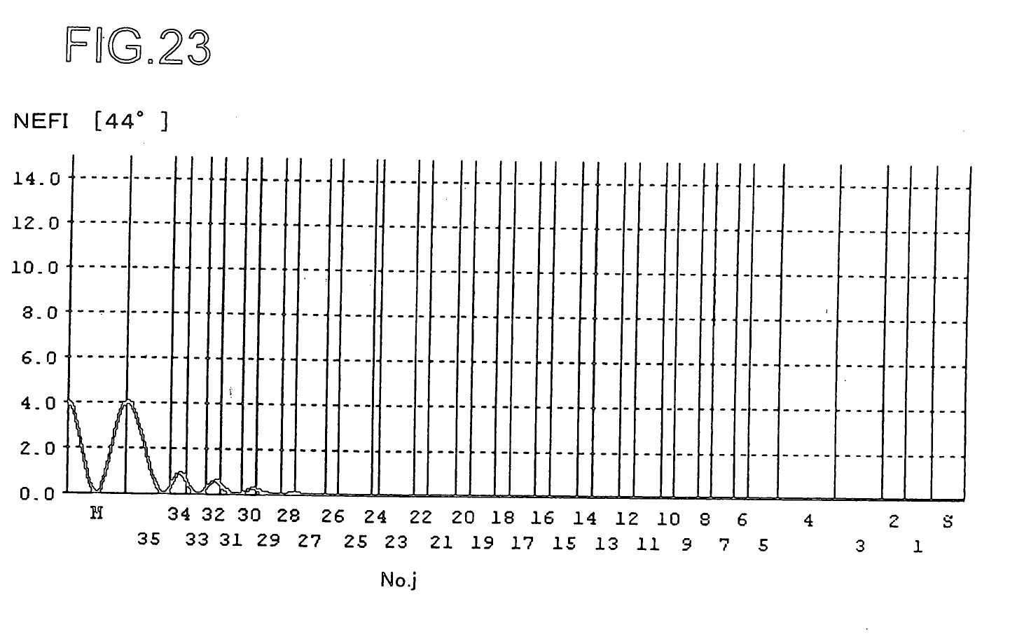

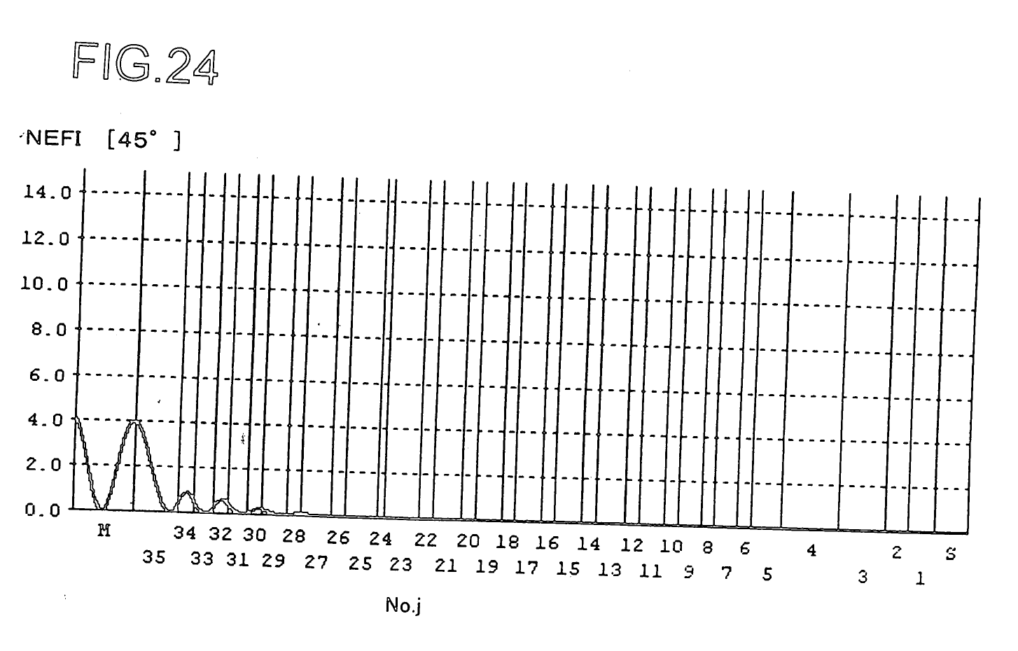

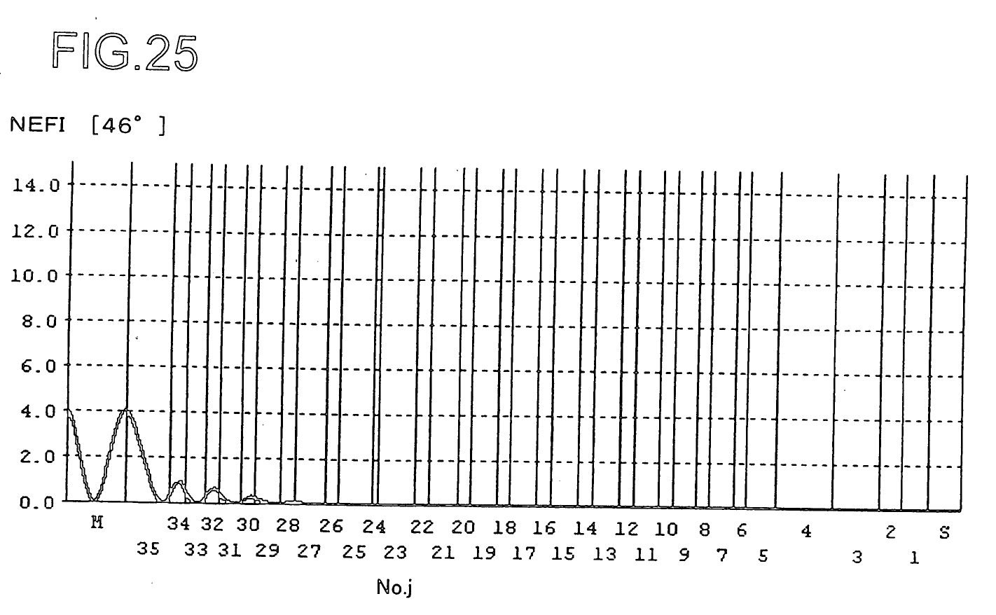

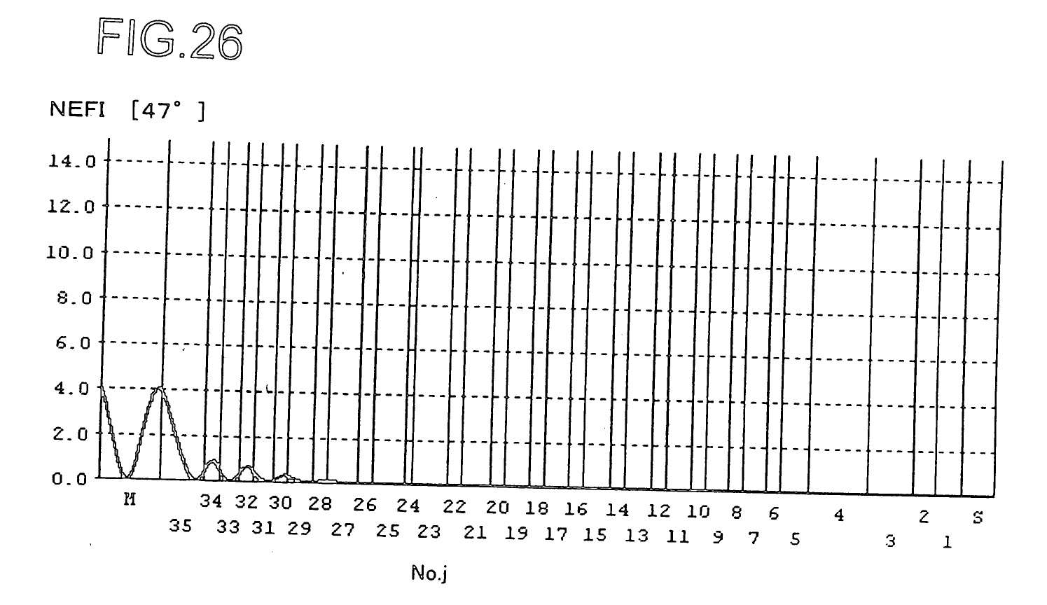

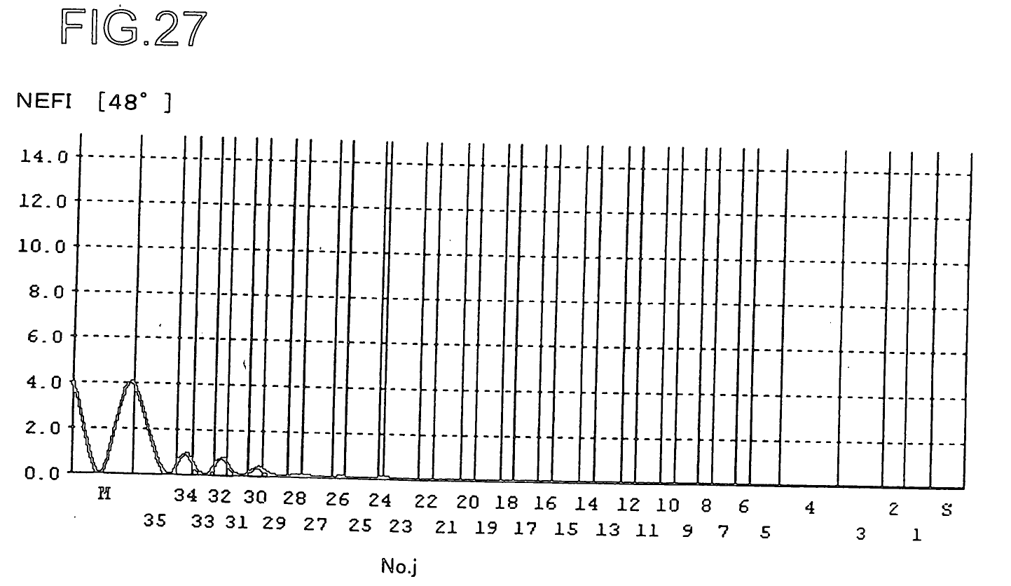

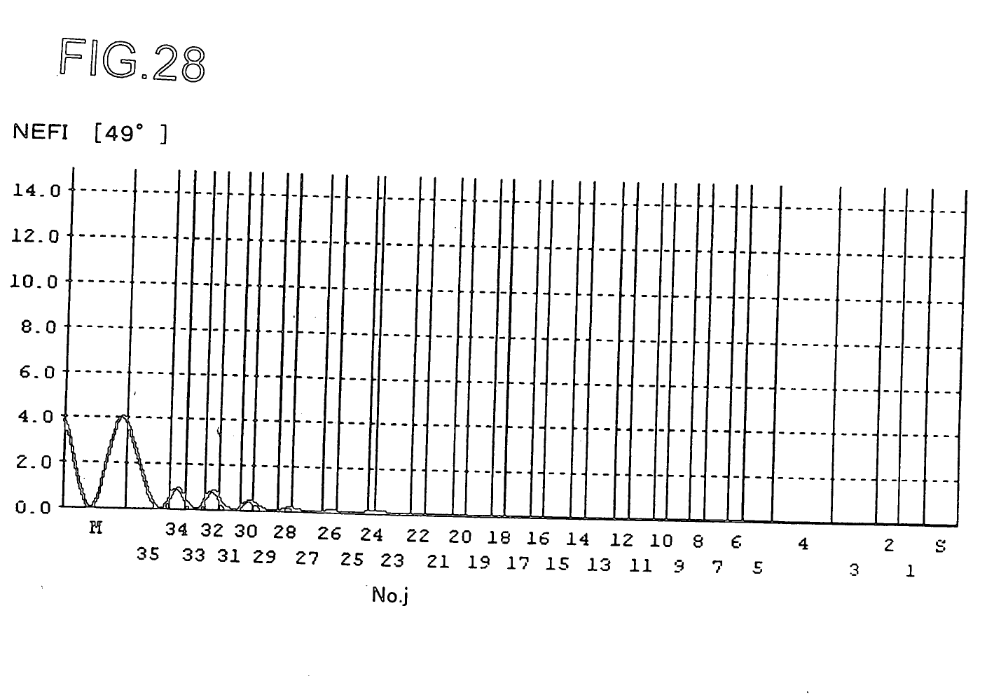

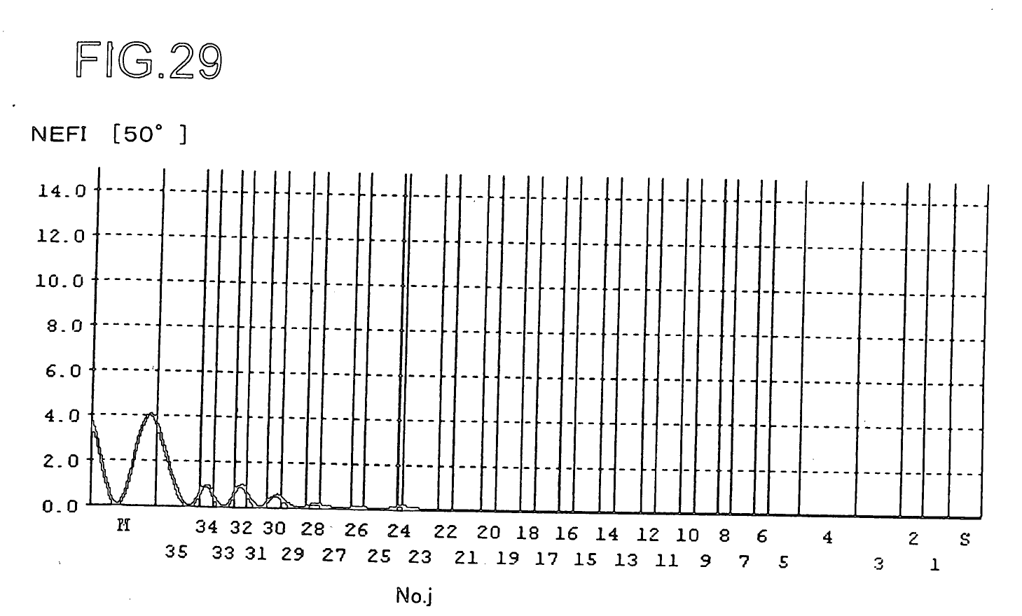

FIGS. 19 to 29 show the electric field intensity distribution of s-polarized light (with a wavelength λ of 405 nm) as observed at each integer angle in the range of incidence angles θ from 40° to 50° in Example 2. In the graphs of FIGS. 19 to 29, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 19 to 29, the vertical axis represents the normalized electric field intensity (NEFI) of the layers. As will be understood from FIGS. 19 to 29, over the entire range of incidence angles θ from 40° to 50°, none of the layers exhibits any sharp increase in electric field intensity. Specifically, the electric field intensity of s-polarized light varies in such a way as not to exceed three times the electric field intensity thereof in the glass substrate M; moreover, the peaks of the electric field intensity distribution decrease largely monotonically.

In Examples 1 and 2 described above, at a wavelength of 405 nm, in the range of incidence angles from 40° to 50°, the reflection-induced phase shift of s-polarized light varies linearly with respect to the variation of the incidence angle. Where the phase shift varies regularly in this way, it can easily be predicted and adjusted on the basis of the relationship between the incidence angle θ and the phase shift φ. Accordingly, as in Examples 1 and 2, by controlling the reflection-induced phase shift of s-polarized light linearly with respect to the incidence angle in a desired range of incidence angles and in a desired range of wavelengths, it is possible to reflect s-polarized light with high wavefront accuracy while maintaining polarization separation characteristics exhibiting low incidence-angle dependence. Such a polarization beam splitter film, or a transparent optical component provided therewith, in which the reflection-induced phase shift of s-polarized light varies linearly with respect to the variation of the incidence angle in a desired range of incidence angles and in a desired range of wavelengths can suitably be used in an optical system that receives incident light having a large divergence angle but that nevertheless requires satisfactory p-/s-polarization separation characteristics (for example, the optical system of an optical pickup using a blue laser). This dramatically enhances the wavefront accuracy of the light reflected from the polarization beam splitter film, and thus helps obtain excellent optical performance and other benefits.

At incidence angles at which the phase shift varies irregularly (i.e., at incidence angles at which the phase shift has inflection points), part of the layers exhibit a sharp increase in electric field intensity. Accordingly, as in Examples 1 and 2, to control the reflection-induced phase shift of s-polarized light linearly with respect to the incidence angle in a desired range of incidence angles and in a desired range of wavelengths, it is preferable that the electric field intensity of s-polarized light as observed between the light-entrance-side and light-exit-side substrates be controlled to be less than or equal to four times (more preferably, three times, and, further preferably, less than or equal to) the electric field intensity as observed in the substrates. In addition, it is preferable that the peaks of the electric field intensity distribution decrease largely monotonically.

In a case where, in a desired range of incidence angles and in a desired range of wavelengths, the electric field intensity distribution of s-polarized light as observed between the light-entrance-side and light-exit-side substrates exhibits an increase exceeding a predetermined value (for example, four times the electric field intensity as observed in the substrates), it is preferable that the film thicknesses of the layers in which the electric field intensity distribution of s-polarized light exhibits the increase be so controlled that the electric field intensity as observed therein is less than or equal to a predetermined value (for example, four times, more preferably, three times, and, further preferably, less than or equal to the electric field intensity as observed in the substrates). By adjusting the film thicknesses of the layers that exhibit a sharp increase in electric field intensity, it is possible to make the phase shift linear, and thereby to make the change of the phase shift regular. This will be described in detail later.

Moreover, it is preferable that the range of incidence angles be ±5° of a predetermined value (in Examples 1 and 2, 45°), and that the deviation of the phase shift from the linear function determined by the phase shifts observed at the minimum and maximum incidence angles be within ±50° over the entire range of incidence angles. It is more preferable that this deviation of the phase shift be within ±20°, and, further preferably, within ±10°. Moreover, it is preferable that the phase shift vary smoothly with respect to the incidence angle. As in Examples 1 and 2, by setting the range of incidence angles to be ±5° of a predetermined value, and setting the deviation of the phase shift from the linear function determined by the phase shifts at the minimum and maximum incidence angles to be within ±50° (more preferably, within ±20°, and, further preferably, within ±10°) over the entire range of incidence angles, it is possible to enhance the wavefront accuracy in a way more suitable for the optical system of an optical pickup for a blue laser. It should be noted that, here, a blue laser denotes, for example, a laser operating at a wavelength from 390 nm to 430 nm.

In Examples 1 and 2 described above, a glass substrate is used as the transparent substrate on which the polarization beam splitter film is formed. It is, however, also possible to use, as necessary, a substrate of another material (for example, a transparent plastic or ceramic substrate). Instead of forming the polarization beam splitter film between substrates, it is also possible to form it on a transparent substrate and then coat it with a protective film.

Next, the method of controlling the reflection-induced phase shift of s-polarized light linearly with respect to the incidence angle in a desired range of incidence angles and in a desired range of wavelengths will be described by way of comparative and other examples. Table 3 shows the multiple-layer construction of Comparative Example 1 (QWOT=4∘n∘d/λ0, where d represents the physical film thickness; n represents the refractive index; and λ0 represents the design wavelength). In the polarization beam splitter film of Comparative Example 1, on a glass substrate M (with a refractive index of 1.64) disposed on the light-entrance side, there are laid a total of 35 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between.

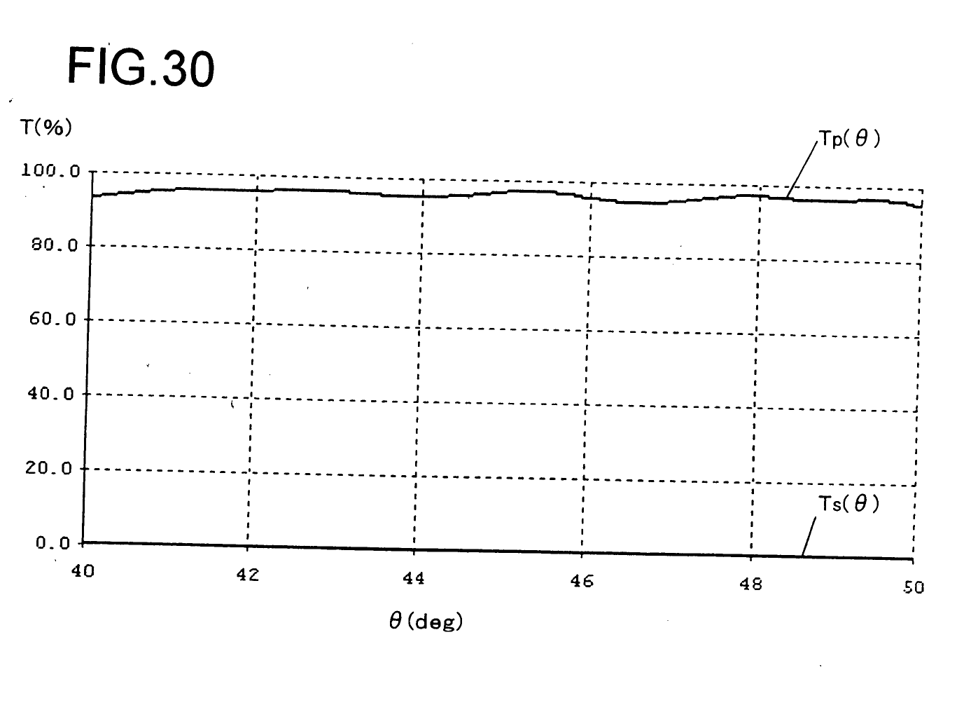

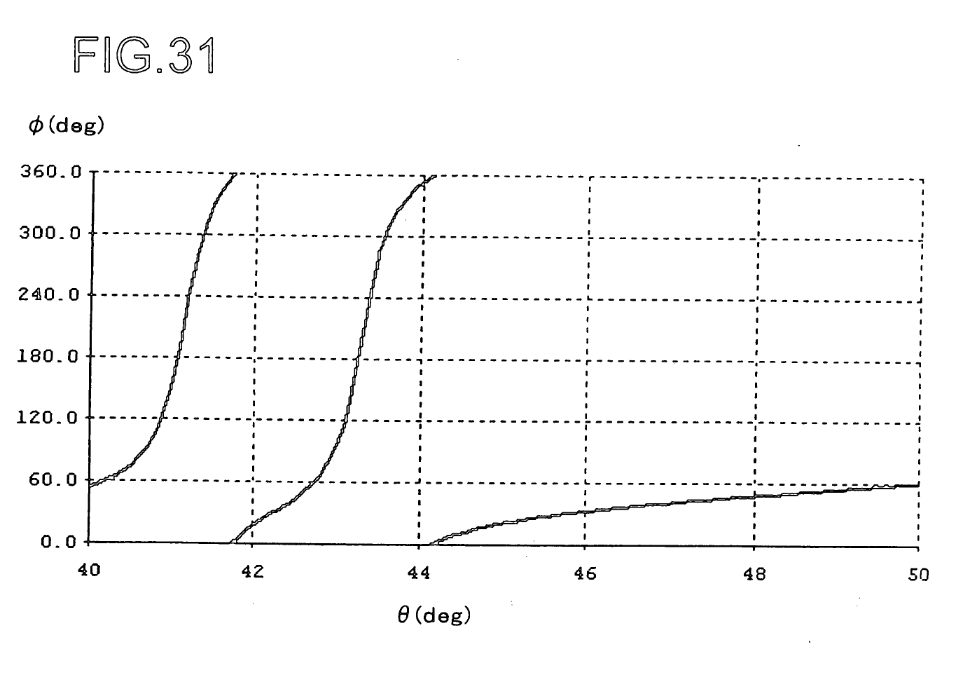

FIG. 30 shows the polarization separation characteristics of Comparative Example 1 as plotted in terms of transmissivity T (%). FIG. 30 shows the transmissivity Tp (θ) of p-polarized light and the transmissivity Ts (θ) of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). FIG. 31 shows the reflection-induced phase shift φ (20) of s-polarized light (with a wavelength λ of 405 nm) as observed in the range of incidence angles θ from 40° to 50° in Comparative Example 1. As will be understood from FIG. 31, around incidence angles θ from 40° to 44°, the curve that represents the reflection-induced phase shift φ of s-polarized light have inflection points. Thus, in Comparative Example 1, when it receives divergent light at incidence angles θ of 45±5°, the phase shift of s-polarized light changes irregularly, lowering the wavefront accuracy of s-polarized light. Incidentally, the s-polarized light reflected from the polarization beam splitter film is subjected to interference-based evaluation using a reference plate, whereby a bend is observed in the image of the transmitted wavefront of the s-polarized light transmitted through the reference plate, permitting the degradation of the transmitted wavefront accuracy to be confirmed.

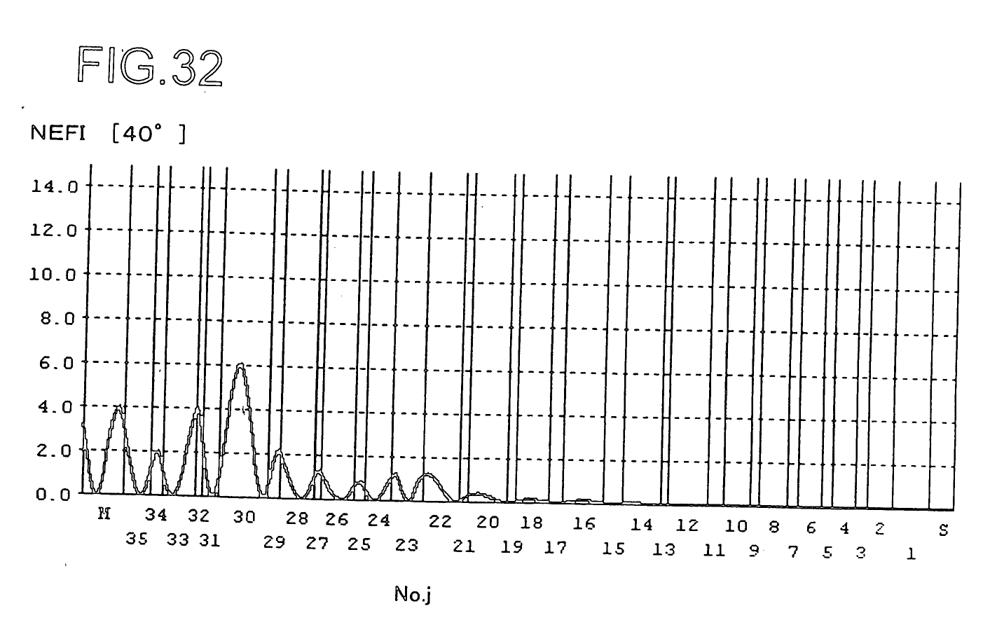

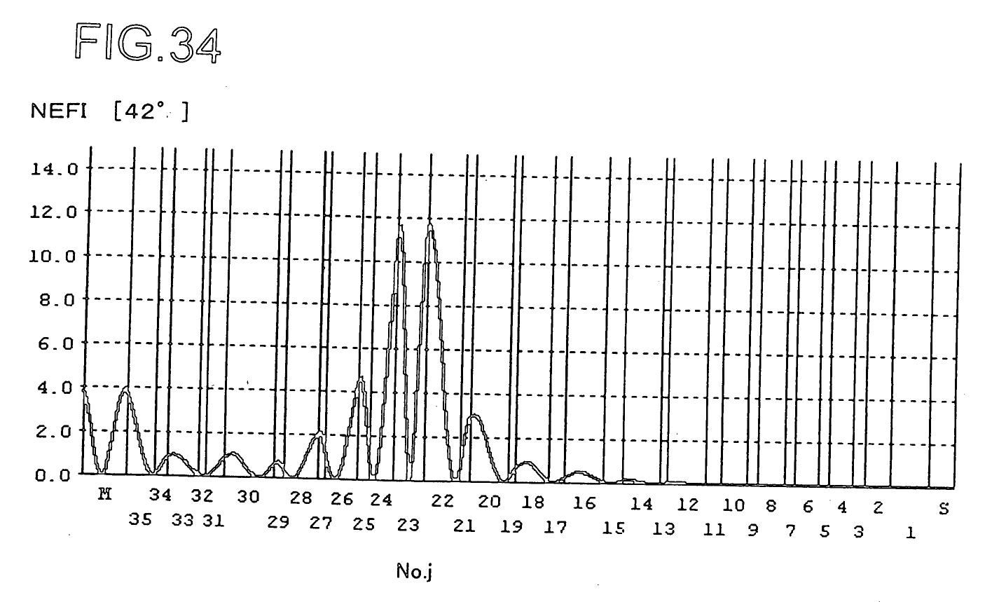

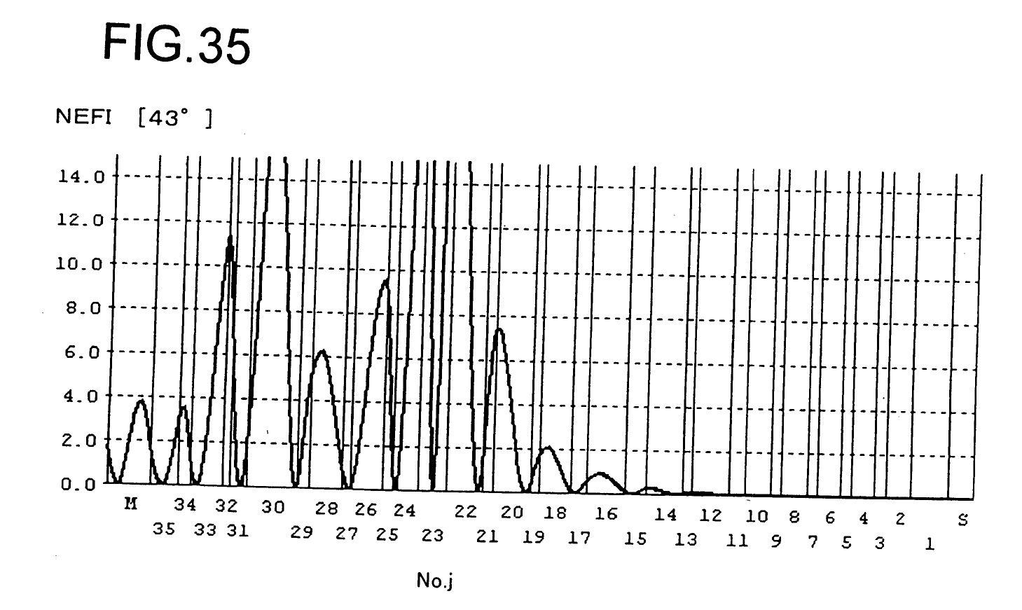

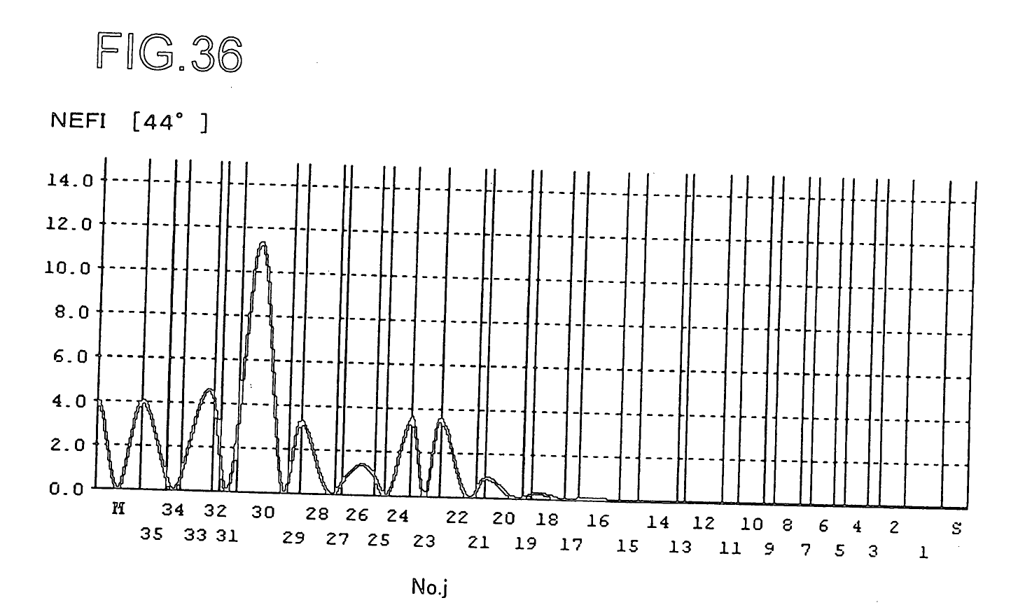

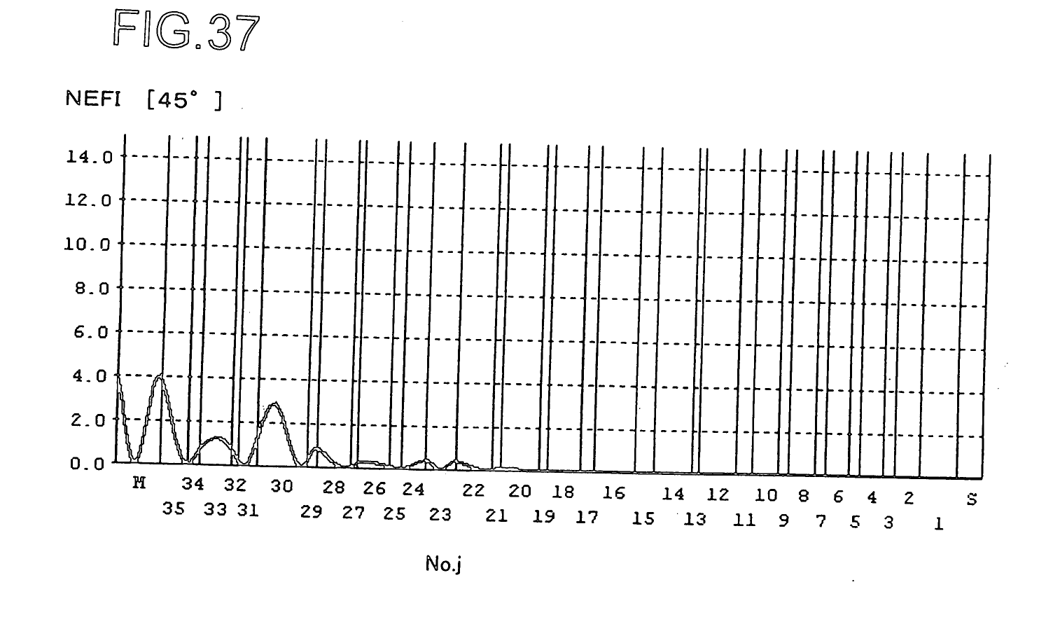

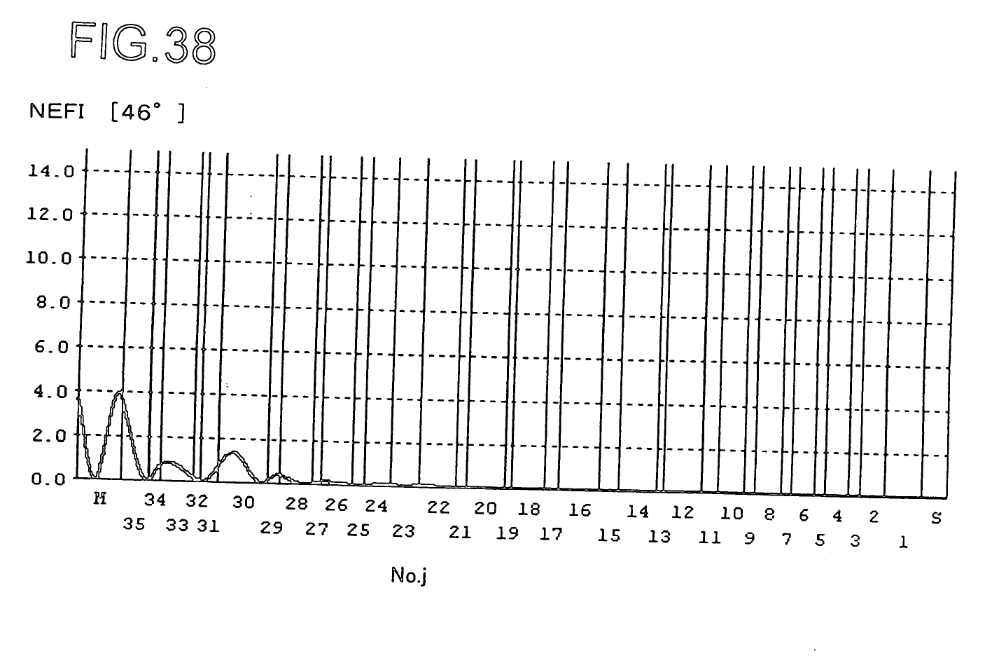

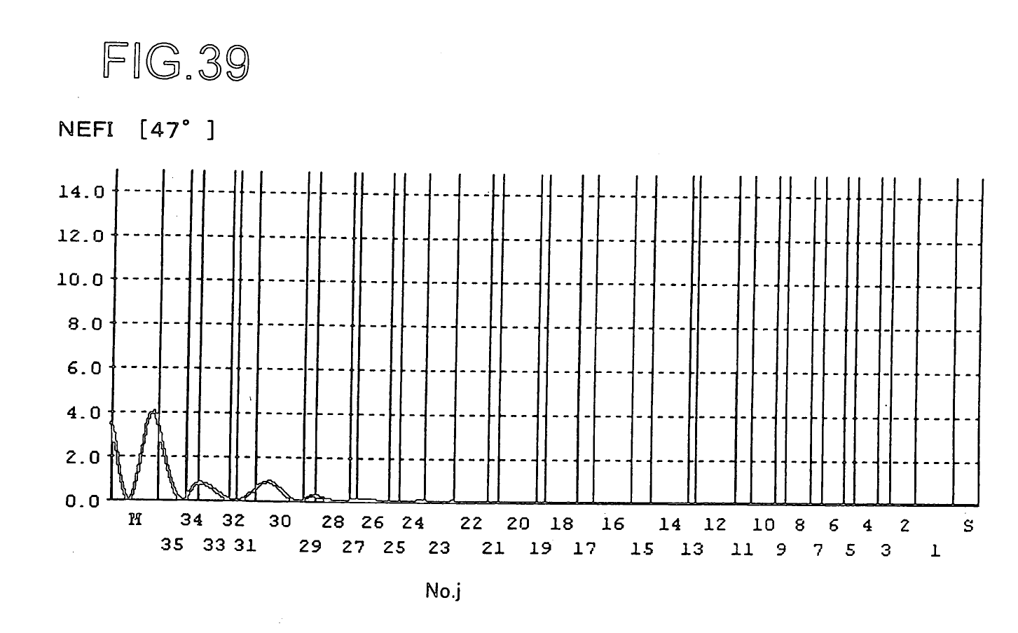

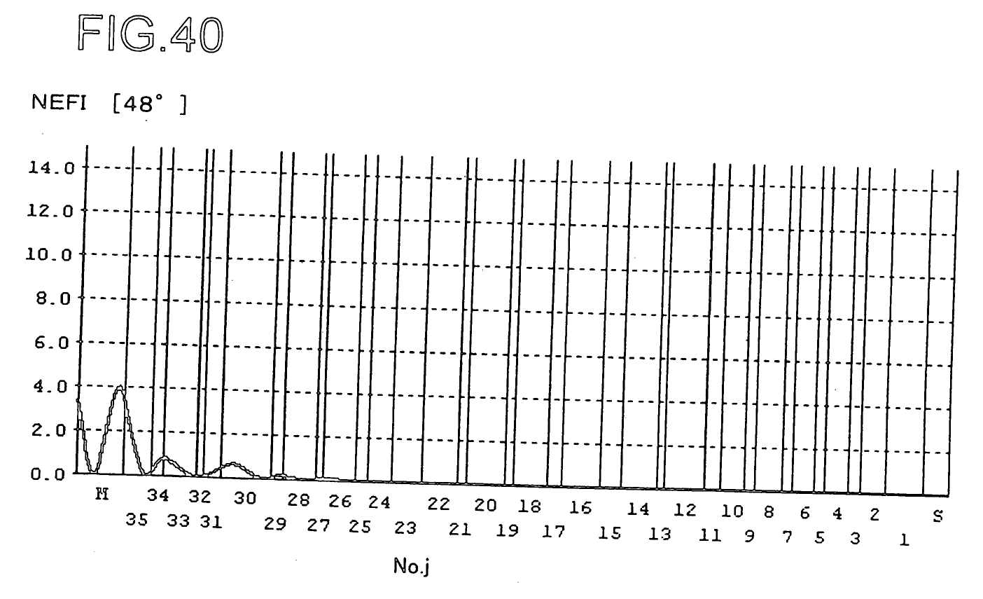

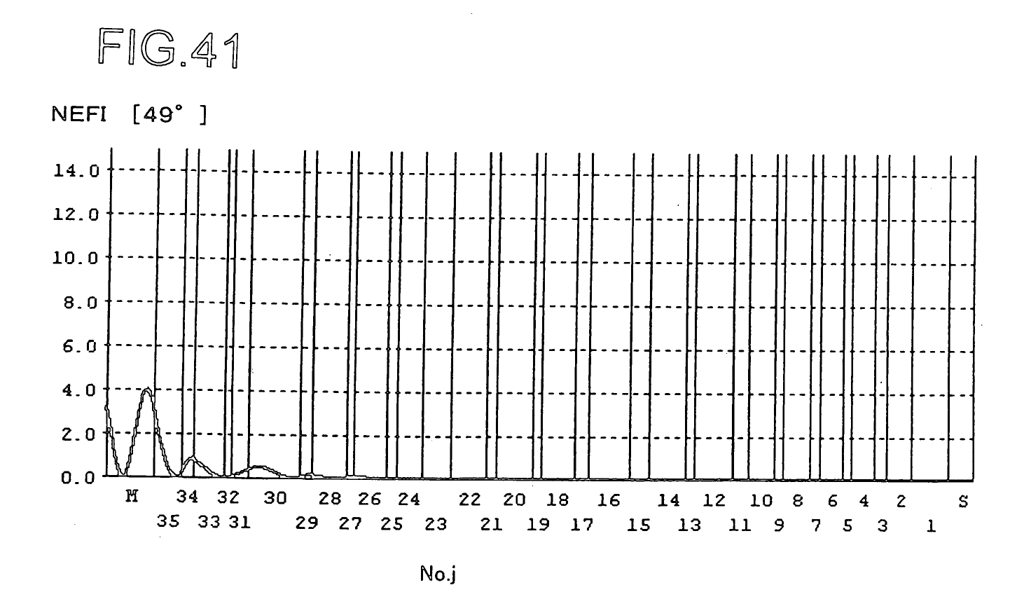

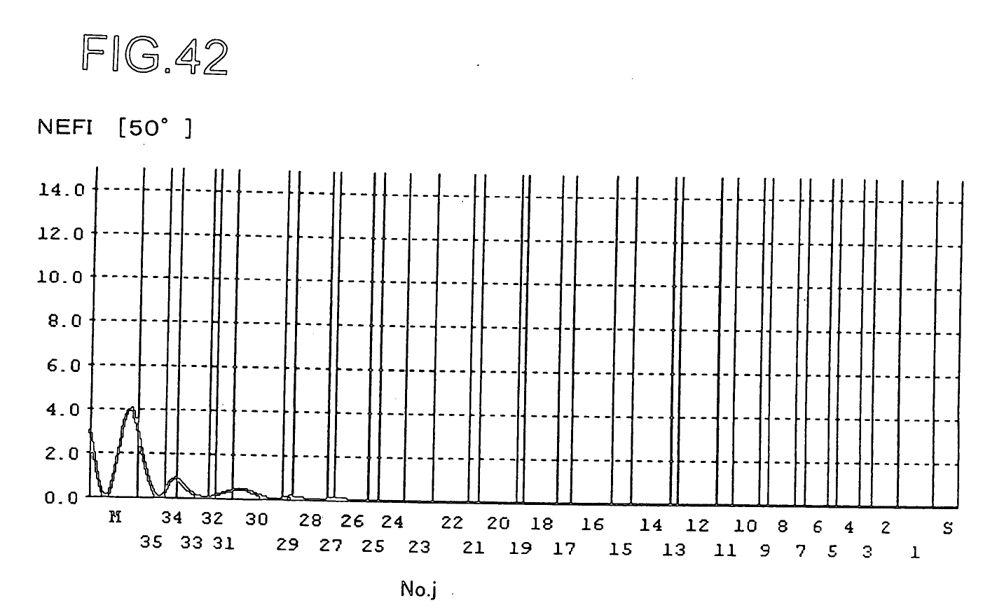

FIGS. 32 to 42 show the electric field intensity distribution of s-polarized light (with a wavelength λ of 405 nm) as observed at each integer angle in the range of incidence angles θ from 40° to 50° in Comparative Example 1. In the graphs of FIGS. 32 to 42, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 32 to 42, the vertical axis represents the normalized electric field intensity (NEFI) of the layers.

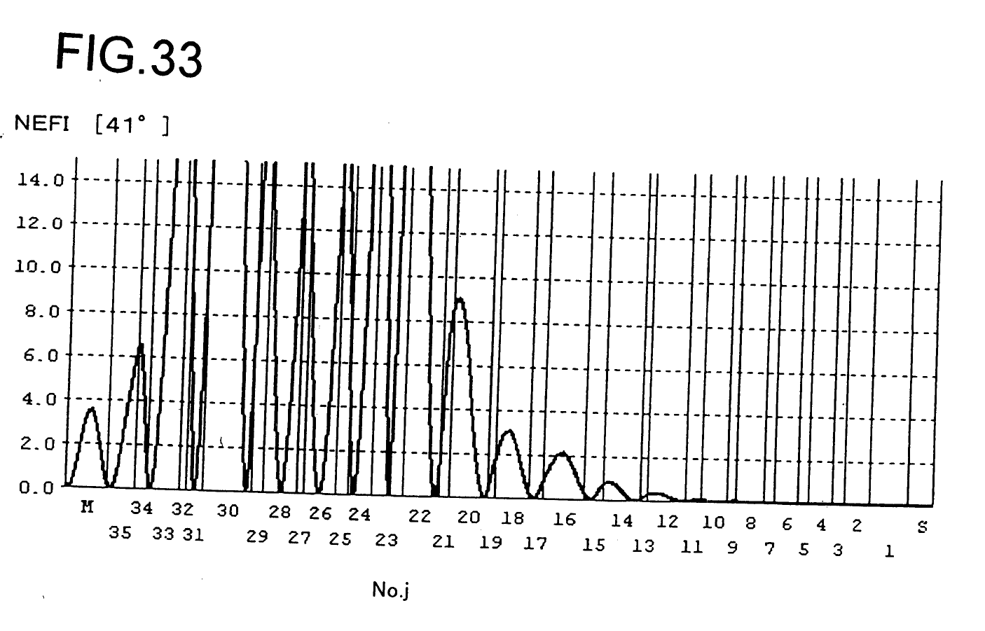

In Comparative Example 1, the reflection-induced phase shift of s-polarized light is not controlled linearly with respect to the incidence angle (FIG. 31), and thus, at incidence angles at which the curve representing the reflection-induced phase shift φ of s-polarized light has inflection points, several middle layers exhibit a sharp increase in electric field intensity (FIGS. 33 to 36). Also in Examples 1 and 2 described earlier, at the design stage, the graphs of the phase shift observed therein include gentle curves. However, here, attention is focused on the range of incidence angles in which part of the layers exhibit a sharp increase in electric field intensity, and the electric field intensity distribution is so controlled as not to increase. In this way, the phase shift is made linear. By contrast, in a case where, as in Comparative Example 1, inflection points are observed in a desired range of incidence angles (θ in the range from 40° to 50°), it is extremely difficult to control the reflection-induced phase shift of s-polarized light linearly with respect to the incidence angle even with the help of automatic calculation performed on a computer or by the use of a method exploiting the monotonic decrease of the electric field intensity distribution.

As an example of a polarization beam splitter film obtained by modifying Comparative Example 1 so that the reflection-induced phase shift of s-polarized light is made linear with respect to the incidence angle with the help of automatic calculation performed on a computer in such a way as not to degrade the polarization separation characteristics, Table 4 shows the multiple-layer construction of Comparative Example 2 (QWOT=4∘n∘d/λ0, where d represents the physical film thickness; n represents the refractive index; and λ0 represents the design wavelength). In the polarization beam splitter film of Comparative Example 2, on a glass substrate M (with a refractive index of 1.64) disposed on the light-entrance side, there are laid a total of 32 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between. Here, as a result of the automatic calculation, the number of layers N is reduced from 35 to 32.

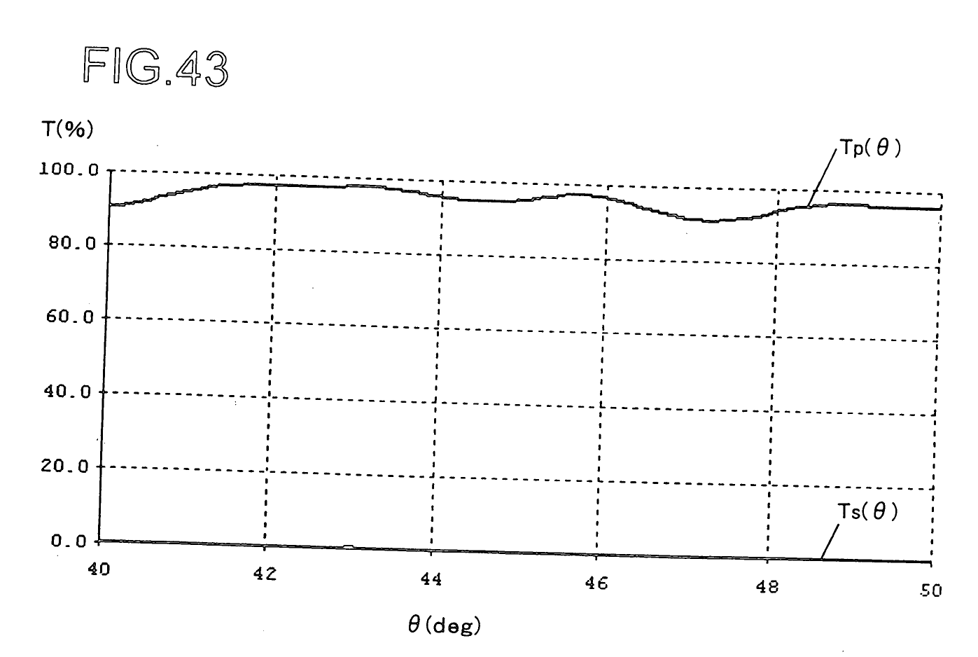

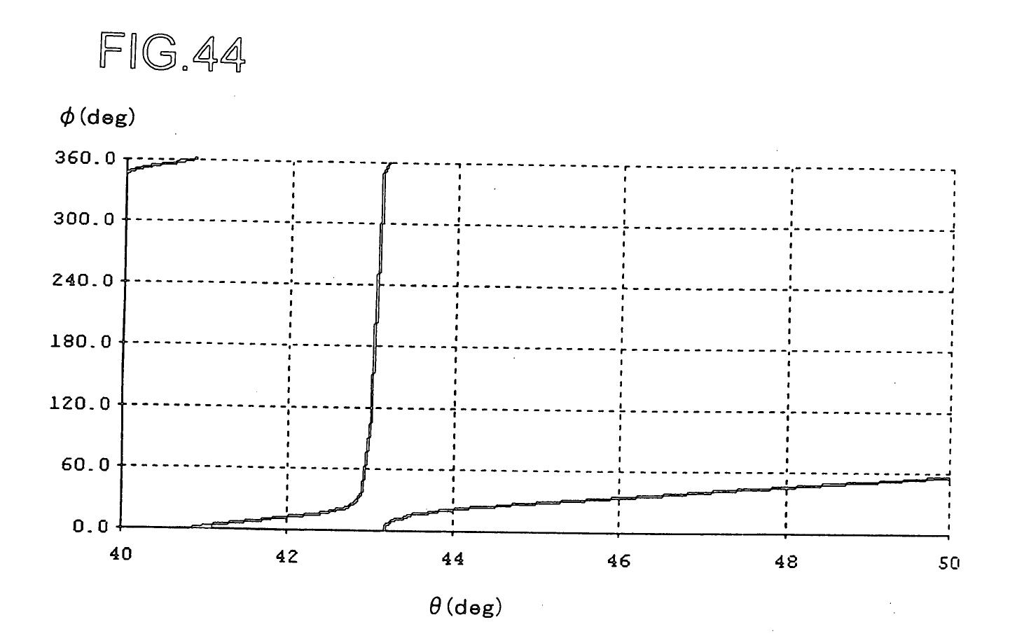

FIG. 43 shows the polarization separation characteristics of Comparative Example 2 as plotted in terms of transmissivity T (%). FIG. 43 shows the transmissivity Tp (θ) of p-polarized light and the transmissivity Ts (θ) of s-polarized light as observed at a wavelength λ of 405 nm, in the range of incidence angles θ from 40° to 50° with respect to the film surface (i.e., in the ±5° range of incidence angles with respect to the reference incidence angle λ0 of 45°). FIG. 44 shows the reflection-induced phase shift φ (°) of s-polarized light (with a wavelength λ of 405 nm) as observed in the range of incidence angles θ from 40° to 50° in Comparative Example 2. As will be understood from FIG. 44, although linearity is achieved over a wide range of incidence angles, the inflection point around an incidence angle θ of 43° is not removed but remains in an extraordinarily deformed form. A point like this which cannot be removed even with the help of automatic designing for linearity will hereinafter be referred to as a “singular point”.

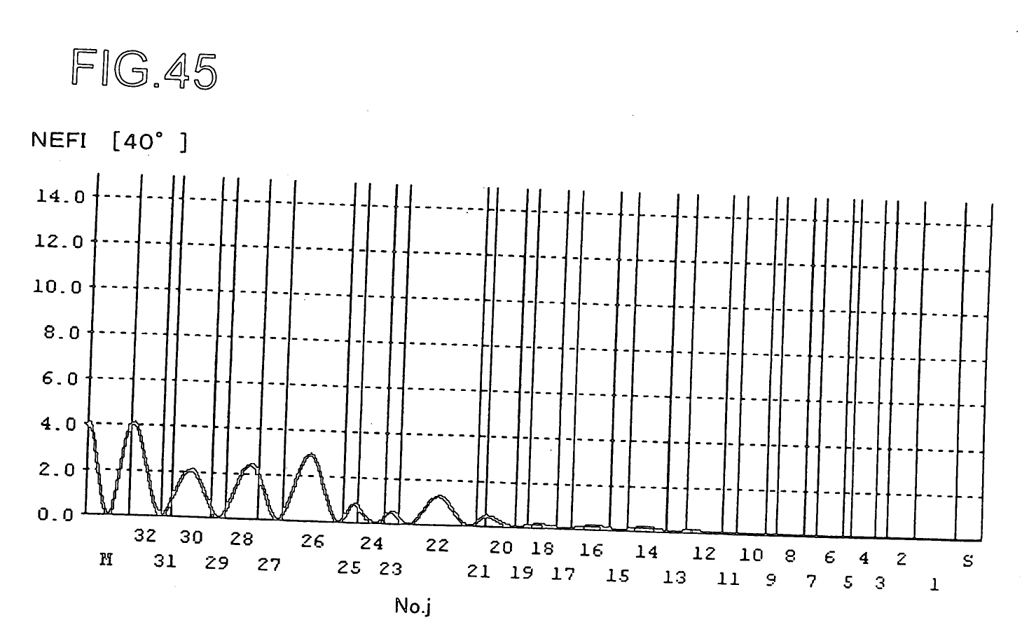

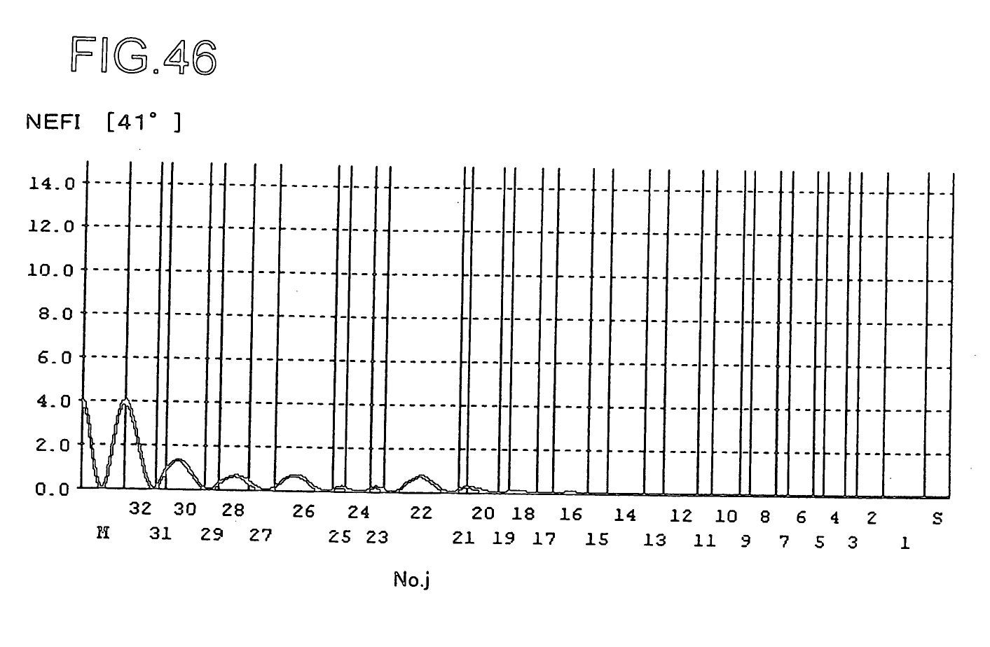

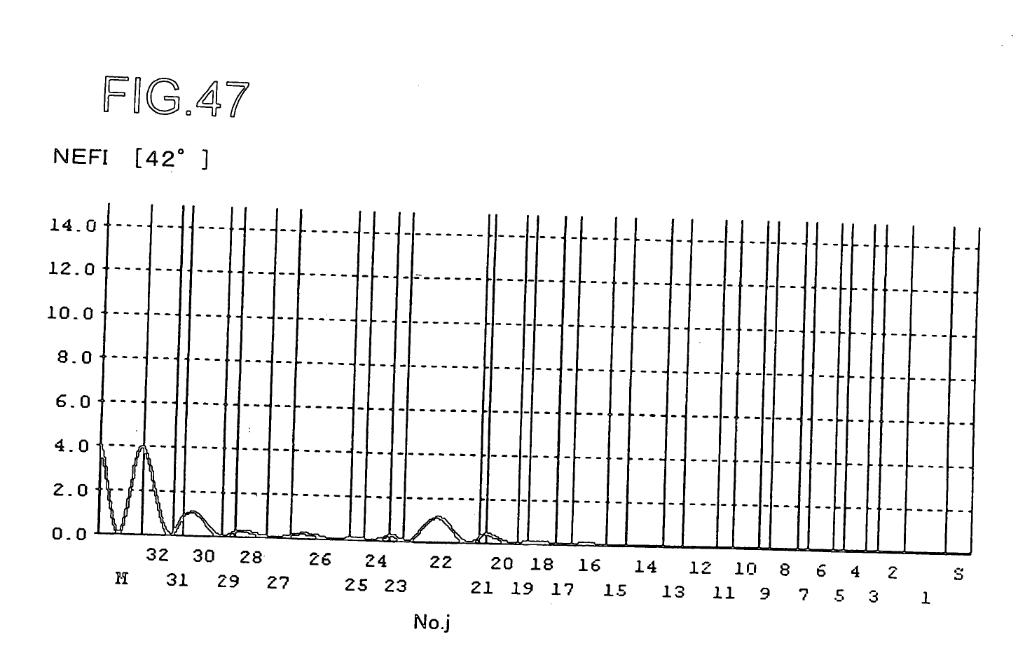

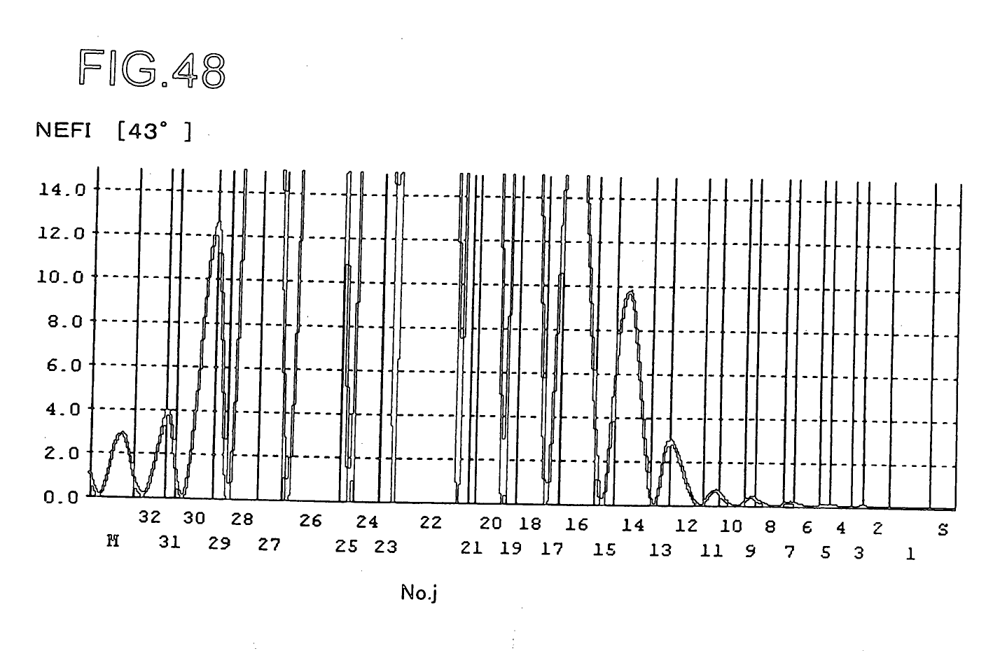

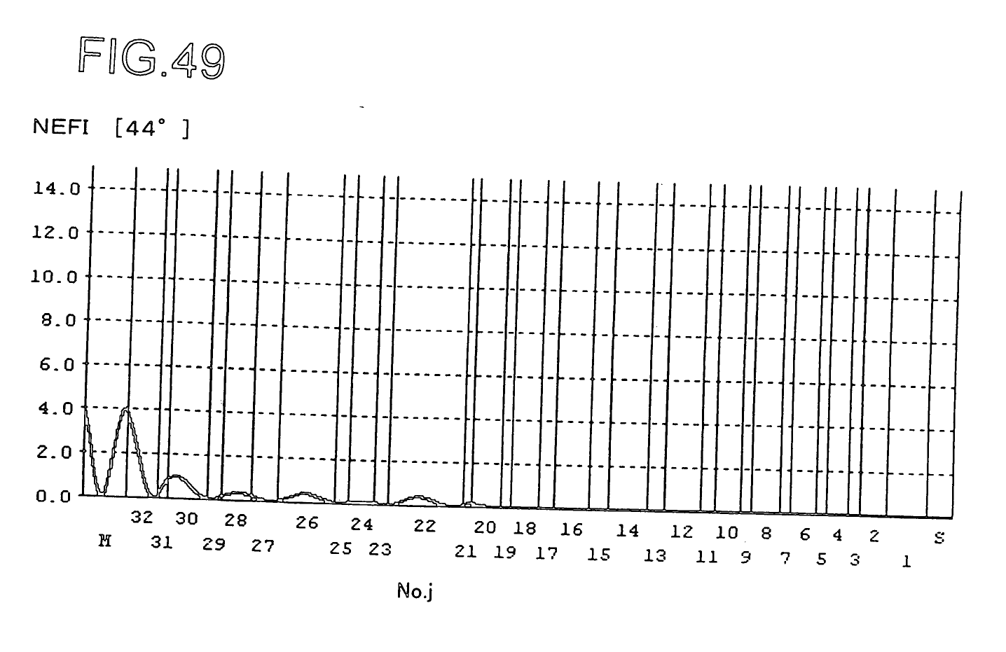

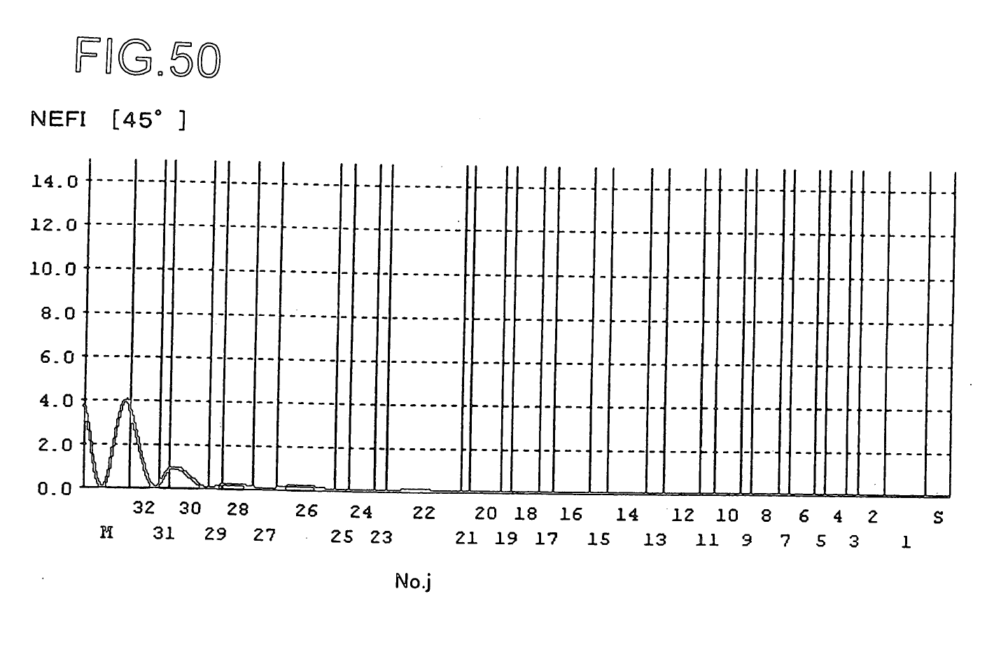

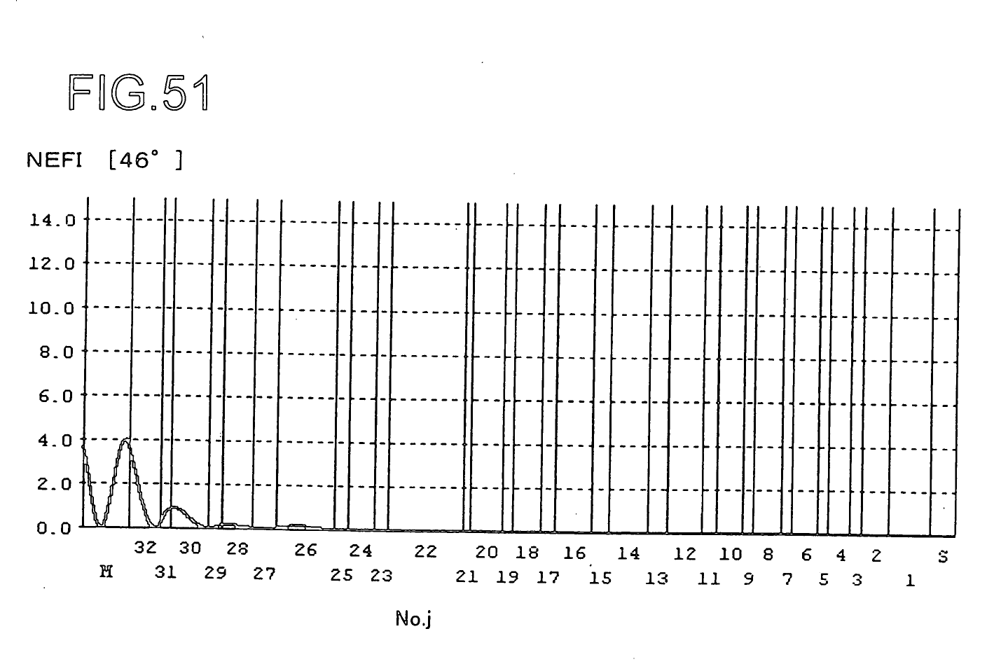

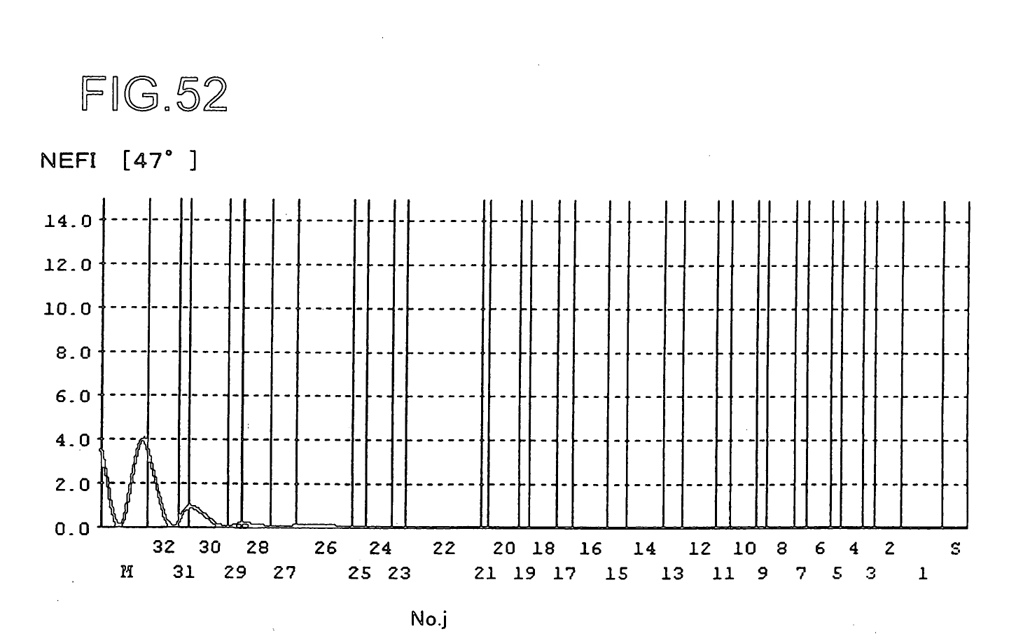

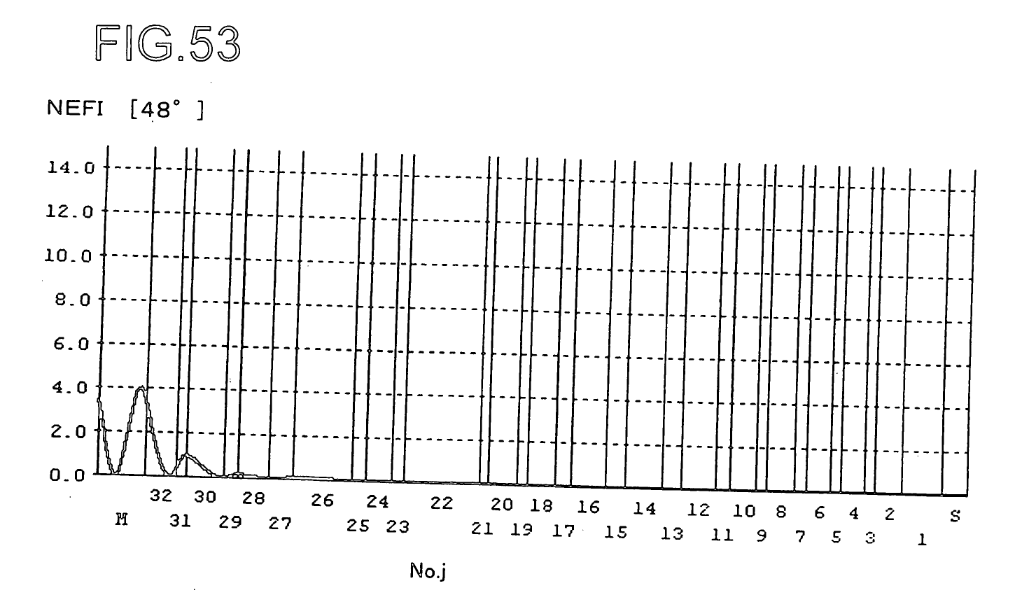

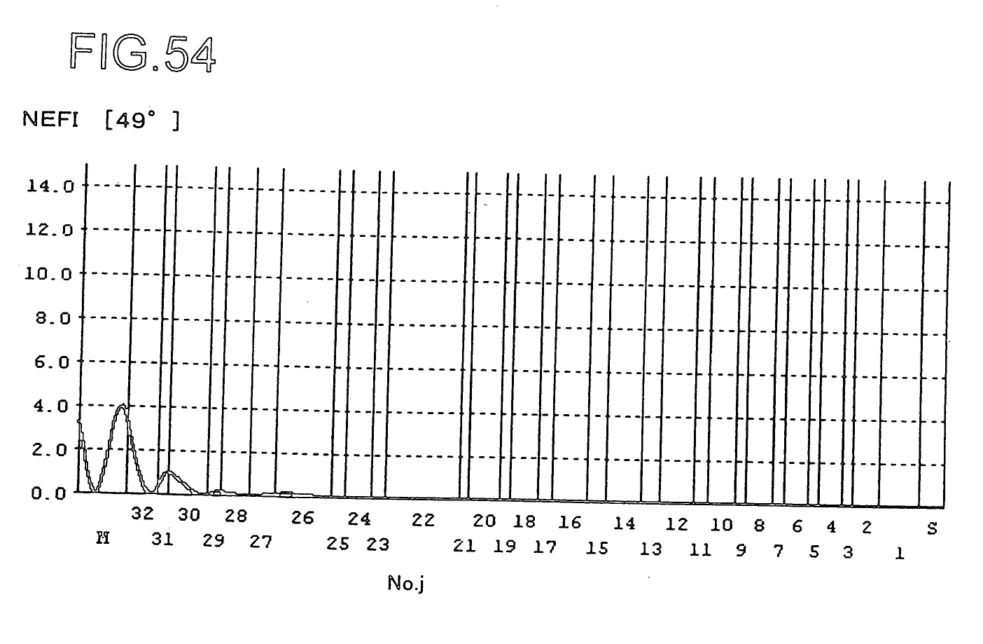

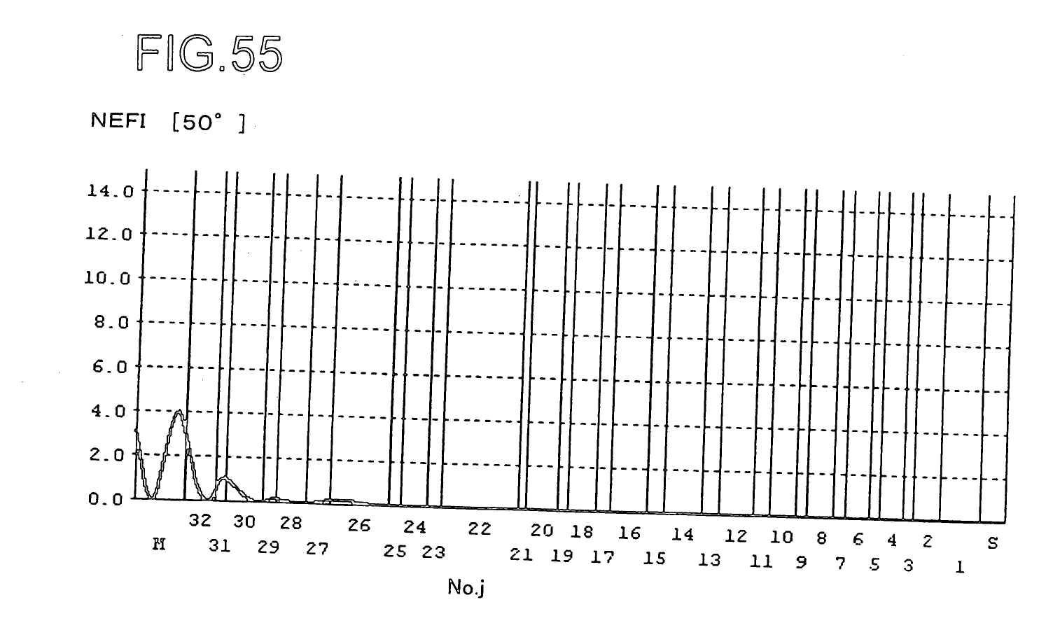

FIGS. 45 to 55 show the electric field intensity distribution of s-polarized light (with a wavelength λ of 405 nm) as observed at each integer angle in the range of incidence angles θ from 40° to 50° in Comparative Example 2. In the graphs of FIGS. 45 to 55, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 45 to 55, the vertical axis represents the normalized electric field intensity (NEFI) of the layers. As will be understood from FIG. 48, at an incidence angle θ of 43° around the singular point, several middle layers exhibit a sharp increase in electric field intensity.

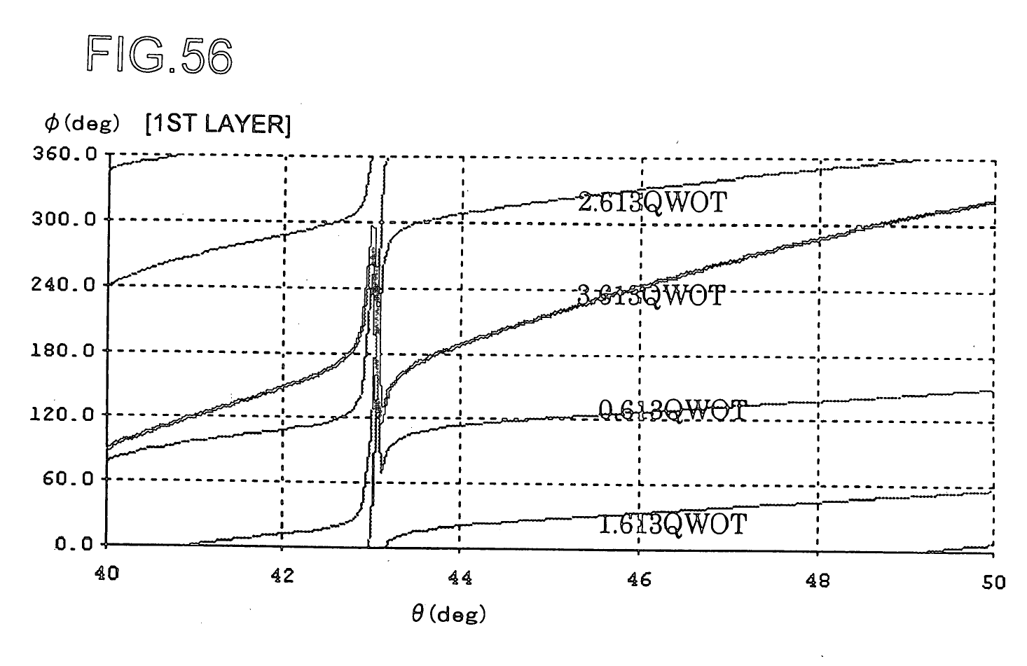

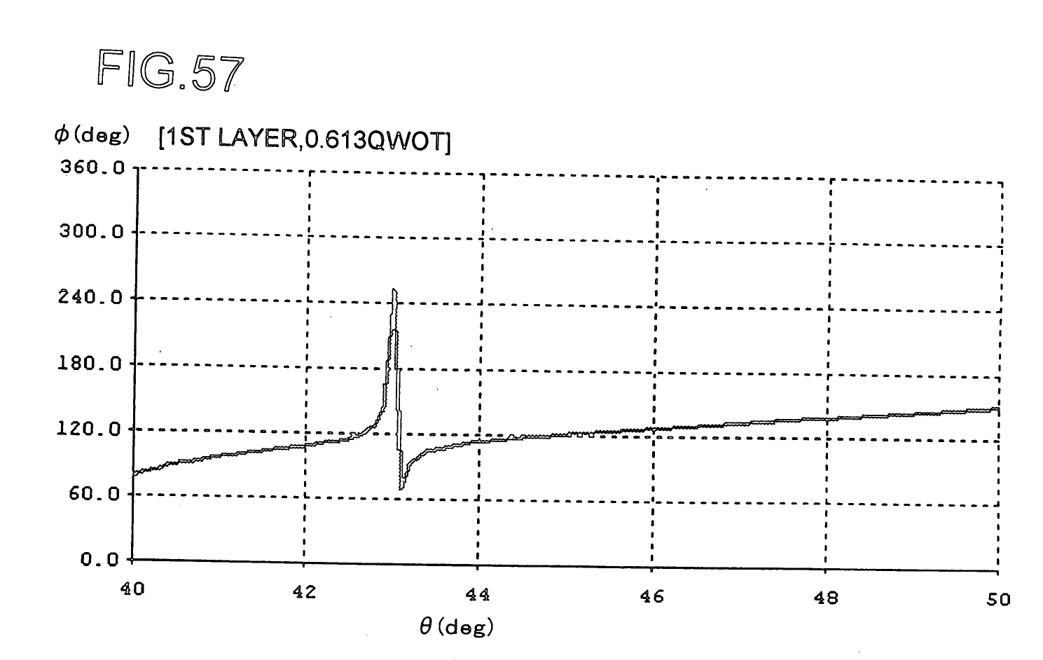

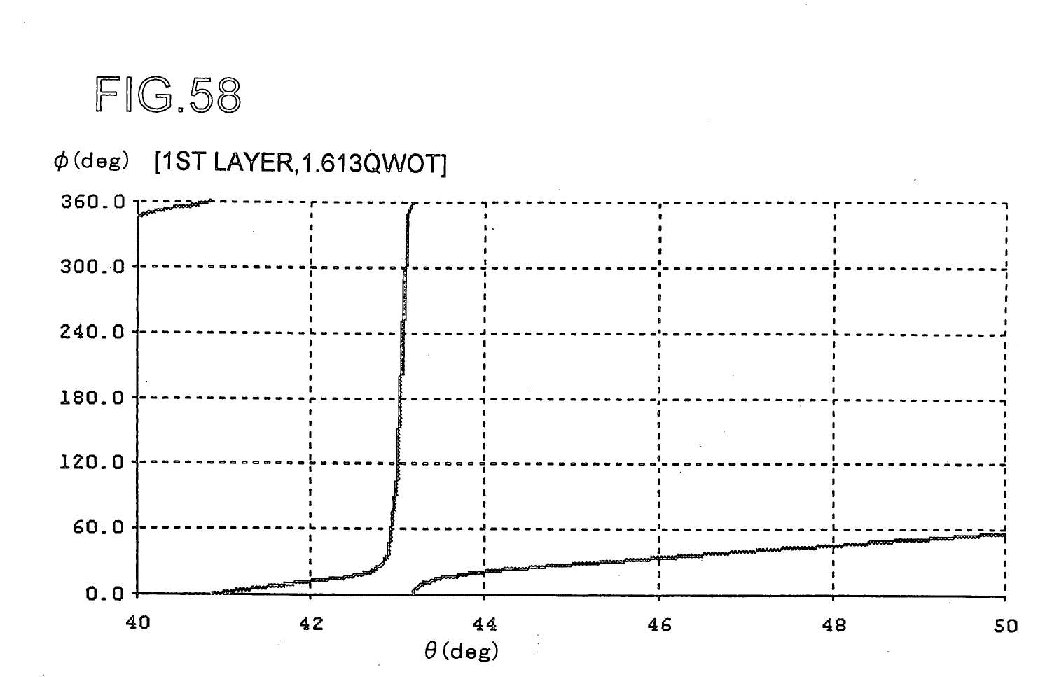

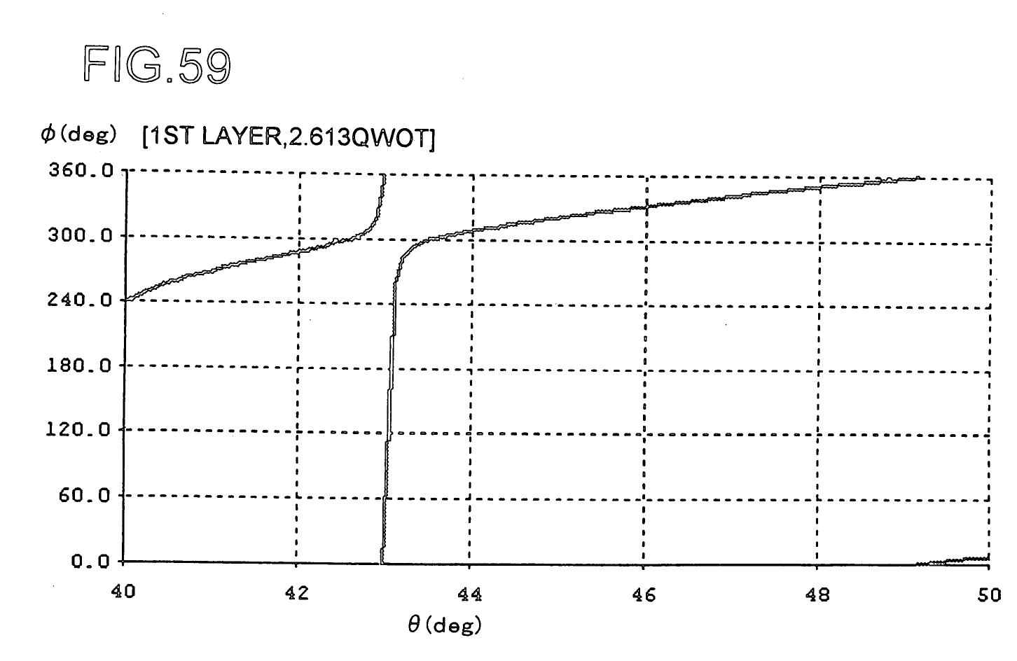

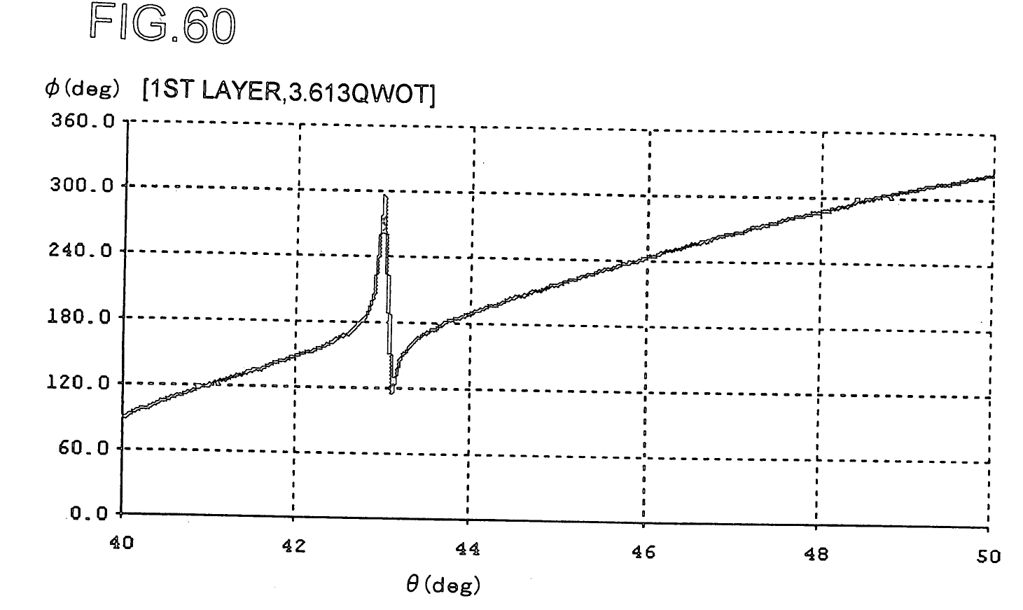

Now, how the phase shift changes when the film thickness of a given layer is varied in four steps, at 1QWOT increments from the design value thereof, in Comparative Example 2 will be studied. FIG. 56 shows the reflection-induced phase shift φ (°) of s-polarized light (with a wavelength λ of 405 nm) as observed in the range of incidence angles θ from 40° to 50° when the film thickness of the first layer (i=1, j=32) is varied in four steps at 1QWOT increments from the design value thereof. The four phase shift curves shown in FIG. 56 are shown separately in FIGS. 57 to 60. As the film thickness is varied, the value of the phase shift varies upward or downward; meanwhile, the singular points remains around 43°.

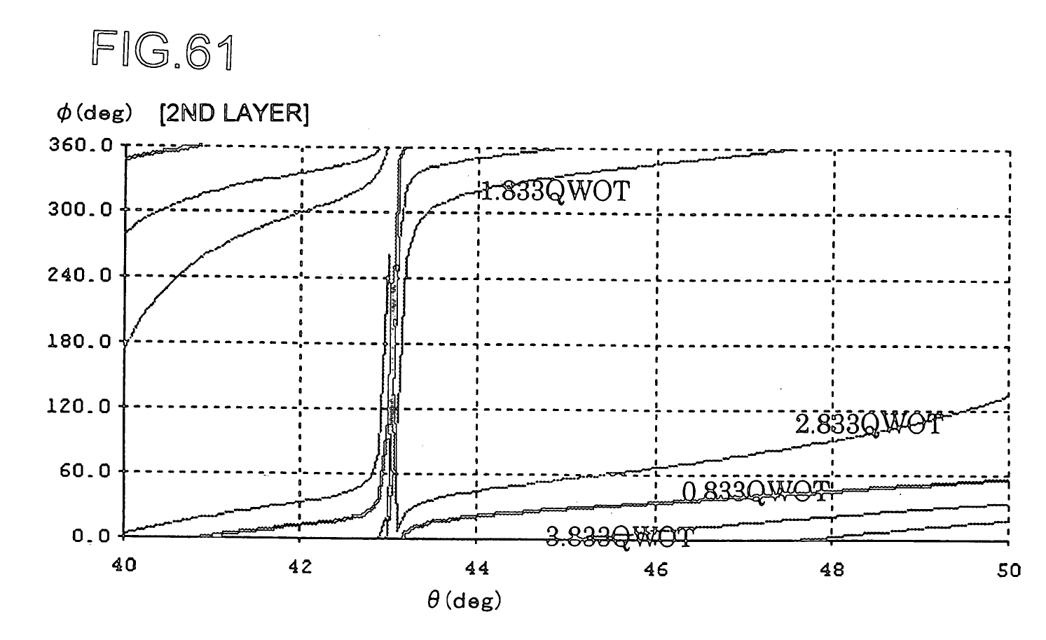

FIG. 61 shows the reflection-induced phase shift φ (°) of s-polarized light (with a wavelength λ of 405 nm) as observed in the range of incidence angles θ from 40° to 50° when the film thickness of the second layer (i=2, j=31) is varied in four steps at 1QWOT increments from the design value thereof. As the film thickness is varied, the value of the phase shift varies upward or downward little by little; meanwhile, the singular points remains around 43°.

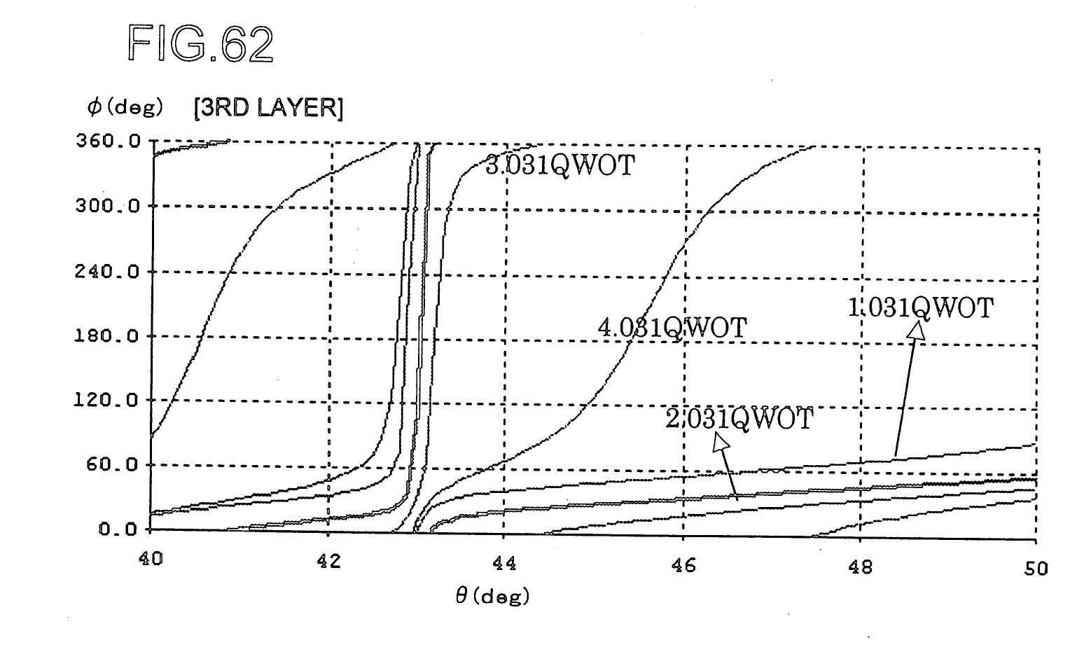

FIG. 62 shows the reflection-induced phase shift φ (°) of s-polarized light (with a wavelength λ of 405 nm) as observed in the range of incidence angles θ from 40° to 50° when the film thickness of the third layer (i=3, j=30) is varied in four steps at 1QWOT increments from the design value thereof. As the film thickness is varied, the phase shift varies less upward or downward, and instead varies more in a way as if revolving about the singular point. Meanwhile, the singular points remains around 43°.

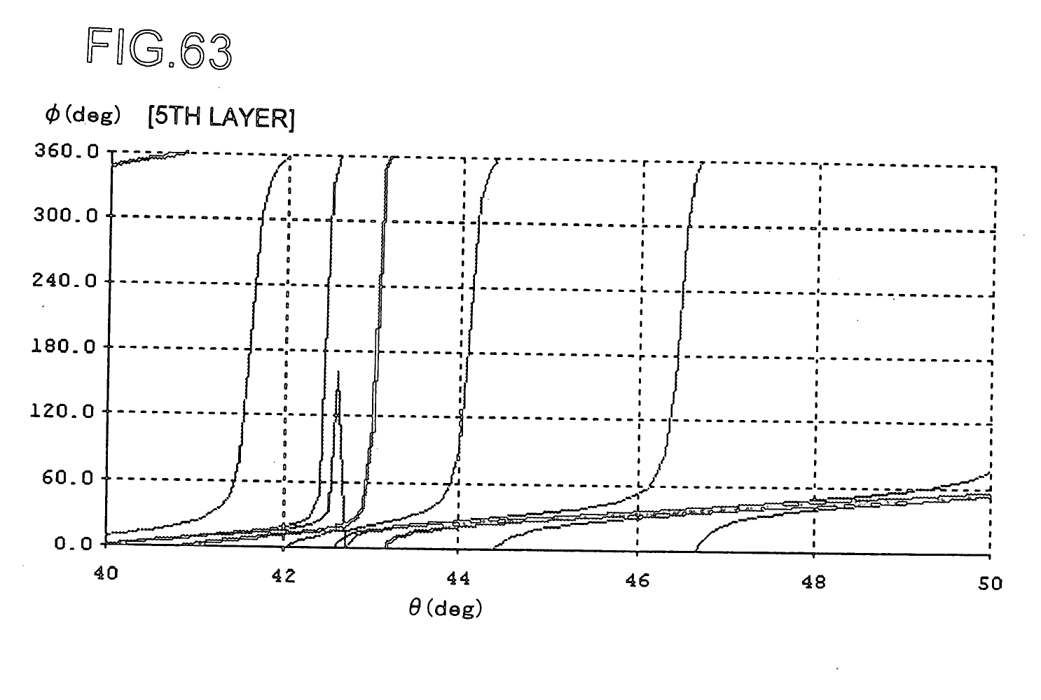

FIG. 63 shows the reflection-induced phase shift φ (°) of s-polarized light (with a wavelength λ of 405 nm) as observed in the range of incidence angles θ from 40° to 50° when the film thickness of the fifth layer (i=5, j=28) is varied in four steps at 1QWOT increments from the design value thereof. As the film thickness is varied, the phase shift exhibits hardly any up/down or revolving variation, and instead exhibits chiefly transverse variation. While singular points are observed also in other ranges of incidence angles, the one around 43° still exists.

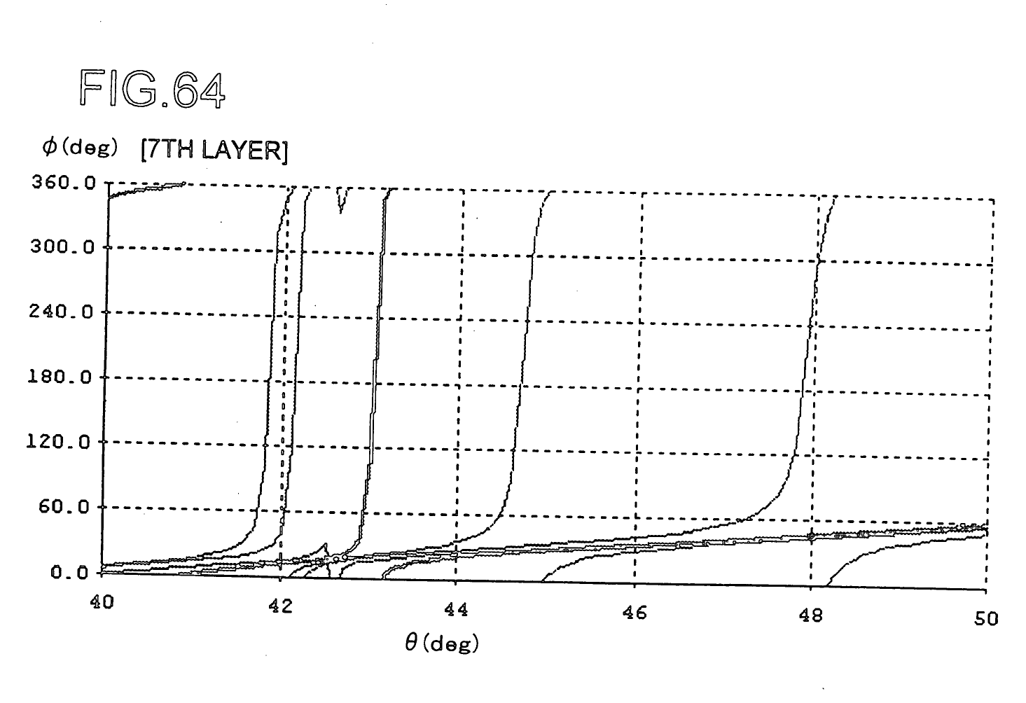

FIG. 64 shows the reflection-induced phase shift φ (°) of s-polarized light (with a wavelength λ of 405 rnm) as observed in the range of incidence angles θ from 40° to 50° when the film thickness of the seventh layer (i=7, j=26) is varied in four steps at 1QWOT increments from the design value thereof. While singular points are observed also in other ranges of incidence angles, the one around 43° still exists.

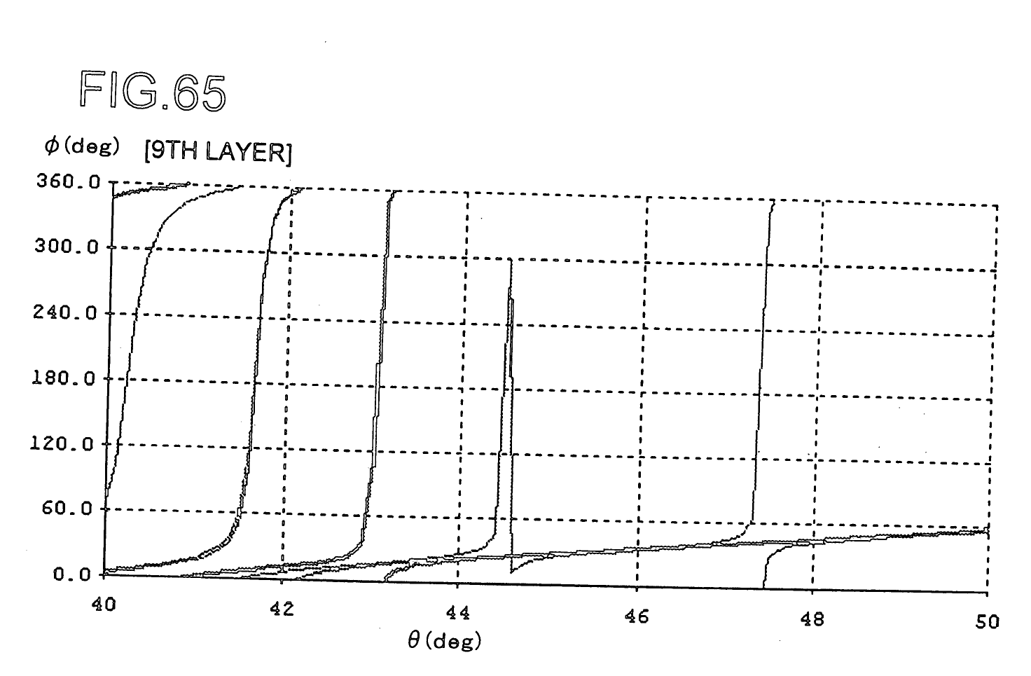

FIG. 65 shows the reflection-induced phase shift φ (°) of s-polarized light (with a wavelength λ of 405 nm) as observed in the range of incidence angles θ from 40° to 50° when the film thickness of the ninth layer (i=9, j=24) is varied in four steps at 1QWOT increments from the design value thereof. As the film thickness is varied, the singular point starts moving transversely little by little away from around 43°.

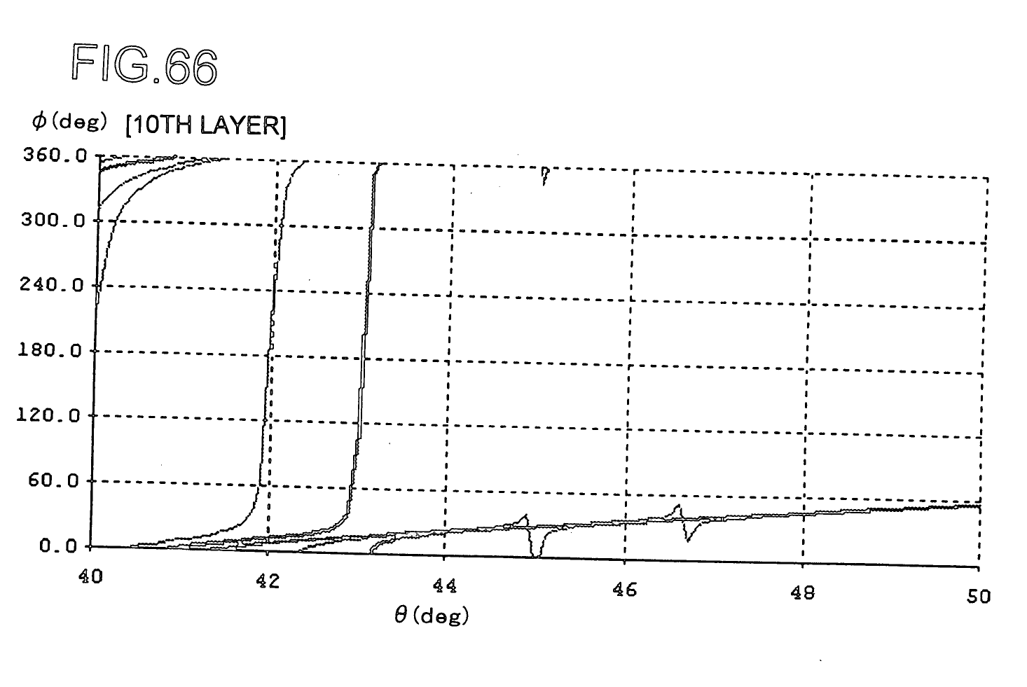

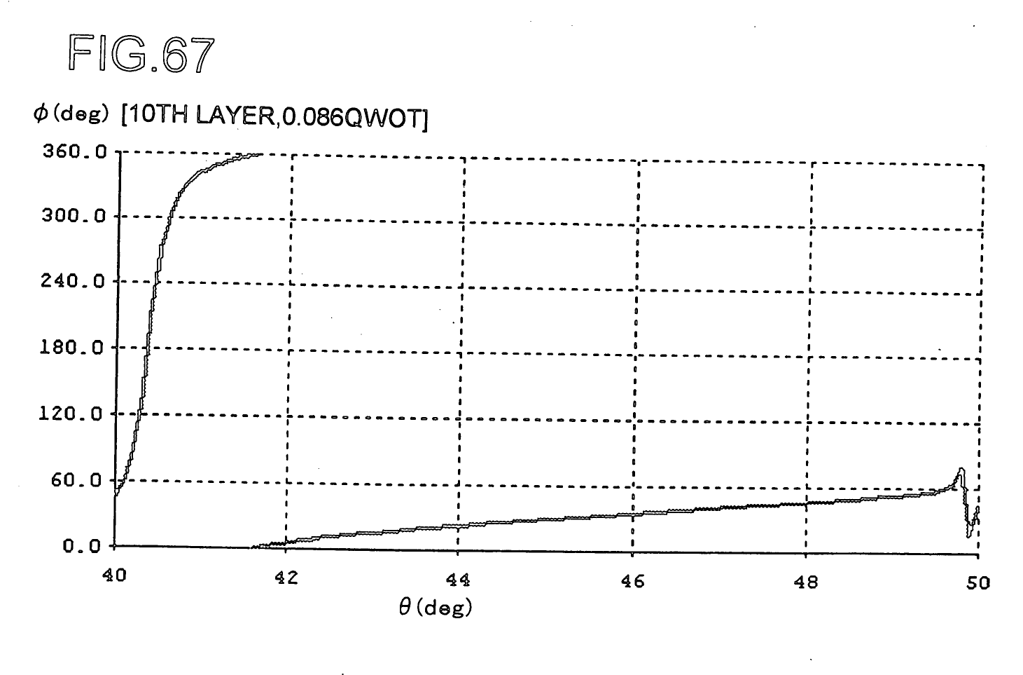

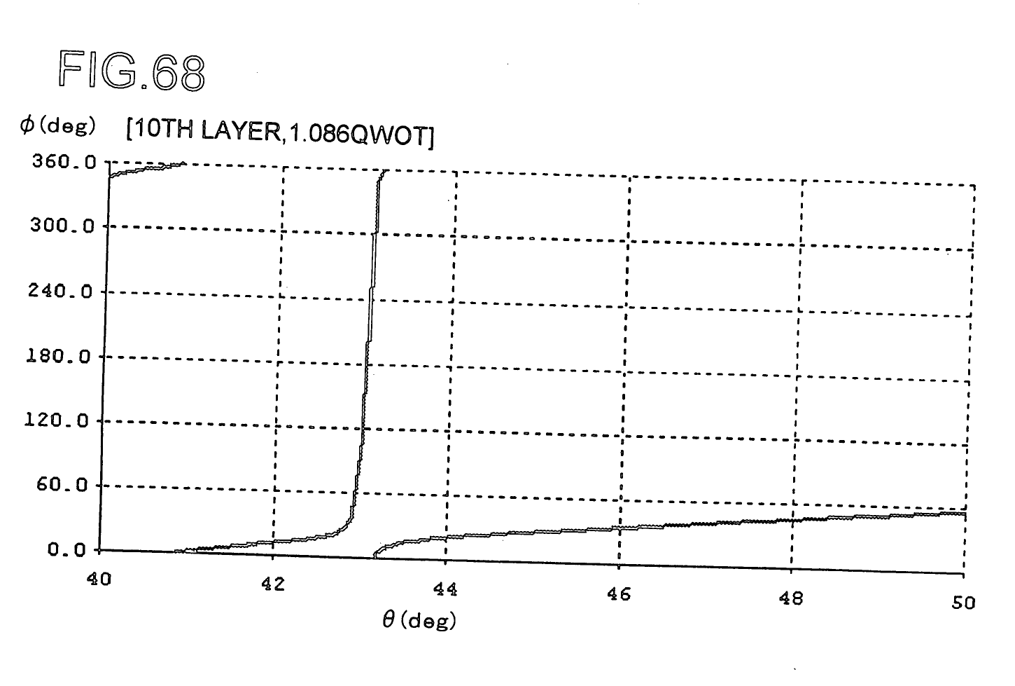

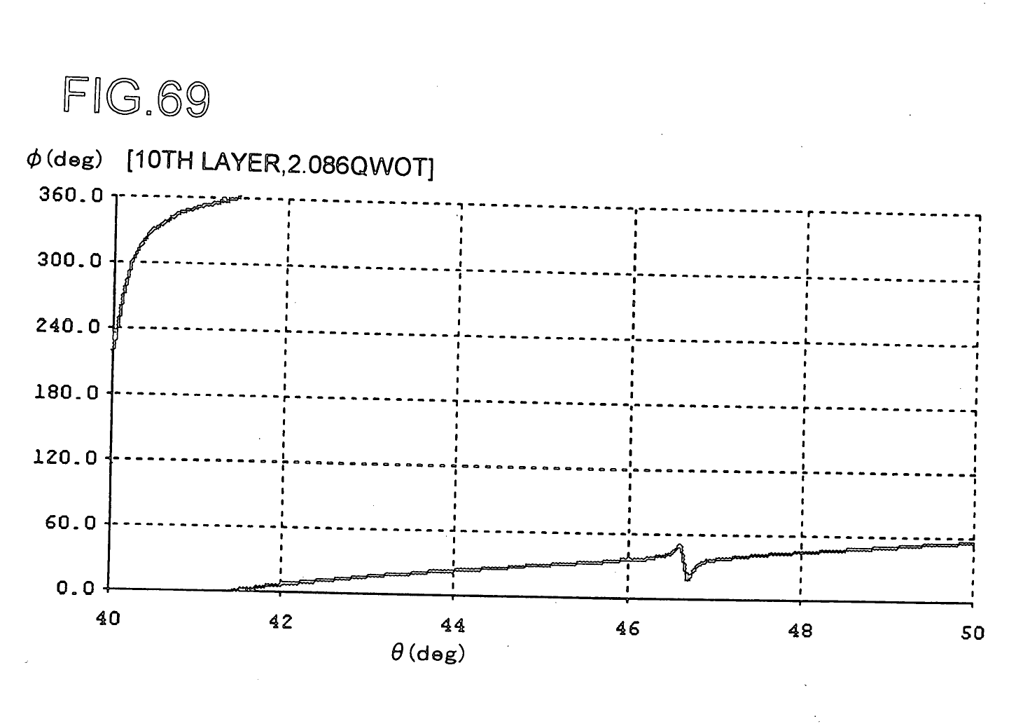

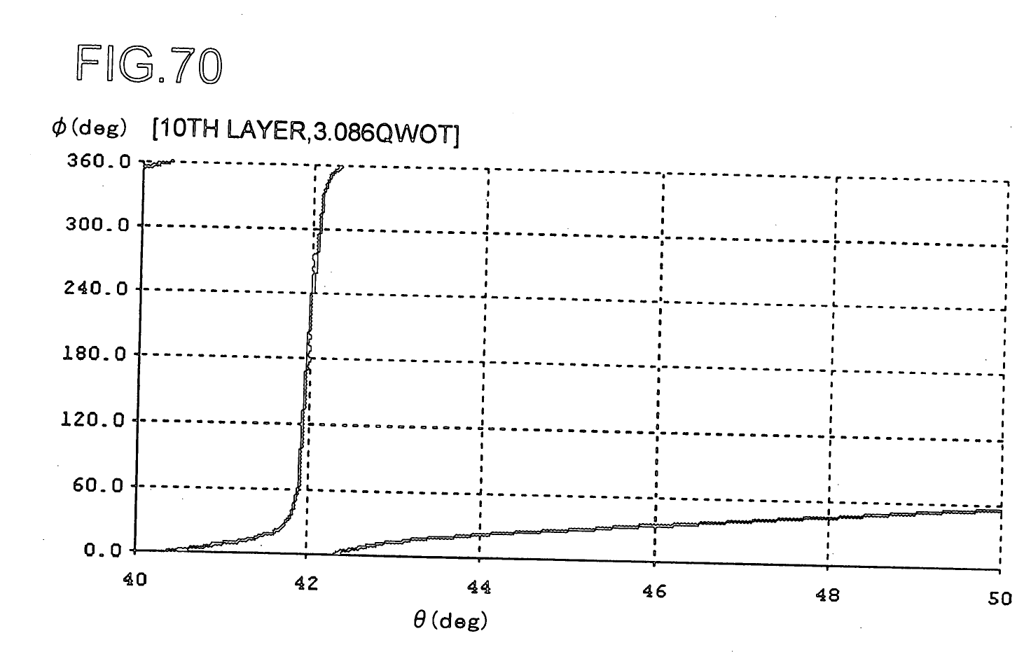

FIG. 66 shows the reflection-induced phase shift φ (°) of s-polarized light (with a wavelength λ of 405 nm) as observed in the range of incidence angles θ from 40° to 50° when the film thickness of the tenth layer (i=10, j=23) is varied in four steps at 1QWOT increments from the design value thereof. The four phase shift curves shown in FIG. 66 are shown separately in FIGS. 67 to 70. As the film thickness is varied, the singular point moves considerably away from around 43°.

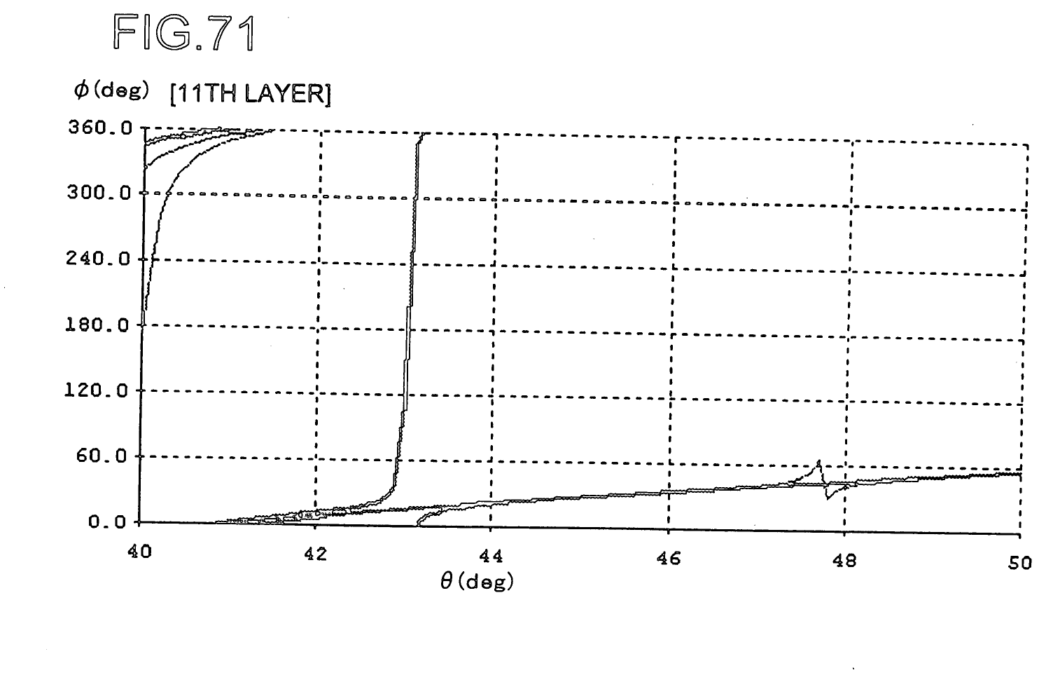

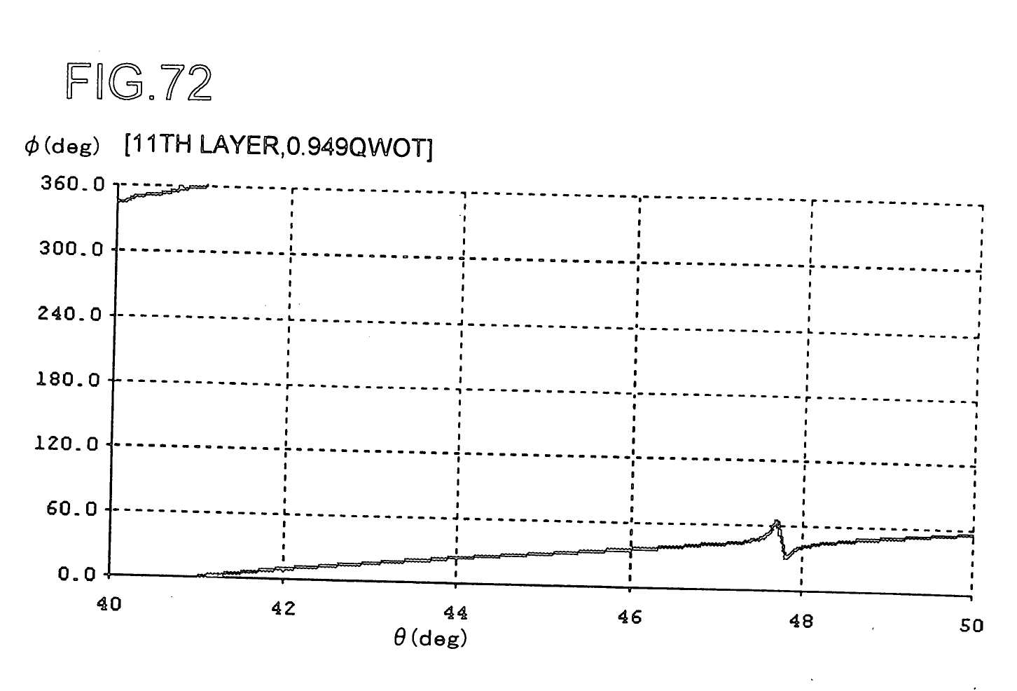

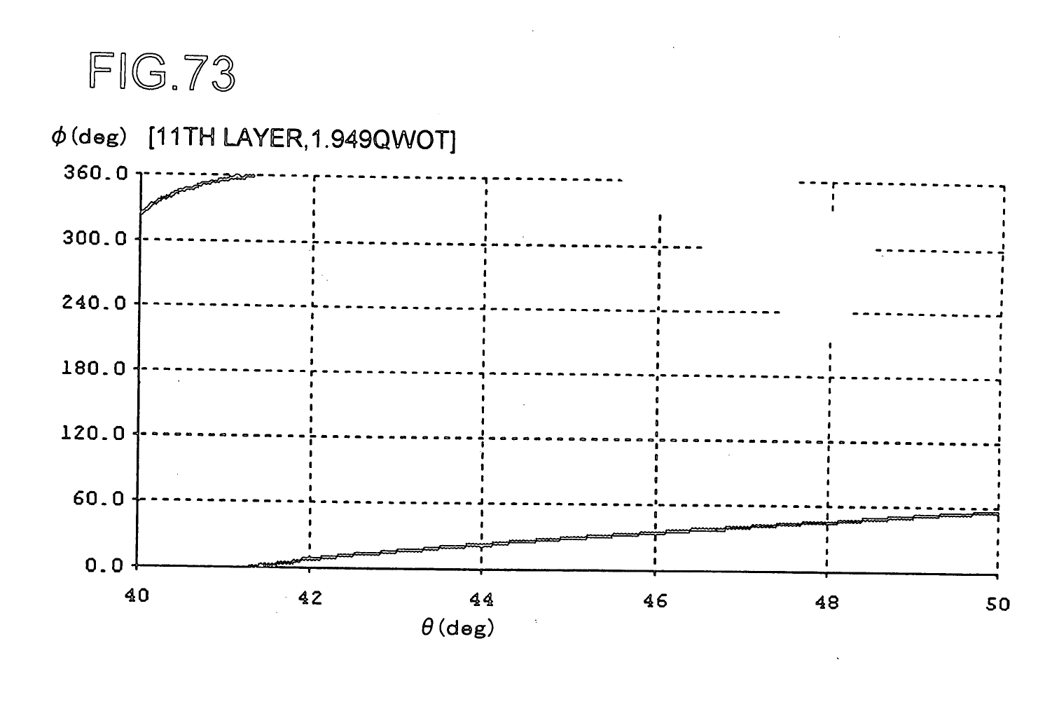

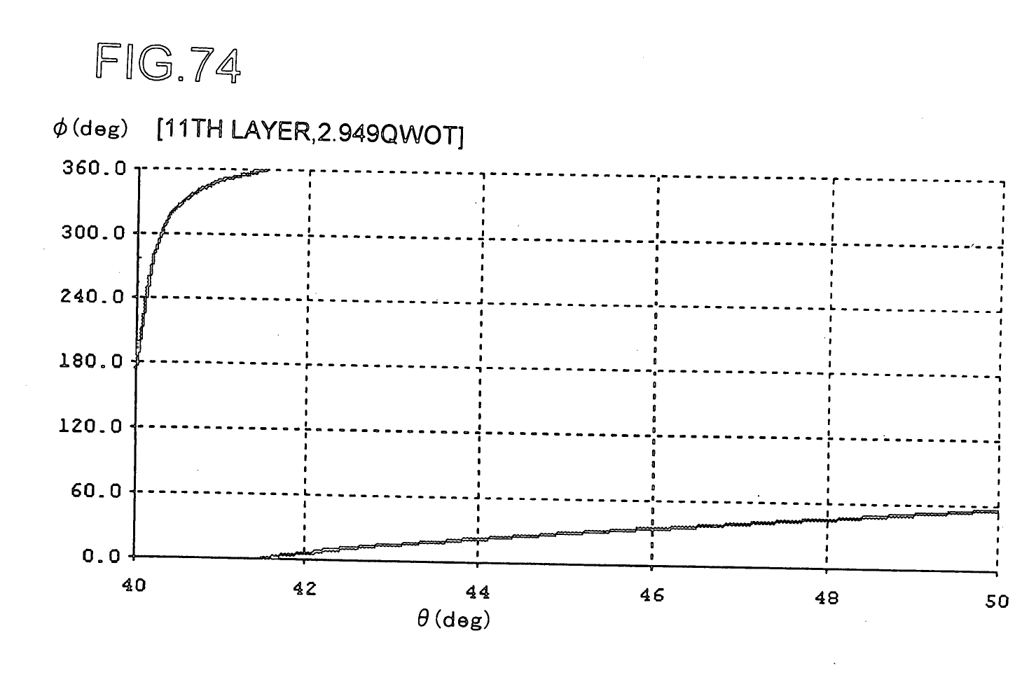

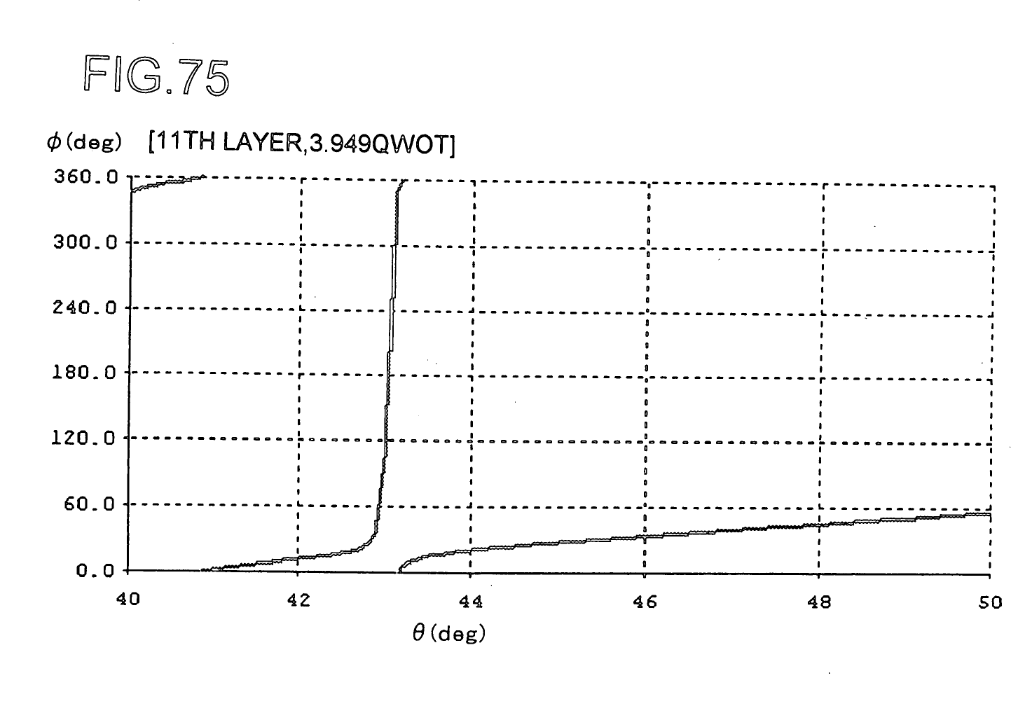

FIG. 71 shows the reflection-induced phase shift φ (°) of s-polarized light (with a wavelength λ of 405 nm) as observed in the range of incidence angles θ from 40° to 50° when the film thickness of the eleventh layer (i=11, j=22) is varied in four steps at 1QWOT increments from the design value thereof. The four phase shift curves shown in FIG. 71 are shown separately in FIGS. 72 to 75. As the film thickness is varied, the singular point moves greatly away from around 43°.

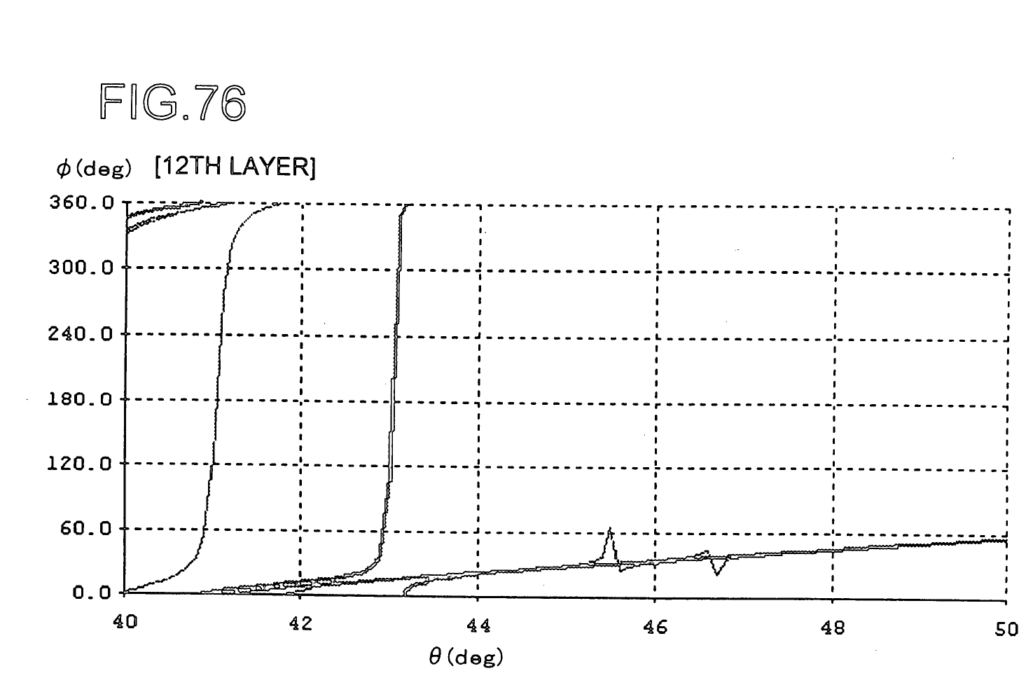

FIG. 76 shows the reflection-induced phase shift φ (°) of s-polarized light (with a wavelength λ of 405 nm) as observed in the range of incidence angles θ from 40° to 50° when the film thickness of the twelfth layer (i=12, j=21) is varied in four steps at 1QWOT increments from the design value thereof. As the film thickness is varied, the singular point moves considerably away from around 43°.

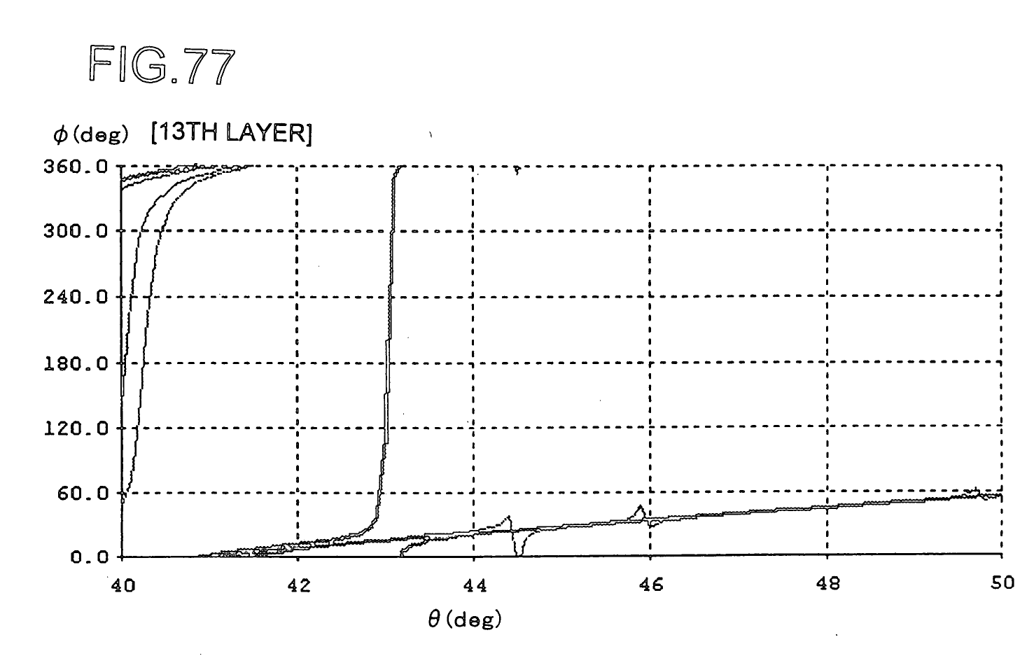

FIG. 77 shows the reflection-induced phase shift φ (20) of s-polarized light (with a wavelength λ of 405 nm) as observed in the range of incidence angles θ from 40° to 50° when the film thickness of the thirteenth layer (i=13, j=20) is varied in four steps at 1QWOT increments from the design value thereof. As the film thickness is varied, the singular point moves modestly away from around 43°.

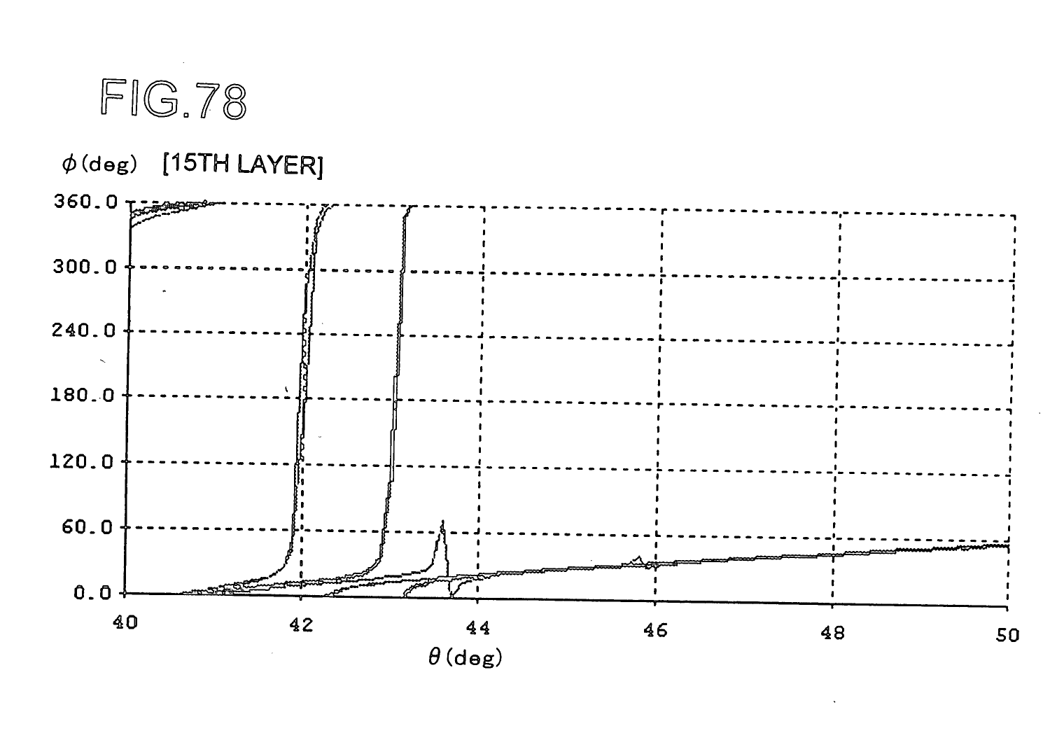

FIG. 78 shows the reflection-induced phase shift φ (°) of s-polarized light (with a wavelength λ of 405 nm) as observed in the range of incidence angles θ from 40° to 50° when the film thickness of the fifteenth layer (i=15, j=18) is varied in four steps at 1QWOT increments from the design value thereof. As the film thickness is varied, the singular point moves modestly away from around 43°.

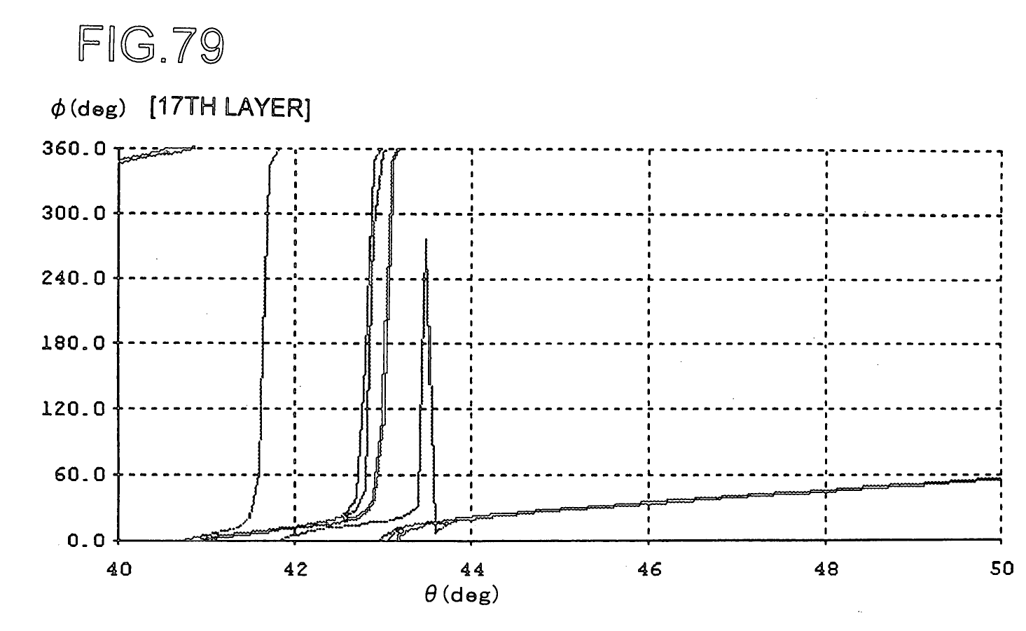

FIG. 79 shows the reflection-induced phase shift φ (°) of s-polarized light (with a wavelength λ of 405 nm) as observed in the range of incidence angles θ from 40° to 50° when the film thickness of the seventeenth layer (i=17, j=16) is varied in four steps at 1QWOT increments from the design value thereof. As the film thickness is varied, the singular point moves little by little away from around 43°.

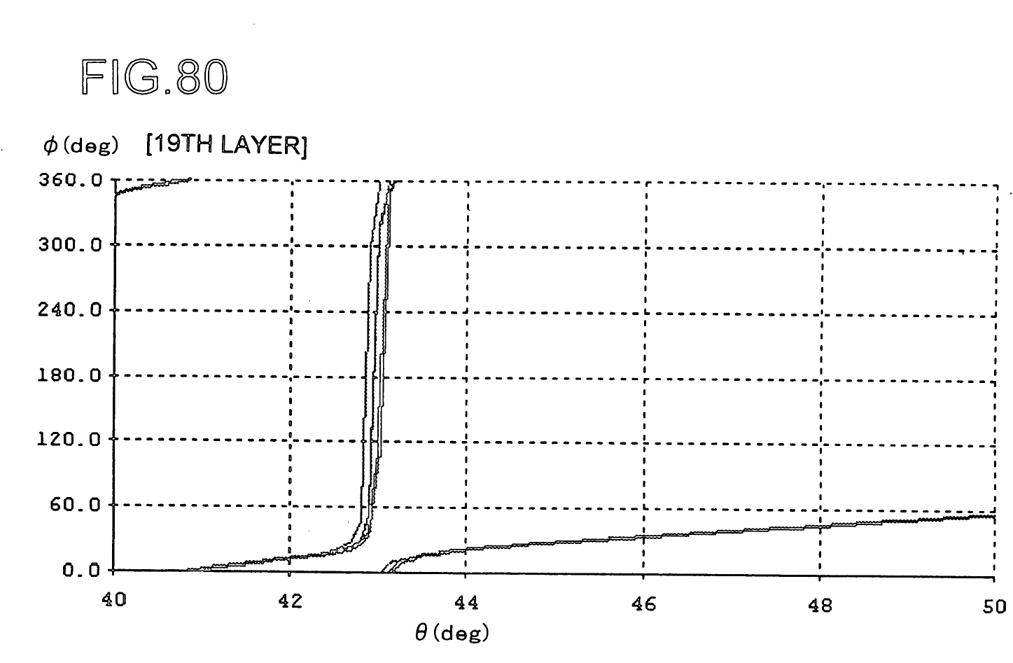

FIG. 80 shows the reflection-induced phase shift φ (°) of s-polarized light (with a wavelength λ of 405 nm) as observed in the range of incidence angles θ from 40° to 50° when the film thickness of the nineteenth layer (i=19, j=14) is varied in four steps at 1QWOT increments from the design value thereof. As the film thickness is varied, the singular point exhibits hardly any movement, and the phase shift curve itself exhibits hardly any change.

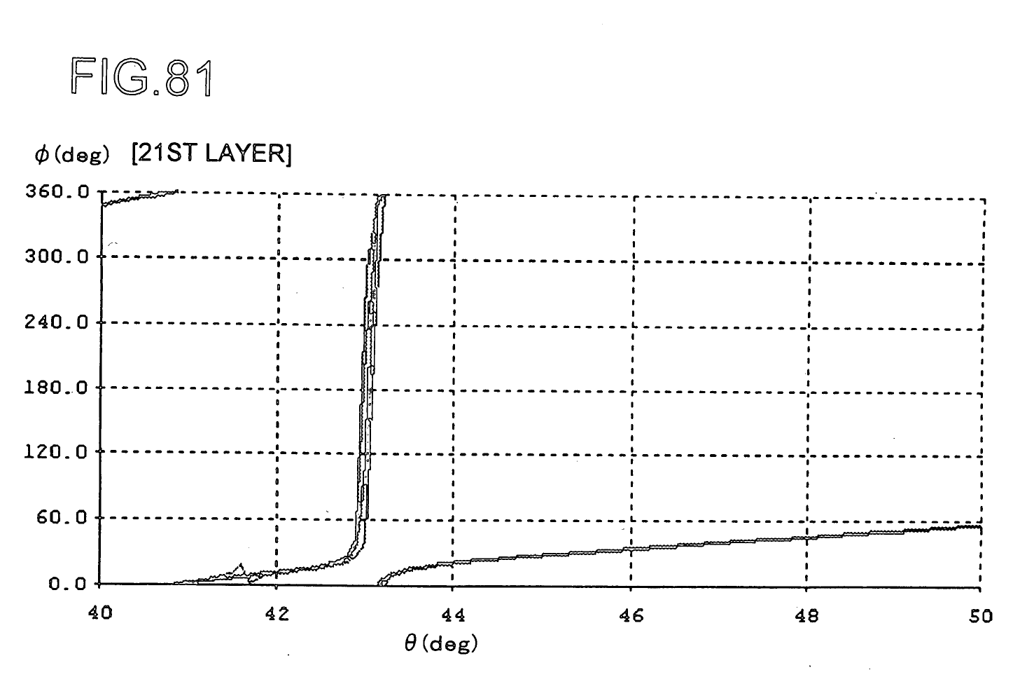

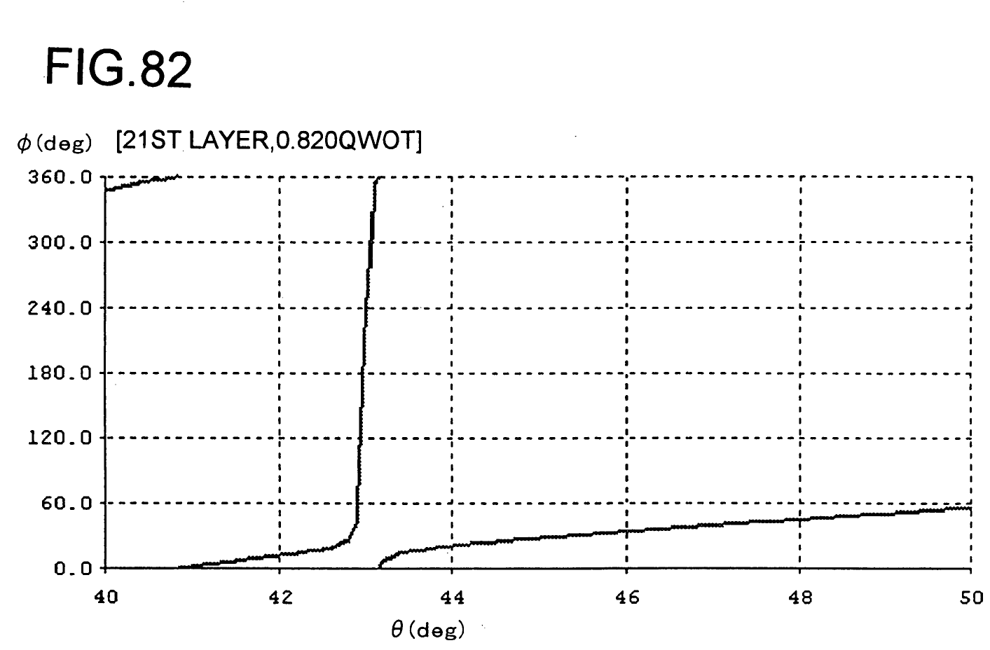

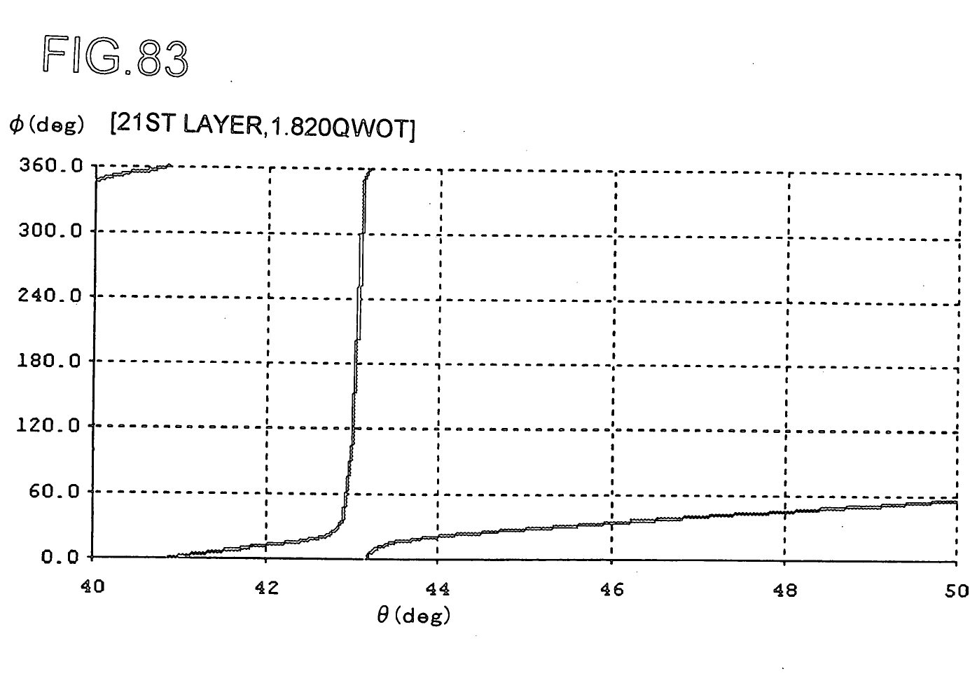

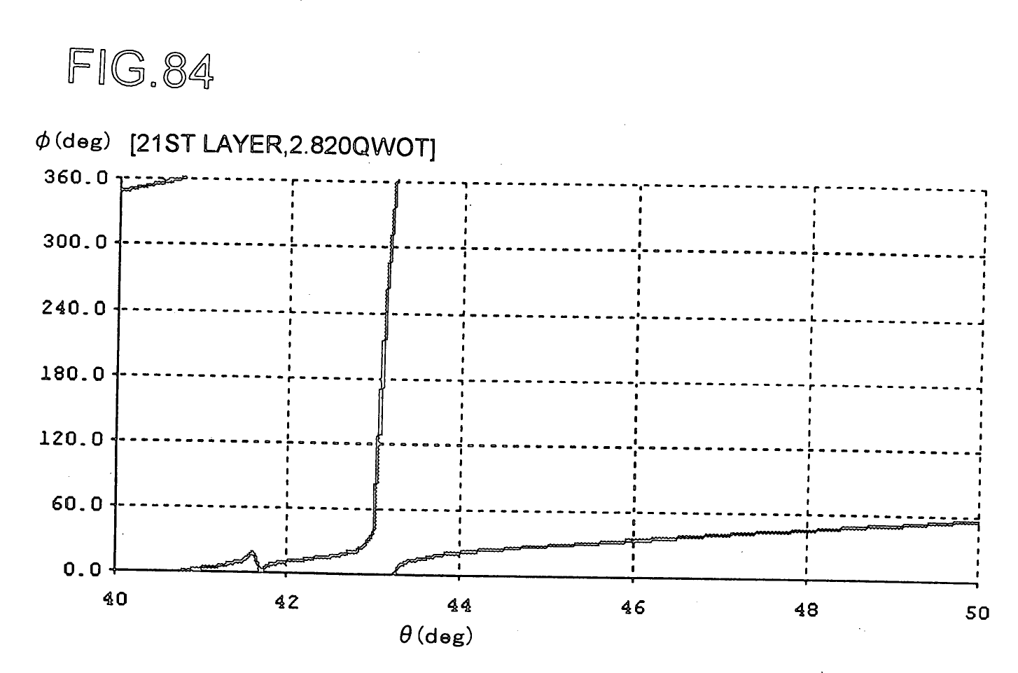

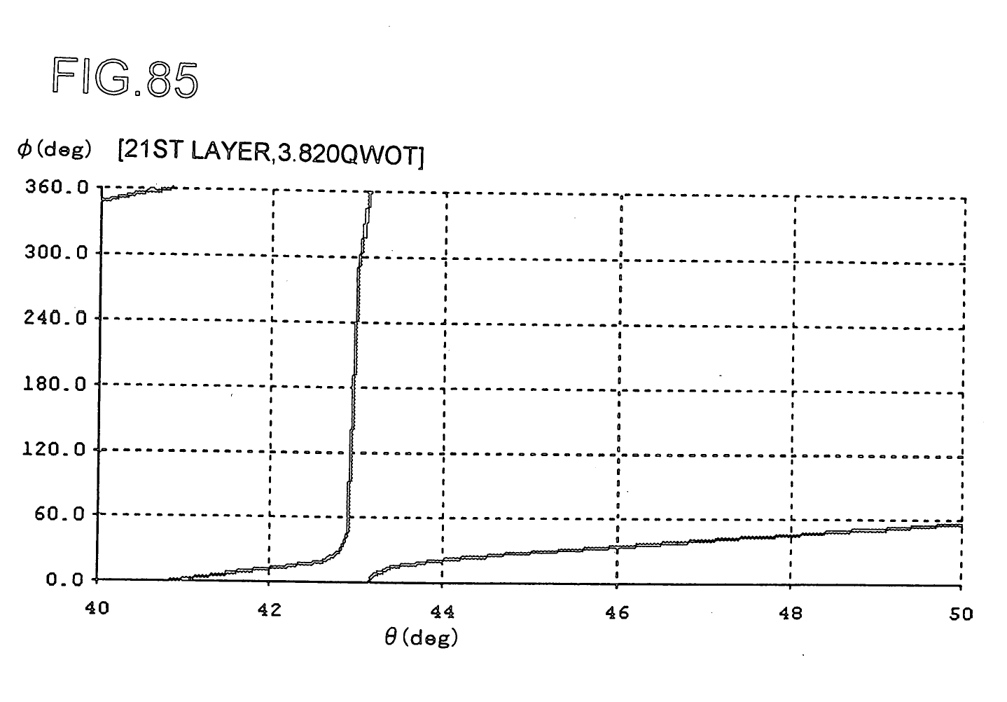

FIG. 81 shows the reflection-induced phase shift φ (°) of s-polarized light (with a wavelength λ of 405 nm) as observed in the range of incidence angles θ from 40° to 50° when the film thickness of the twenty-first layer (i=21, j=12) is varied in four steps at 1QWOT increments from the design value thereof. The four phase shift curves shown in FIG. 81 are shown separately in FIGS. 82 to 85. As the film thickness is varied, the singular point exhibits hardly any movement, and the phase shift curve itself exhibits hardly any change.

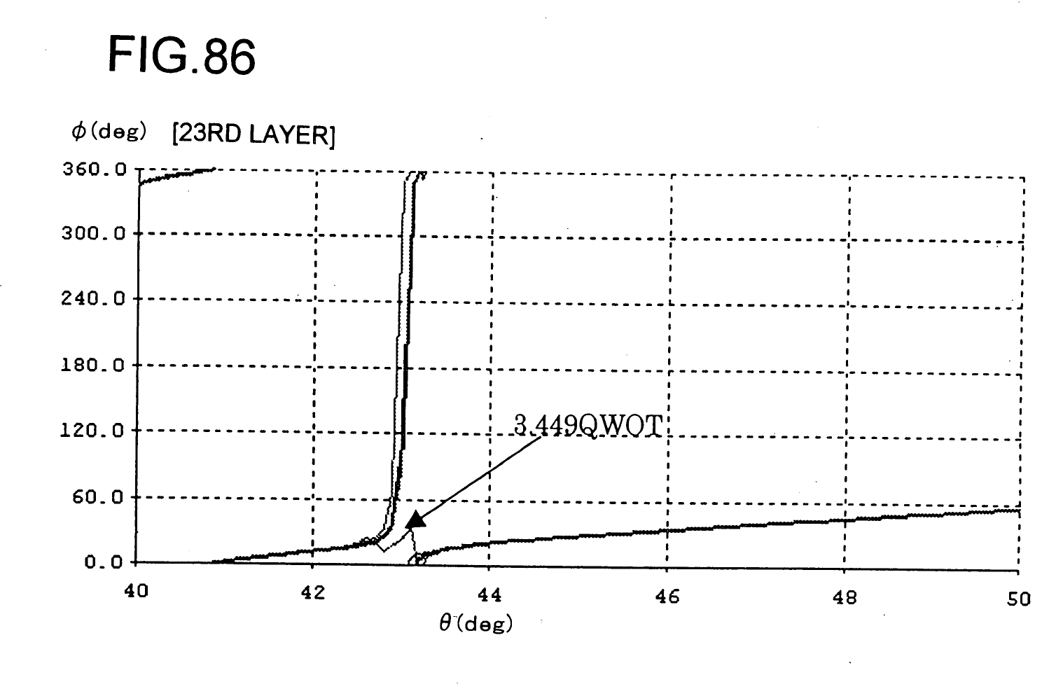

FIG. 86 shows the reflection-induced phase shift φ (°) of s-polarized light (with a wavelength λ of 405 nm) as observed in the range of incidence angles θ from 40° to 50° when the film thickness of the twenty-third layer (i=23, j=10) is varied in four steps at 1QWOT increments from the design value thereof. Except that a change in shape is observed at 3.449QWOT, as the film thickness is varied, the singular point exhibits hardly any movement, and the phase shift curve itself exhibits hardly any change.

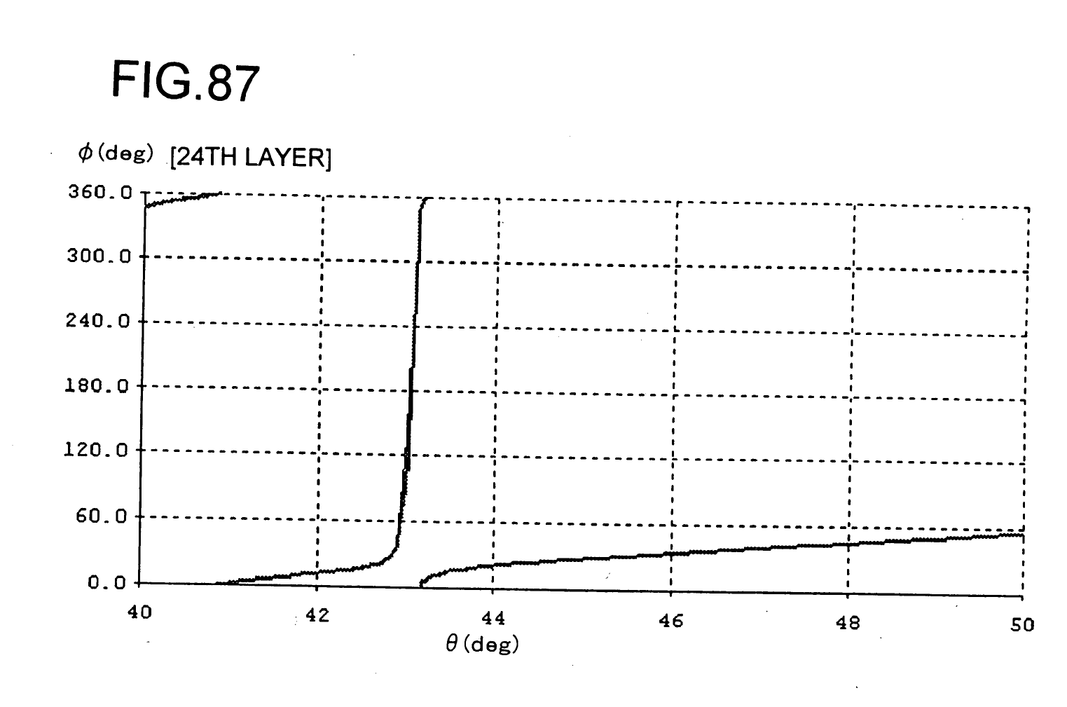

FIG. 87 shows the reflection-induced phase shift φ (°) of s-polarized light (with a wavelength λ of 405 nm) as observed in the range of incidence angles θ from 40° to 50° when the film thickness of the twenty-fourth layer (i=24, j=9) is varied in four steps at 1QWOT increments from the design value thereof. As the film thickness is varied, the singular point exhibits no movement at all, and the phase shift curve itself exhibits no change at all. In this way, in a layer where the electric field intensity is flatly zero, as the film thickness is varied, the phase shift curve exhibits no change at all. This is true also with the twenty-fifth and following layers.

As described above, how the phase shift curve changes as the film thickness of a given layer varies is, roughly speaking, in one of the following three ways depending on where the layer is located between the light-entrance and light-exit sides:
(1) In layers close to the light-entrance-side medium (glass substrate M), the phase shift curve moves greatly upward, downward, or obliquely, while the singular point is constant; the electric field intensity is modest.
(2) In several middle layers, the singular point changes greatly; the electric field intensity is very high in the range of incidence angles where the singular point exists.
(3) In layers close to the light-exit-side medium (glass substrate E), the singular point and the phase shift curve are both constant; the electric field intensity is zero.

In layers close to the light-entrance-side medium (glass substrate M), as the film thickness varies, the phase shift curve changes greatly. This is because these layers have a certain electric field intensity and thus contribute greatly to the reflection of s-polarized light. Accordingly, these layers also contribute greatly to the reflection-induced phase shift. Meanwhile, the incidence angles at which the inflection points and the singular point appear are largely constant. At incidence angles around the singular point, the closer to the several layers that exhibit a sharp increase in electric field intensity, the more the incidence angle at which the singular point appears moves. As a result, only when the film thicknesses of the several middle layers that exhibit a sharp increase in electric field intensity owing to the presence of a curve, inflection point, or singular point are varied, it is possible to move the incidence angle at which the singular point appears. The layers close to the light-exit-side medium (glass substrate E) have no electric field intensity, and thus hardly contribute to reflection. Accordingly, these layers do not contribute to the reflection-induced phase shift, and the shape of the phase shift curve and the positions of inflection points and singular points are largely constant.

In a film construction in which the phase shift curve exhibits an inflection point and a singular point, in most of the layers thereof, it is difficult to obtain linearity through film thickness adjustment. However, in the electric field intensity distribution at the incidence angle at which the singular point appears, by adjusting the film thicknesses of several middle layers (hereinafter referred to as the “key layers”) that exhibit a sharp increase in electric field intensity, it is possible to remove the inflection point and the singular point from a predetermined range of incidence angles (in Comparative Example 2, the keys layers are those located around the eleventh layer (i=11, j=22) that exhibits the highest electric field intensity). That is, to make a tricky pattern involving a singular point linear, by adjusting the film thicknesses of the key layers, it is possible to remove the singular point from a desired range of incidence angles. In a case where doing so degrades the polarization separation characteristics, the thicknesses of the layers other than the key layers can be adjusted to obtain satisfactory polarization separation characteristics. Adjusting the thicknesses of the layers other than the key layers does not cause the singular point to move, and thus does not cause it to come back into the desired range of incidence angles.

As an example of a polarization beam splitter film in which the film thicknesses are adjusted with attention focused on the key layers mentioned above, Table 5 shows the multiple-layer construction of Example 3 (QWOT=4∘n∘d/λ0, where d represents the physical film thickness; n represents the refractive index; and λ0 represents the design wavelength). In the polarization beam splitter film of Example 3, on a glass substrate M (with a refractive index of 1.64) disposed on the light-entrance side, there are laid a total of 32 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between.

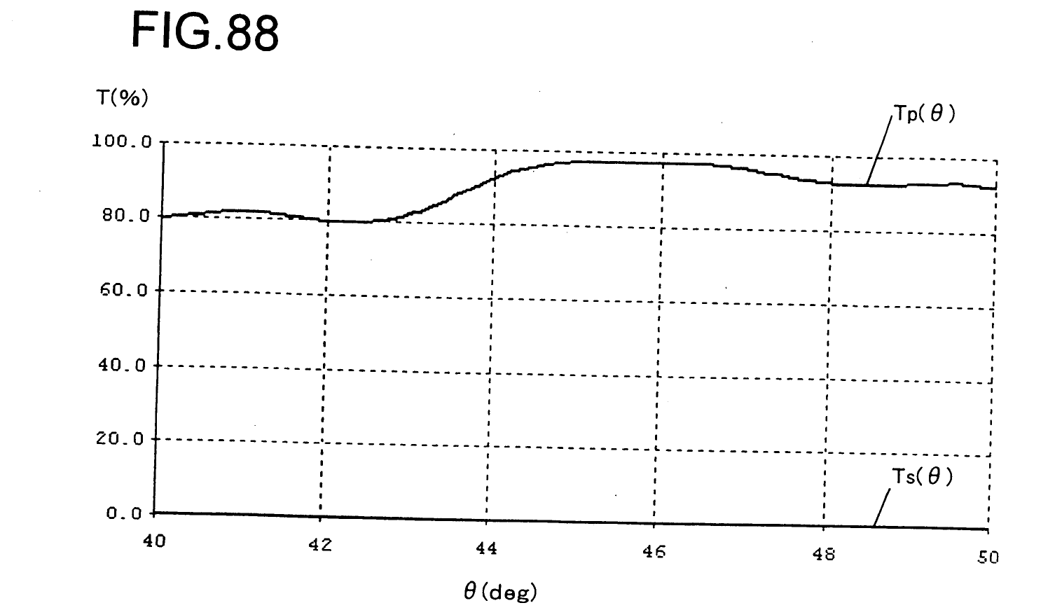

FIG. 88 shows the polarization separation characteristics of Example 3 as plotted in terms of transmissivity T (%). FIG. 88 shows the transmissivity Tp (θ) of p-polarized light and the transmissivity Ts (θ) of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 88, although the transmissivity of p-polarized light in the range of incidence angles θ from 40° to 43° is slightly sacrificed, Example 3 offers satisfactory polarization separation characteristics exhibiting low incidence-angle dependence.

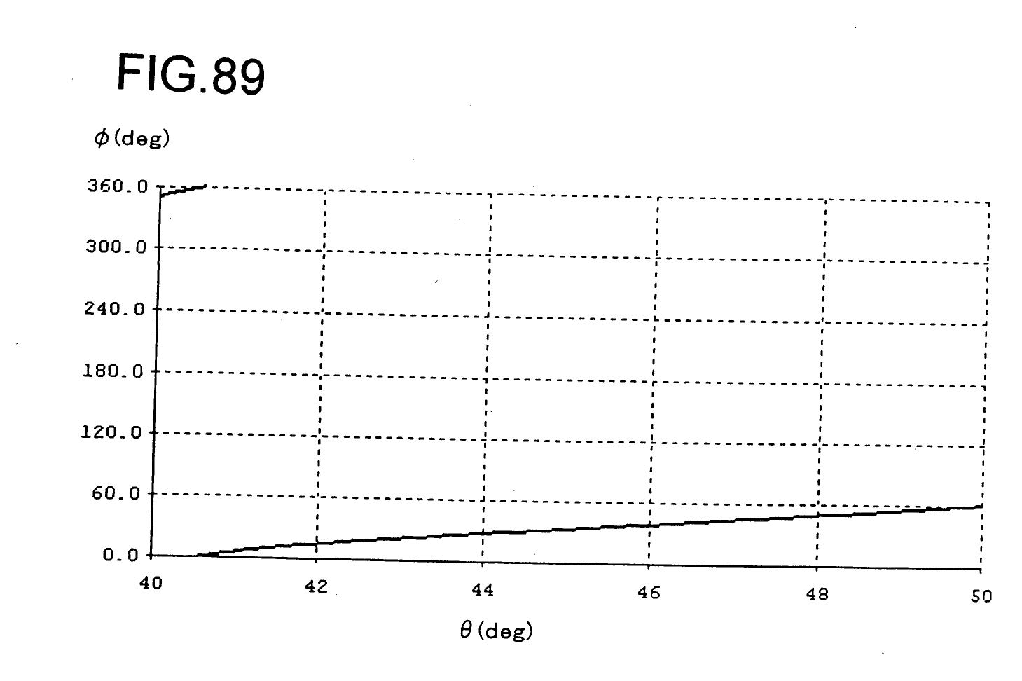

FIG. 89 shows the reflection-induced phase shift φ (°) of s-polarized light (with a wavelength λ of 405 nm) as observed in the range of incidence angles θ from 40° to 50° in Example 3. As will be understood from FIG. 89, the reflection-induced phase shift φ of s-polarized light, involving no singular point, varies linearly with respect to the variation of the incidence angle.

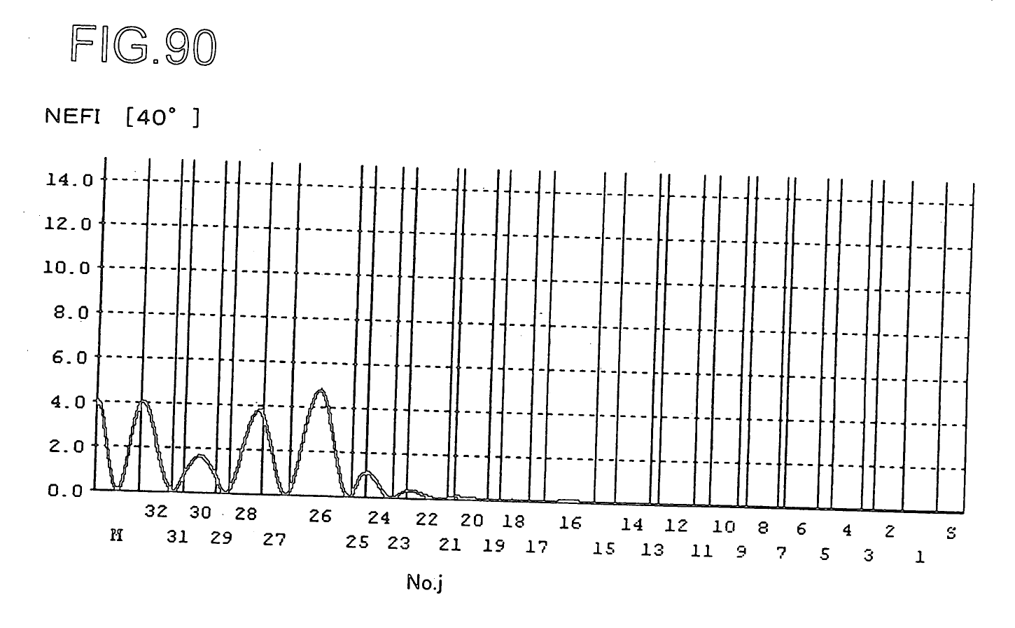

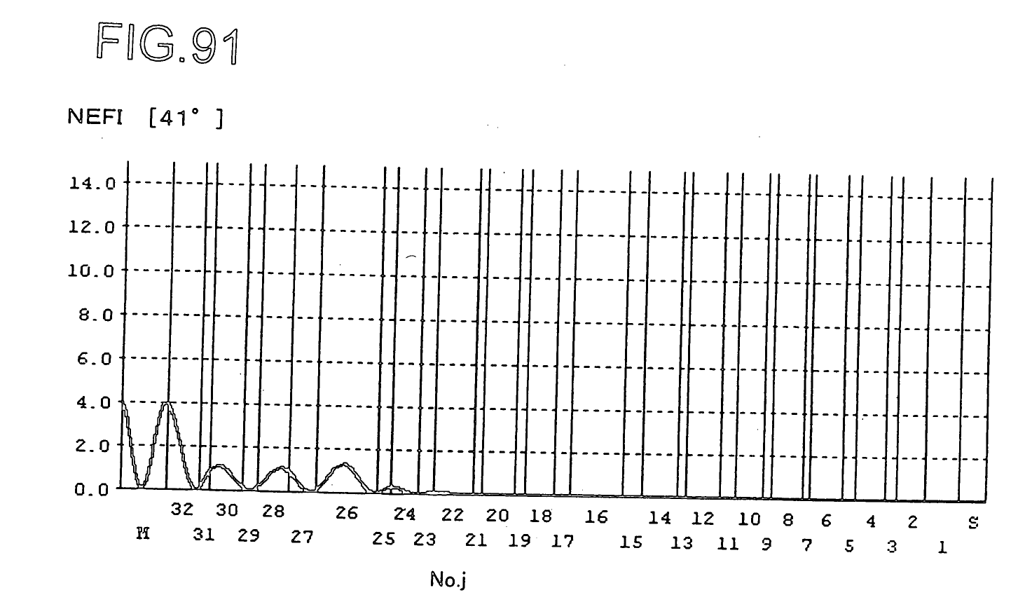

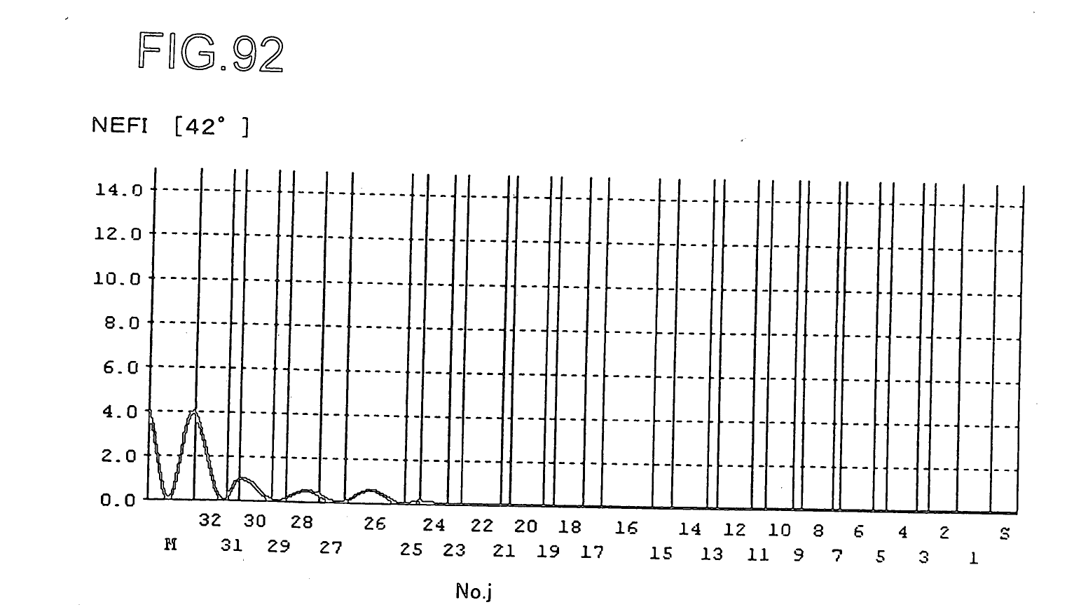

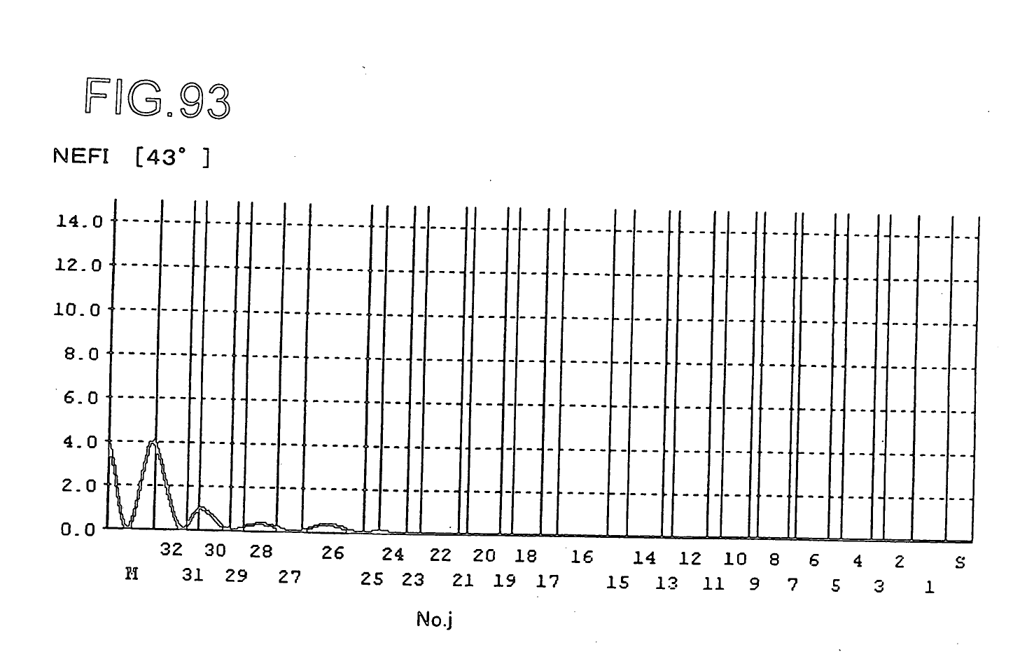

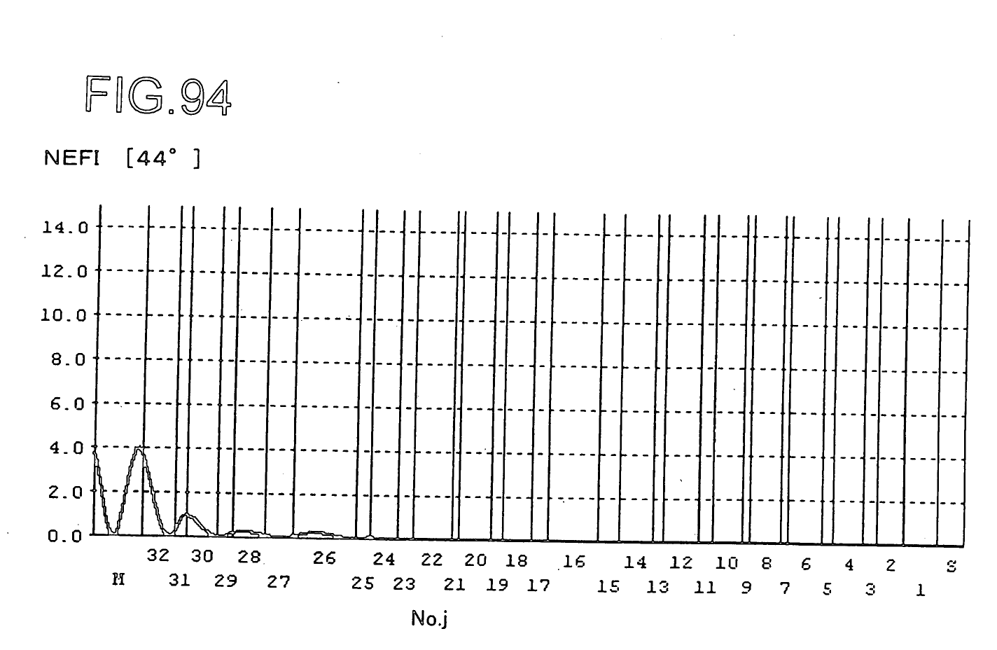

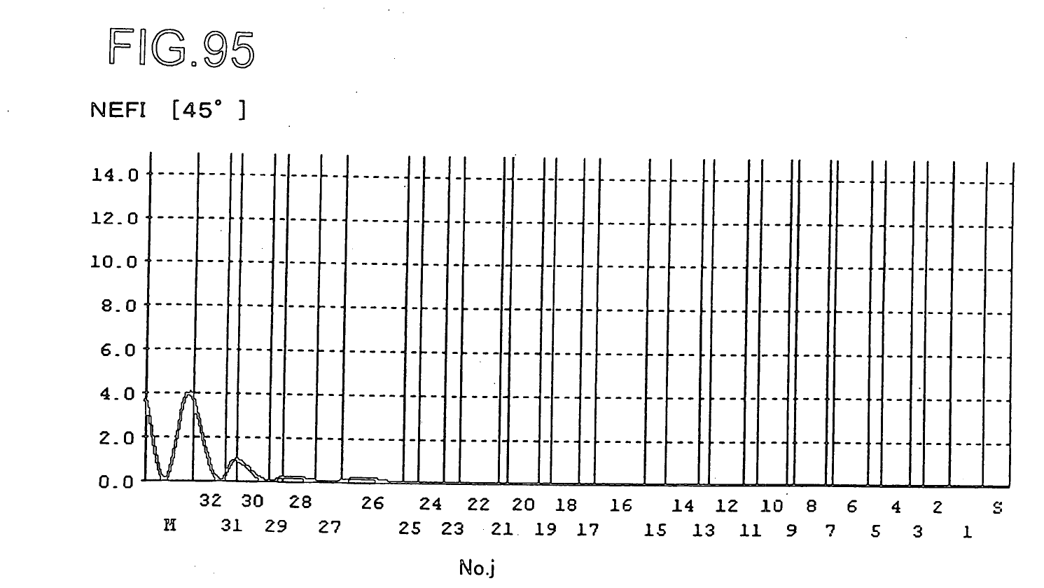

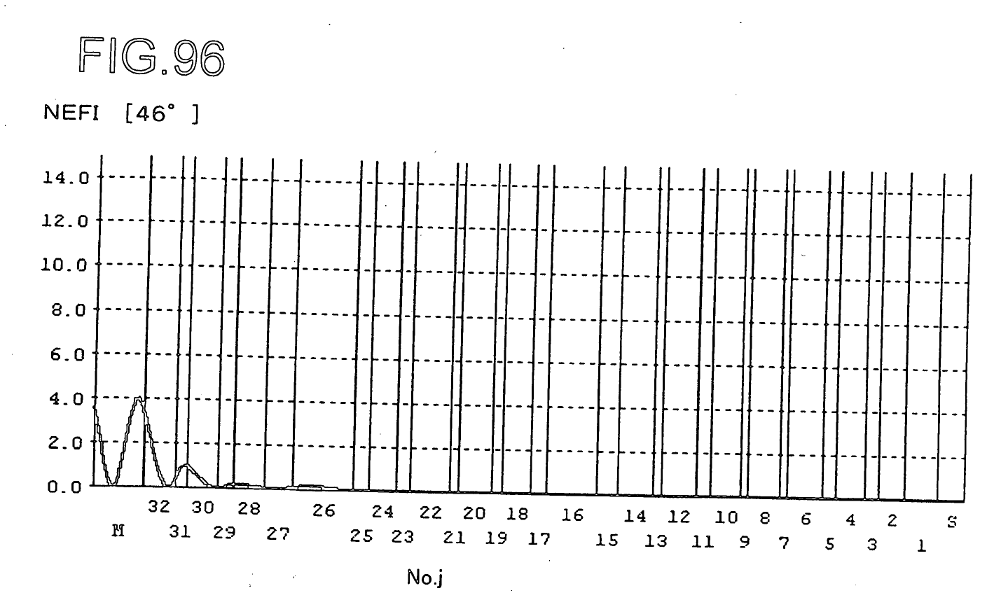

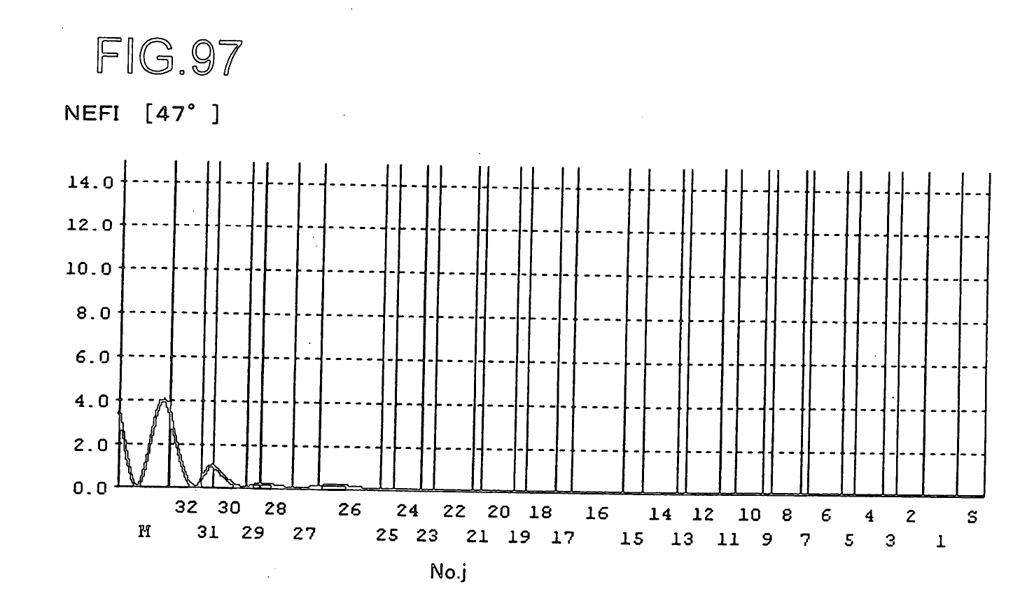

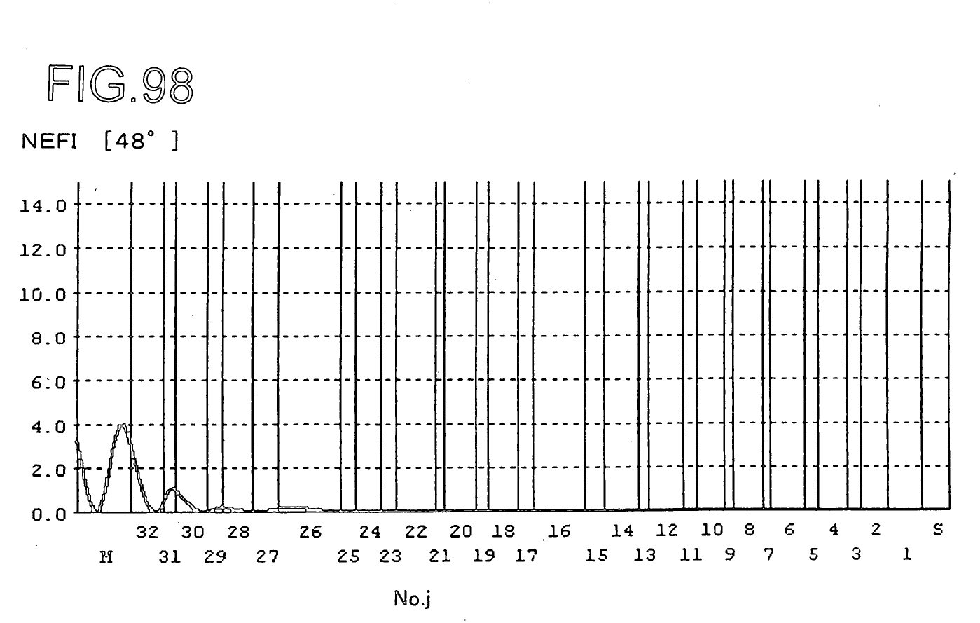

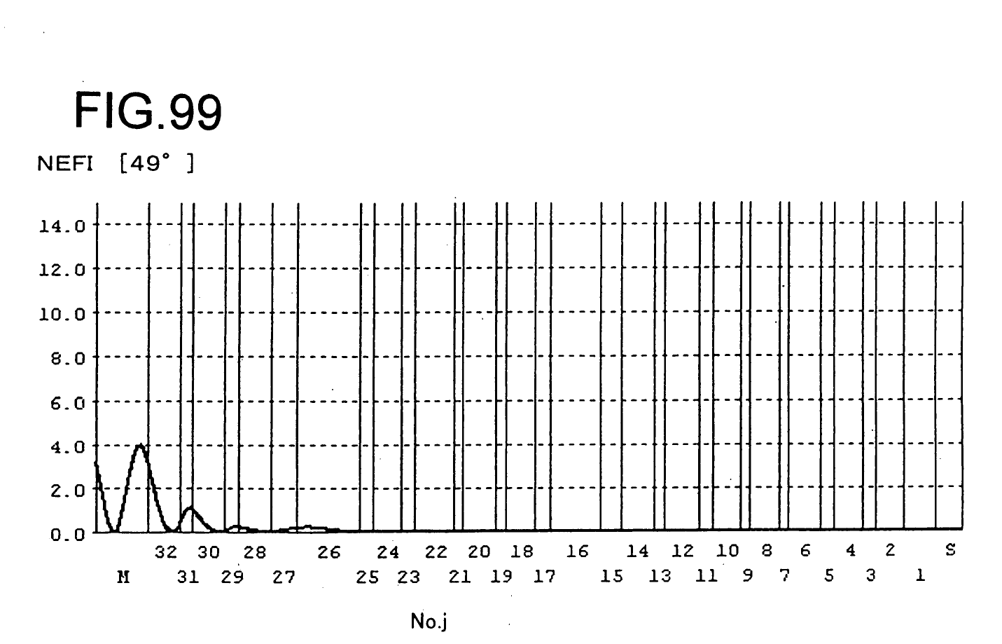

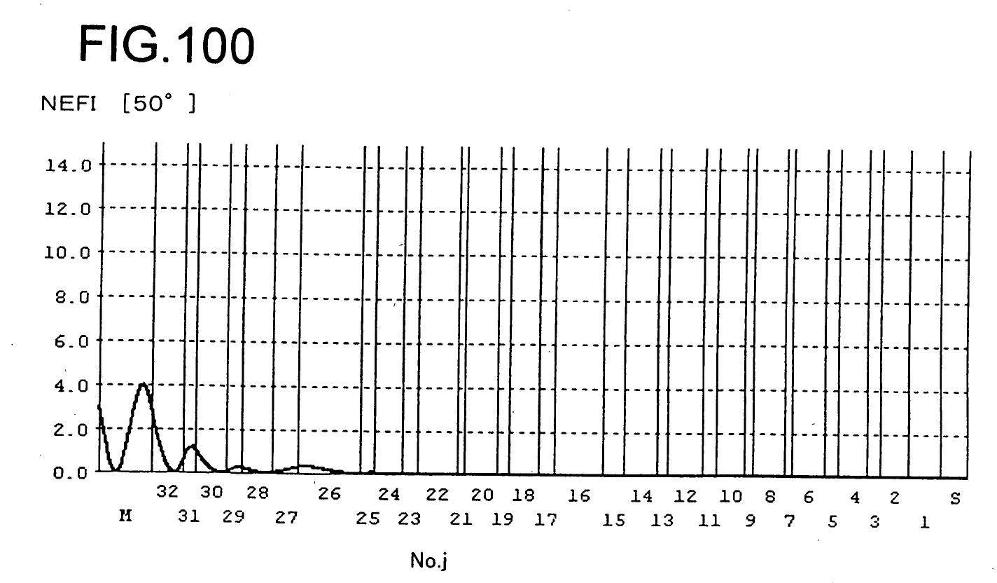

FIGS. 90 to 100 show the electric field intensity distribution of s-polarized light (with a wavelength λ of 405 nm) as observed at each integer angle in the range of incidence angles θ from 40° to 50° in Example 3. In the graphs of FIGS. 90 to 100, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 90 to 100, the vertical axis represents the normalized electric field intensity (NEFI) of the layers. As will be understood from FIGS. 90 to 100, over the entire range of incidence angles θ from 40° to 50°, none of the layers exhibits any sharp increase in electric field intensity. Specifically, the electric field intensity of s-polarized light varies in such a way as to hardly exceed the electric field intensity thereof in the glass substrate M; moreover, the peaks of the electric field intensity distribution decrease largely monotonically.

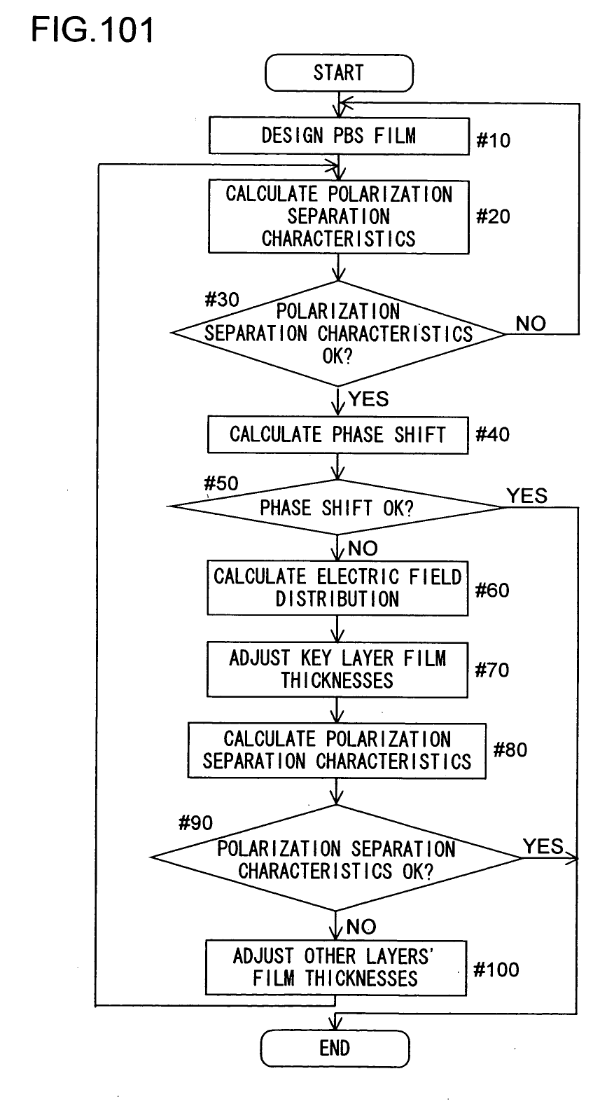

The foregoing leads to the following conclusion. First, in making the phase shift curve linear, the electric field intensity distribution serves as an indicator. Second, among all the layers starting with those located on the light-entrance side which have a certain electric field intensity and ending with those which have almost no electric field intensity, there exist key layers that permit adjustment of an inflection point and a singular point (i.e., layers that exhibit a sharp increase in the electric field intensity at incidence angles around the singular point). In a case where the phase shift curve involves an inflection point and a singular point, it is difficult to achieve linearity by adjusting the film thicknesses even with the help of automatic designing while paying attention to the electric field intensity distribution. However, by adjusting the film thicknesses of the key layers, it is possible to fabricate a polarization beam splitter film in which the reflection-induced phase shift of s-polarized light varies linearly with respect to the variation of the incidence angle in a desired range of incidence angles and in a desired range of wavelengths. Now, a method, characterized in that way, of fabricating a polarization beam splitter film will be described with reference to the flow chart shown in FIG. 101.

First, a polarization beam splitter film (PBS film) is designed (step #10). Then, its polarization separation characteristics are calculated (#20), and whether or not these exhibit low incidence-angle dependence is checked (#30). If the polarization separation characteristics obtained are not as desired, the flow returns to step #10. For example, if, as in Comparative Example 1 (FIG. 30), satisfactory polarization separation characteristics are obtained in a wide range of angles corresponding to incident light having a divergence angle of ±5° or more, then the reflection-induced phase shift of s-polarized light in a desired range of incidence angles and in a desired range of wavelengths (in the case of Comparative Example 1, FIG. 31) is calculated (#40). Then, whether or not the reflection-induced phase shift of s-polarized light varies linearly with respect to the variation of the incidence angle is checked (#50).

When satisfactory linearity is achieved, for example, if the range of incidence angles is ±5° of a predetermined value (in Comparative Example 1, 45°) and if the deviation of the phase shift from the linear function determined by the phase shifts at the minimum and maximum incidence angles is within ±50° over the entire range of incidence angles, the flow is ended. If the phase shift curve involves an inflection point or the like, the processing for enhancing the wavefront accuracy of s-polarized light is started. Specifically, the electric field intensity distribution (in the case of Comparative Example 1, FIGS. 32 to 42) is calculated (#60), and the film thicknesses of the key layers are adjusted (#70) to remove the inflection point and the singular point from the desired range of incidence angles. Then, to check whether or not the key layer thickness adjustment (#70) has degraded the polarization separation characteristics, the polarization separation characteristics are calculated (#80) and evaluated (#90). If the polarization separation characteristics obtained are as desired, the flow is ended; otherwise, the thicknesses of the other layers are adjusted (#100), and then the flow returns to step #20. As described earlier, adjusting the film thicknesses of the layers other than the key layers does not cause the singular point to move.

TABLE 1
Example 1 (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | SiO₂ | 69.04 | 1.000 |
| 2 | TiO₂ | 93.57 | 2.326 |
| 3 | SiO₂ | 164.16 | 2.378 |
| 4 | TiO₂ | 8.78 | 0.218 |
| 5 | SiO₂ | 329.14 | 4.768 |
| 6 | TiO₂ | 11.17 | 0.278 |
| 7 | SiO₂ | 98.13 | 1.422 |
| 8 | TiO₂ | 36.92 | 0.918 |
| 9 | SiO₂ | 106.72 | 1.546 |
| 10 | TiO₂ | 21.67 | 0.539 |
| 11 | SiO₂ | 90.71 | 1.314 |
| 12 | TiO₂ | 29.27 | 0.728 |
| 13 | SiO₂ | 90.04 | 1.304 |
| 14 | TiO₂ | 40.37 | 1.003 |
| 15 | SiO₂ | 88.18 | 1.277 |
| 16 | TiO₂ | 39.14 | 0.973 |
| 17 | SiO₂ | 69.76 | 1.011 |
| 18 | TiO₂ | 29.65 | 0.737 |
| 19 | SiO₂ | 65.58 | 0.950 |
| 20 | TiO₂ | 44.26 | 1.100 |
| 21 | SiO₂ | 113.91 | 1.650 |
| 22 | TiO₂ | 65.11 | 1.618 |
| 23 | SiO₂ | 128.11 | 1.856 |
| 24 | TiO₂ | 60.95 | 1.515 |
| 25 | SiO₂ | 112.9 | 1.635 |
| 26 | TiO₂ | 56.11 | 1.395 |
| 27 | SiO₂ | 108.66 | 1.574 |
| 28 | TiO₂ | 67.93 | 1.688 |
| 29 | SiO₂ | 127.87 | 1.852 |
| 30 | TiO₂ | 56.04 | 1.393 |
| 31 | SiO₂ | 124.92 | 1.810 |
| 32 | TiO₂ | 79.66 | 1.980 |
| 33 | SiO₂ | 131.17 | 1.900 |

Adhesive Layer S (Refractive Index: 1.51)
Glass Substrate E (Refractive Index: 1.64)

TABLE 2
Example 2 (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | SiO₂ | 131.63 | 1.907 |
| 2 | TiO₂ | 45.5 | 1.131 |
| 3 | SiO₂ | 59.38 | 0.860 |
| 4 | TiO₂ | 39.98 | 0.994 |
| 5 | SiO₂ | 61.47 | 0.890 |
| 6 | TiO₂ | 41 | 1.019 |
| 7 | SiO₂ | 72.72 | 1.053 |
| 8 | TiO₂ | 41.89 | 1.041 |
| 9 | SiO₂ | 87.92 | 1.274 |
| 10 | TiO₂ | 39.33 | 0.978 |
| 11 | SiO₂ | 96.45 | 1.397 |
| 12 | TiO₂ | 18.56 | 0.461 |
| 13 | SiO₂ | 106.16 | 1.538 |
| 14 | TiO₂ | 41.06 | 1.021 |
| 15 | SiO₂ | 83.47 | 1.209 |
| 16 | TiO₂ | 40.82 | 1.015 |
| 17 | SiO₂ | 75.42 | 1.092 |
| 18 | TiO₂ | 39.49 | 0.981 |
| 19 | SiO₂ | 75.01 | 1.087 |
| 20 | TiO₂ | 40.18 | 0.999 |
| 21 | SiO₂ | 78.33 | 1.135 |
| 22 | TiO₂ | 42.22 | 1.050 |
| 23 | SiO₂ | 78.54 | 1.138 |
| 24 | TiO₂ | 42.72 | 1.062 |
| 25 | SiO₂ | 73.11 | 1.059 |
| 26 | TiO₂ | 41.05 | 1.020 |
| 27 | SiO₂ | 67.91 | 0.984 |
| 28 | TiO₂ | 39.29 | 0.977 |
| 29 | SiO₂ | 68.97 | 0.999 |
| 30 | TiO₂ | 40.56 | 1.008 |
| 31 | SiO₂ | 85.99 | 1.246 |
| 32 | TiO₂ | 174.96 | 4.349 |
| 33 | SiO₂ | 137.63 | 1.994 |
| 34 | TiO₂ | 67.57 | 1.6796 |
| 35 | SiO₂ | 77.84 | 1.1275 |

Adhesive Layer S (Refractive Index: 1.52)
Glass Substrate E (Refractive Index: 1.64)

TABLE 3
Comparative Example 1 (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | MgF₂ | 105.74 | 1.447 |
| 2 | TX | 48.63 | 1.019 |
| 3 | MgF₂ | 124.36 | 1.701 |
| 4 | TX | 26.18 | 0.549 |
| 5 | MgF₂ | 70.06 | 0.958 |
| 6 | SiO₂ | 194.72 | 2.821 |
| 7 | TX | 44.89 | 0.941 |
| 8 | MgF₂ | 132.19 | 1.808 |
| 9 | TX | 28.92 | 0.606 |
| 10 | MgF₂ | 126.28 | 1.727 |
| 11 | TX | 43.31 | 0.908 |
| 12 | SiO₂ | 98.59 | 1.428 |
| 13 | TX | 118.54 | 2.484 |
| 14 | MgF₂ | 140.95 | 1.928 |
| 15 | TX | 37.25 | 0.781 |
| 16 | MgF₂ | 147.16 | 2.013 |
| 17 | TX | 31.53 | 0.661 |
| 18 | SiO₂ | 126.75 | 1.836 |
| 19 | TX | 56.05 | 1.174 |
| 20 | MgF₂ | 151.23 | 2.069 |
| 21 | TX | 75.36 | 1.579 |
| 22 | SiO₂ | 146 | 2.115 |
| 23 | TX | 28 | 0.587 |
| 24 | MgF₂ | 151.25 | 2.069 |
| 25 | TX | 60.57 | 1.269 |
| 26 | SiO₂ | 98.61 | 1.428 |
| 27 | TX | 38.76 | 0.812 |
| 28 | MgF₂ | 103.8 | 1.420 |
| 29 | TX | 41.37 | 0.867 |
| 30 | MgF₂ | 92.79 | 1.269 |
| 31 | TX | 37.68 | 0.790 |
| 32 | SiO₂ | 95.69 | 1.386 |
| 33 | TX | 45.81 | 0.960 |
| 34 | MgF₂ | 103.97 | 1.4222 |
| 35 | TX | 146.39 | 3.0669 |

Adhesive Layer S (Refractive Index: 1.52)
Glass Substrate E (Refractive Index: 1.64)

TABLE 4
Comparative Example 2 (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | MgF₂ | 117.88 | 1.613 |
| 2 | TX | 39.76 | 0.833 |
| 3 | MgF₂ | 148.45 | 2.031 |
| 4 | TX | 53.16 | 1.114 |
| 5 | MgF₂ | 115.52 | 1.580 |
| 6 | SiO₂ | 94.95 | 1.375 |
| 7 | MgF₂ | 514.33 | 3.036 |
| 8 | TX | 51.92 | 1.088 |
| 9 | SiO₂ | 98.59 | 1.428 |
| 10 | TX | 51.83 | 1.086 |
| 11 | MgF₂ | 288.7 | 3.949 |
| 12 | TX | 29.7 | 0.622 |
| 13 | MgF₂ | 116.4 | 1.592 |
| 14 | TX | 40.77 | 0.854 |
| 15 | SiO₂ | 105.26 | 1.525 |
| 16 | TX | 56.52 | 1.184 |
| 17 | MgF₂ | 133.96 | 1.832 |
| 18 | TX | 69.95 | 1.465 |
| 19 | SiO₂ | 141.53 | 2.050 |
| 20 | TX | 70.42 | 1.475 |
| 21 | MgF₂ | 133.03 | 1.820 |
| 22 | TX | 54.33 | 1.138 |
| 23 | SiO₂ | 100.03 | 1.449 |
| 24 | TX | 39.64 | 0.831 |
| 25 | MgF₂ | 103.11 | 1.411 |
| 26 | TX | 43.55 | 0.912 |
| 27 | MgF₂ | 95.53 | 1.307 |
| 28 | TX | 38.62 | 0.809 |
| 29 | SiO₂ | 89.45 | 1.296 |
| 30 | TX | 44.09 | 0.924 |
| 31 | MgF₂ | 103.97 | 1.422 |
| 32 | TX | 157.8 | 3.306 |

Adhesive Layer S (Refractive Index: 1.52)
Glass Substrate E (Refractive Index: 1.64)

TABLE 5
Example 3 (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | MgF₂ | 117.23 | 1.604 |
| 2 | TX | 42.74 | 0.895 |
| 3 | MgF₂ | 115.94 | 1.586 |
| 4 | TX | 51.65 | 1.082 |
| 5 | MgF₂ | 115.52 | 1.580 |
| 6 | SiO₂ | 94.95 | 1.375 |
| 7 | MgF₂ | 221.91 | 3.036 |
| 8 | TX | 51.92 | 1.088 |
| 9 | SiO₂ | 98.59 | 1.428 |
| 10 | TX | 51.83 | 1.086 |
| 11 | MgF₂ | 142.49 | 1.949 |
| 12 | TX | 29.7 | 0.622 |
| 13 | MgF₂ | 116.4 | 1.592 |
| 14 | TX | 40.77 | 0.854 |
| 15 | SiO₂ | 105.26 | 1.525 |
| 16 | TX | 56.52 | 1.184 |
| 17 | MgF₂ | 179.46 | 2.455 |
| 18 | TX | 71.02 | 1.488 |
| 19 | SiO₂ | 121.82 | 1.765 |
| 20 | TX | 34.21 | 0.717 |
| 21 | MgF₂ | 124.03 | 1.697 |
| 22 | TX | 51.32 | 1.075 |
| 23 | SiO₂ | 100.74 | 1.459 |
| 24 | TX | 28.56 | 0.598 |
| 25 | MgF₂ | 109.7 | 1.501 |
| 26 | TX | 25.22 | 0.528 |
| 27 | MgF₂ | 120.69 | 1.651 |
| 28 | TX | 49.12 | 1.029 |
| 29 | SiO₂ | 107.65 | 1.559 |
| 30 | TX | 47.13 | 0.987 |
| 31 | MgF₂ | 103.97 | 1.422 |
| 32 | TX | 120.31 | 2.521 |

Adhesive Layer S (Refractive Index: 1.52)
Glass Substrate E (Refractive Index: 1.64)

1. A polarization beam splitter film formed on a transparent substrate,
wherein, in a desired range of incidence angles and in a desired range of wavelengths, a reflection-induced phase shift of s-polarized light varies linearly with respect to variation of an incidence angle thereof.

2. A polarization beam splitter film as claimed in claim 1,
wherein, in the desired range of incidence angles and in the desired range of wavelengths, an electric field intensity of the s-polarized light as observed between a light-entrance side, where the substrate is located, and a light-exit side varies in such a way as not to exceed four times an electric field intensity of the s-polarized light as observed in the substrate.

3. A polarization beam splitter film as claimed in claim 1,
wherein the desired range of incidence angles is ±5° of a desired value, and a deviation of the phase shift from a linear function determined by phase shifts observed at minimum and maximum incidence angles is within ±50° over the entire range of incidence angles.

4. A polarization beam splitter film as claimed in claim 2,
wherein, in the desired range of incidence angles and in the desired range of wavelengths, peaks of electric field intensity distribution of the s-polarized light as observed between the light-entrance side and the light-exit side decrease largely monotonically.

5. A polarization beam splitter film as claimed in claim 2,
wherein the desired range of wavelengths is ±5 nm of a predetermined wavelength.

6. A polarization beam splitter film as claimed in claim 2,
wherein the desired range of incidence angles is ±5° of a predetermined angle.

7. A method of adjusting a phase shift of s-polarized light reflected from a polarization beam splitter film having a multiple-layer construction,
wherein, in a desired range of incidence angles and in a desired range of wavelengths, if electric field intensity distribution of the s-polarized light as observed between a light-entrance side and a light-exit side exhibits an increase exceeding a predetermined value, an electric field intensity of the s-polarized light is reduced down to the predetermined value or less by adjusting a film thickness of a layer in which the electric field intensity distribution of the s-polarized light exhibits the increase.

8. A method of adjusting a phase shift as claimed in claim 7,
wherein a substrate is disposed on the light-entrance side of the polarization beam splitter film, and the predetermined value is four times an electric field intensity in the substrate.

9. A method of adjusting a phase shift of s-polarized light reflected from a polarization beam splitter film having a multiple-layer construction,
wherein, in a desired range of incidence angles and in a desired range of wavelengths, electric field intensity distribution of the s-polarized light as observed between a light-entrance side and a light-exit side is controlled in such a way that peaks thereof decrease largely monotonically.

10. A method of adjusting a phase shift as claimed in claim 9,
wherein a substrate is disposed on the light-entrance side of the polarization beam splitter film, and
wherein an electric field intensity of the s-polarized light as observed between a light-entrance side and a light-exit side is controlled to be less than or equal to four times an electric field intensity as observed in the substrate.

11. A method of adjusting a phase shift of s-polarized light reflected from a polarization beam splitter film having a multiple-layer construction,
wherein, in a desired range of incidence angles and in a desired range of wavelengths, if electric field intensity distribution of the s-polarized light as observed between a light-entrance side and a light-exit side exhibits an increase exceeding a predetermined value, an electric field intensity of the s-polarized light is reduced down to the predetermined value or less by adjusting a film thickness of a layer in which the electric field intensity distribution of the s-polarized light exhibits the increase so that the electric field intensity distribution is controlled in such a way that peaks thereof decrease largely monotonically.

12. A method of adjusting a phase shift as claimed in claim 11,
wherein a substrate is disposed on the light-entrance side of the polarization beam splitter film, and the predetermined value is four times an electric field intensity in the substrate.

13. A polarization beam splitter comprising:
a first substrate that is transparent;
a polarization beam splitter film formed on the first substrate,
wherein, when light in a desired range of wavelengths is incident on the polarization beam splitter film in a desired range of incidence angles, a deviation of a reflection-induced phase shift of s-polarized light from a phase shift curve expressed as a linear function determined by phase shifts observed at minimum and maximum incidence angles is within ±50° all over the desired range of incidence angles.

14. A polarization beam splitter as claimed in claim 13,
wherein the desired range of incidence angles is ±5° of a predetermined angle.

15. A polarization beam splitter as claimed in claim 13,
wherein the desired range of wavelengths is ±5 nm of a predetermined wavelength.

16. A polarization beam splitter as claimed in claim 13, further comprising:
a second substrate that is transparent,
wherein the first and second substrates are bonded together with the polarization beam splitter film sandwiched therebetween.

17. A polarization beam splitter as claimed in claim 13,
wherein, when light is incident from a first direction, the reflection-induced phase shift of the s-polarized light from the phase shift curve is within ±20° all over the desired range of incidence angles.

18. A polarization beam splitter as claimed in claim 13,
wherein, when light is incident from a first direction, the reflection-induced phase shift of the s-polarized light from the phase shift curve is within ±10° all over the desired range of incidence angles.

19. A polarization beam splitter as claimed in claim 13,
wherein the reflection-induced phase shift of the s-polarized light varies smoothly over the desired range of incidence angles.
